(19) United States
(12) Patent Application Publication
(10) Pub. No.: US 2022/0339952 A1
(43) Pub. Date: Oct. 27, 2022

(54) LITHOGRAPHIC PRINTING METHOD

(71) Applicant: FUJIFILM Corporation, Tokyo (JP)

(72) Inventors: Yusuke NAMBA, Shizuoka (JP); Atsushi MATSUURA, Shizuoka (JP); Akira SAKAGUCHI, Shizuoka (JP)

(73) Assignee: FUJIFILM Corporation, Tokyo (JP)

(21) Appl. No.: 17/849,143

(22) Filed: Jun. 24, 2022

Related U.S. Application Data
(63) Continuation of application No. PCT/JP2020/048991, filed on Dec. 25, 2020.

(30) Foreign Application Priority Data
Dec. 27, 2019 (JP) 2019-239025

(51) Int. Cl. B41M 1/06

(52) U.S. Cl. CPC B41M 1/06

(57) ABSTRACT

Provided is a lithographic printing method including a preparing step of preparing a lithographic printing plate precursor which includes an aluminum support, and an image recording layer containing an acid color developing agent and an acid generator on the aluminum support, an exposing step of exposing the lithographic printing plate precursor, a developing step of supplying acidic dampening water to the exposed lithographic printing plate precursor and removing a non-image area of the image recording layer, and a printing step, in which the aluminum support includes an anodized aluminum film, the anodized film has micropores, and a value ΔS is 15% or greater and 60% or less.

### CROSS-REFERENCE TO RELATED APPLICATIONS

This application is a continuation application of International Application No. PCT/JP2020/048991, filed Dec. 25, 2020, the disclosure of which is incorporated herein by reference in its entirety. Further, this application claims priority from Japanese Patent Application No. 2019-239025, filed Dec. 27, 2019, the disclosure of which is incorporated herein by reference in its entirety.

### BACKGROUND OF THE INVENTION

### 1. Field of the Invention

The present disclosure relates to a lithographic printing method.

### 2. Description of the Related Art

A lithographic printing plate is typically formed of a lipophilic image area that receives ink in the process of printing and a hydrophilic non-image area that receives dampening water. Lithographic printing is applied to a method of performing printing by utilizing the property that water and oil-based ink repel each other to generate a difference in adhesiveness of ink onto a surface of a lithographic printing plate using a lipophilic image area of the lithographic printing plate as an ink receiving unit and a hydrophilic non-image area as a dampening water receiving unit (ink non-receiving unit), allowing the ink to land only on an image area, and transferring the ink to a printing material such as paper.

In the related art, a lithographic printing plate precursor (also referred to as a PS plate) obtained by providing a lipophilic photosensitive resin layer (image recording layer) on a hydrophilic support has been widely used as a lithographic printing plate. A lithographic printing plate is typically obtained by performing plate-making according to a method of exposing a lithographic printing plate precursor through an original picture such as a lith film, allowing a part which is an image area of an image recording layer to remain, dissolving the other unnecessary part of the image recording layer in an alkaline developer or an organic solvent so that the part is removed, and exposing a surface of a hydrophilic support to form a non-image area.

Further, environmental problems related to a waste liquid associated with wet treatments such as a development treatment have been highlighted due to the growing interest in the global environment.

In order to deal with the above-described environmental problem, it is desired to simplify the process of development or plate-making or not to perform any treatment. A so-called “on-press development” method is an example of a simple method of preparing a lithographic printing plate. That is, the on-press development is a method of exposing a lithographic printing plate precursor, mounting the lithographic printing plate precursor on a printing press without performing development of the related art, and removing an unnecessary part of an image recording layer, at an initial stage of a typical printing step.

Examples of the lithographic printing plate precursor of the related art include those described in WO2019/044087A.

WO2019/044087A describes a lithographic printing plate precursor including an aluminum support and an image recording layer, in which the aluminum support includes an aluminum plate and an anodized aluminum film disposed on the aluminum plate, the anodized film is positioned on a side of the image recording layer with respect to the aluminum plate, the anodized film has micropores extending from the surface on the side of the image recording layer in the depth direction, the average diameter of the micropores in the surface of the anodized film is greater than 10 nm and 100 nm or less, and the value of the brightness L* in the L*a*b* color system of the surface of the anodized film on the side of the image recording layer is in a range of 70 to 100.

### SUMMARY OF THE INVENTION

An object to be achieved by one aspect of the present disclosure is to provide a lithographic printing method with excellent printing durability of a lithographic printing plate to be obtained and an excellent property of suppressing residual color in a non-image area after development, even in a case where an ultraviolet curable ink (also referred to as a UV ink) is used.

The means for achieving the above-described object includes the following aspects.

<1> A lithographic printing method comprising: a preparing step of preparing a lithographic printing plate precursor which includes an aluminum support, and an image recording layer containing an acid color developing agent and an acid generator on the aluminum support; an exposing step of imagewise-exposing the lithographic printing plate precursor; a developing step of supplying acidic dampening water to the exposed lithographic printing plate precursor and removing a non-image area of the image recording layer; and a printing step of performing printing using a lithographic printing plate obtained by the development, with printing ink and acidic dampening water, in which the aluminum support includes an aluminum plate and an anodized aluminum film disposed on the aluminum plate, the anodized film is positioned on a side of the image recording layer with respect to the aluminum plate, the anodized film has micropores extending from a surface of the anodized film on the side of the image recording layer in a depth direction, and an average diameter of the micropores in the surface of the anodized film is greater than 10 nm and 100 nm or less, and a specific surface area ΔS which is a value acquired by Equation (i) for a geometrically measured area S₀ and an actual area Sₓ obtained by an approximate three-point method, based on three-dimensional data obtained by measuring 512×512 points in a range of 25 μm×25 μm on the surface of the anodized film on the side of the image recording layer using an atomic force microscope, is 15% or greater and 60% or less,

ΔS=(Sₓ−S₀)/S₀×100(%) (i).

<2> The lithographic printing method according to <1>, further comprising a drying step of drying the acidic dampening water on the lithographic printing plate obtained by the development.

<3> The lithographic printing plate precursor according to <1> or <2>, in which the micropores are formed of large-diameter pores extending to a position at a depth of 10 nm to 1000 nm from the surface of the anodized film and small-diameter pores communicating with bottom portions of the large-diameter pores and extending to a position at a depth of 20 nm to 2000 nm from communication positions, and an average diameter of the large-diameter pores in the surface of the anodized film is in a range of 15 nm to 100 nm, and an average diameter of the small-diameter pores at the communication positions is 13 nm or less.

<4> The lithographic printing method according to <3>, in which a depth of the large-diameter pores is in a range of 10 nm to 130 nm.

<5> The lithographic printing method according to <3>, in which the average diameter of the large-diameter pores in the surface of the anodized film is in a range of 20 nm to 100 nm.

<6> The lithographic printing method according to any one of <1> to <5>, in which the acid color developing agent has a molar absorption coefficient ε of 20000 to 100000 at a maximum absorption wavelength.

<7> The lithographic printing method according to any one of <1> to <6>, in which at least one maximum absorption wavelength λmax of an image area of the exposed lithographic printing plate precursor is in a range of 400 nm to 700 nm.

<8> The lithographic printing method according to any one of <1> to <7>, in which the image recording layer contains a polymerization initiator, and the polymerization initiator includes an electron-donating polymerization initiator and an electron-accepting polymerization initiator.

<9> The lithographic printing method according to <8>, in which the image recording layer contains an infrared absorbing agent, and a difference between HOMO of the infrared absorbing agent and HOMO of the electron-donating polymerization initiator is 0.70 eV or less.

<10> The lithographic printing method according to <8>, in which the image recording layer contains an infrared absorbing agent, and a difference between LUMO of the electron-accepting polymerization initiator and LUMO of the infrared absorbing agent is 0.80 eV or less.

<11> The lithographic printing method according to any one of <1> to <10>, in which the image recording layer contains a polymerizable compound, and the polymerizable compound includes a hepta- or higher functional polymerizable compound.

<12> The lithographic printing method according to <11>, in which the polymerizable compound includes a deca- or higher functional polymerizable compound.

<13> The lithographic printing method according to any one of <1> to <12>, in which the acid color developing agent is a leuco coloring agent.

<14> The lithographic printing method according to <13>, in which the leuco coloring agent is a leuco coloring agent having a phthalide structure or a fluorane structure.

<15> The lithographic printing method according to <14>, in which the leuco coloring agent having a phthalide structure or a fluorane structure is a compound represented by any of Formulae (Le-1) to (Le-3).

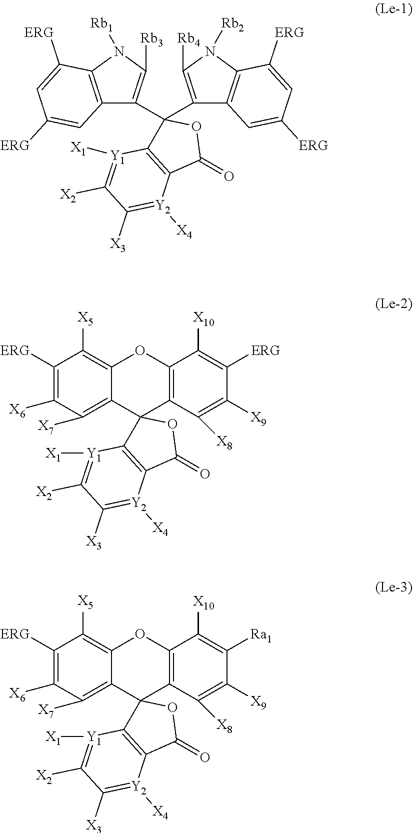

In Formulae (Le-1) to (Le-3), ERG's each independently represent an electron-donating group, X₁ to X₄ each independently represent a hydrogen atom, a halogen atom, or a dialkylanilino group, X₅ to X₁₀ each independently represent a hydrogen atom, a halogen atom, or a monovalent organic group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent an alkyl group or an aryl group.

<16> The lithographic printing method according to <14> or <15>, in which the leuco coloring agent having a phthalide structure or a fluorane structure is a compound represented by any of Formulae (Le-4) to (Le-6).

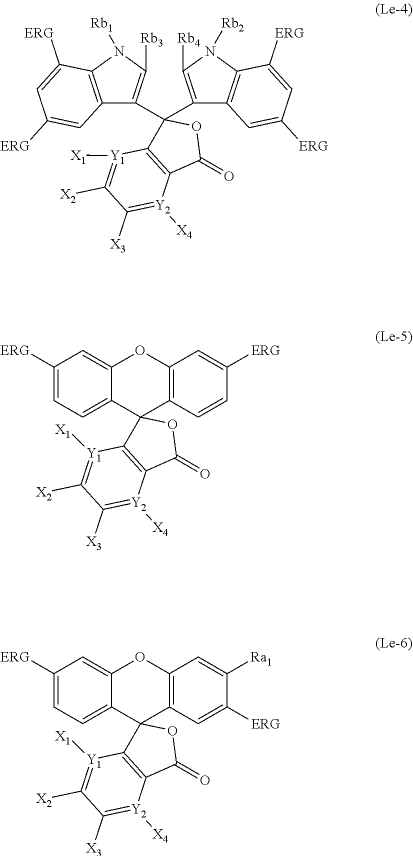

In Formulae (Le-4) to (Le-6), ERG's each independently represent an electron-donating group, X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent an alkyl group or an aryl group.

<17> The lithographic printing method according to any one of <14> to <16>, in which the leuco coloring agent having a phthalide structure or a fluorane structure is a compound represented by any of Formulae (Le-7) to (Le-9).

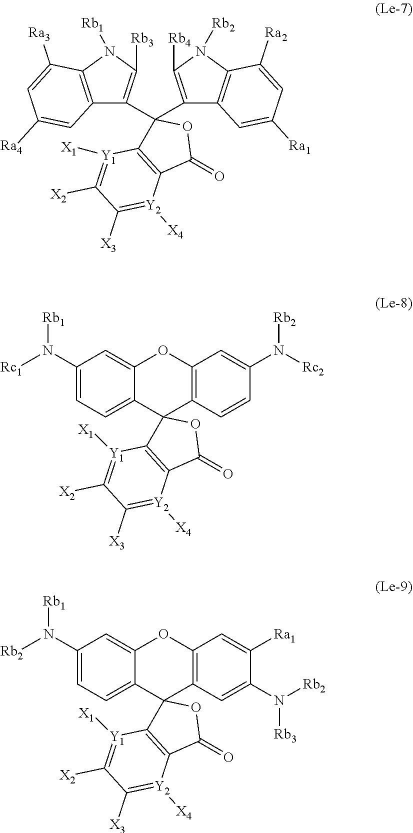

In Formulae (Le-7) to (Le-9), X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ to Ra₄ each independently represent a hydrogen atom, an alkyl group, or an alkoxy group, Rb₁ to Rb₄ each independently represent an alkyl group or an aryl group, and Rc₁ and Rc₂ each independently represent an aryl group.

<18> The lithographic printing method according to <17>, in which Ra₁ to Ra₄ each independently represent an alkoxy group.

<19> The lithographic printing method according to <17> or <18>, in which the leuco coloring agent having a phthalide structure or a fluorane structure is a compound represented by Formula (Le-8).

<20> The lithographic printing method according to <19>, in which X₁ to X₄ represent a hydrogen atom, and Y₁ and Y₂ represent C.

<21> The lithographic printing method according to <19> or <20>, in which Rb₁ and Rb₂ each independently represent a hydrogen atom or an alkyl group.

According to one embodiment of the present disclosure, it is possible to provide a lithographic printing method with excellent printing durability of a lithographic printing plate to be obtained and an excellent property of suppressing residual color in a non-image area after development, even in a case where a UV ink is used.

### BRIEF DESCRIPTION OF THE DRAWINGS

FIG. 1 is a schematic cross-sectional view illustrating an embodiment of an aluminum support.

FIG. 2 is a schematic cross-sectional view illustrating another embodiment of an aluminum support.

FIG. 3 is a graph showing an example of an alternating waveform current waveform diagram used for an electrochemical roughening treatment according to a method of producing an aluminum support.

FIG. 4 is a side view illustrating an example of a radial type cell in the electrochemical roughening treatment carried out using an alternating current according to the method of producing an aluminum support.

FIG. 5 is a side view illustrating the concept of a brush graining step used for a mechanical roughening treatment according to the method of producing an aluminum support having an anodized film.

FIG. 6 is a schematic view illustrating an anodization treatment device used for an anodization treatment in preparation of the aluminum support.

### DESCRIPTION OF THE PREFERRED EMBODIMENTS

Hereinafter, the contents of the present disclosure will be described in detail. The description of constituent elements below is made based on representative embodiments of the present disclosure in some cases, but the present disclosure is not limited to such embodiments.

Further, in the present specification, a numerical range shown using “to” indicates a range including numerical values described before and after “to” as a lower limit and an upper limit.

In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.

Further, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

Further, the term “step” in the present specification indicates not only an independent step but also a step which cannot be clearly distinguished from other steps as long as the intended purpose of the step is achieved.

Further, in the present disclosure, “% by mass” has the same definition as that for “% by weight”, and “part by mass” has the same definition as that for “part by weight”.

Further, in the present disclosure, a combination of two or more preferred embodiments is a more preferred embodiment.

Further, the weight-average molecular weight (Mw) and the number average molecular weight (Mn) in the present disclosure are molecular weights in terms of polystyrene used as a standard substance, which are detected by using tetrahydrofuran (THF) as a solvent, a differential refractometer, and a gel permeation chromatography (GPC) analyzer using TSKgel GMHxL, TSKgel G4000HxL, and TSKgel G2000HxL (all trade names, manufactured by Tosoh Corporation) as columns, unless otherwise specified.

In the present specification, the term “lithographic printing plate precursor” includes not only a lithographic printing plate precursor but also a key plate precursor. Further, the term “lithographic printing plate” includes not only a lithographic printing plate prepared by performing operations such as exposure and development on a lithographic printing plate precursor as necessary but also a key plate. In a case of a key plate precursor, the operations of exposure, development, and the like are not necessarily required. Further, a key plate is a lithographic printing plate precursor for attachment to a plate cylinder that is not used in a case where printing is performed on a part of a paper surface with one or two colors in color newspaper printing.

Hereinafter, the present disclosure will be described in detail.

A lithographic printing method according to the present disclosure is a method including a preparing step of preparing a lithographic printing plate precursor which includes an aluminum support, and an image recording layer containing an acid color developing agent and an acid generator on the aluminum support; an exposing step of imagewise-exposing the lithographic printing plate precursor; a developing step of supplying acidic dampening water to the exposed lithographic printing plate precursor and removing a non-image area of the image recording layer; and a printing step of performing printing using a lithographic printing plate obtained by the development, with printing ink and acidic dampening water, the aluminum support includes an aluminum plate and an anodized aluminum film disposed on the aluminum plate, the anodized film is positioned on a side of the image recording layer with respect to the aluminum plate, the anodized film has micropores extending from a surface of the anodized film on the side of the image recording layer in a depth direction, an average diameter of the micropores in the surface of the anodized film is greater than 10 nm and 100 nm or less, and a specific surface area ΔS which is a value acquired by Equation (i) for a geometrically measured area S₀ and an actual area Sₓ obtained by an approximate three-point method, based on three-dimensional data obtained by measuring 512×512 points in a range of 25 μm×25 μm on the surface of the anodized film on the side of the image recording layer using an atomic force microscope is 15% or greater and 60% or less.

ΔS=(Sₓ−S₀)/S₀×100(%) (i)

In the lithographic printing method using a lithographic printing plate precursor including an image recording layer that contains an acid color developing agent and an acid generator, in a case where acidic dampening water is supplied to the lithographic printing plate precursor after exposure to remove the non-image area of the image recording layer, the acid color developing agent remains in the non-image area of the image recording layer after development, and thus color development occurs in some cases.

In the present disclosure, color development caused by the acid color developing agent remaining in the non-image area of the image recording layer after development is referred to as “residual color”.

Therefore, as a result of intensive research conducted by the present inventors, it was found that in a case where the above-described configuration is employed, a lithographic printing method with printing durability (also referred to as “UV printing durability”) and an excellent property of suppressing residual color in a non-image area after development (hereinafter, also simply referred to as “property of suppressing residual color”) can be provided even in a case where particularly an ultraviolet curable ink (that is, a UV ink) is used.

The detailed mechanism by which the above-described effect is obtained is not clear, but can be assumed as follows.

The roughness of the surface of the aluminum support is further reduced by setting particularly the specific surface area ΔS of the aluminum support used for the lithographic printing method of the present disclosure to be 15% or greater and 60% or less, and thus residual color of the acid color developing agent (for example, a leuco coloring agent described below) on the surface of the support (non-image area) is suppressed. Therefore, it is assumed that residual color in the non-image area after development caused by the remaining acid color developing agent coming into contact with acidic dampening water is suppressed, and thus the property of suppressing residual color is excellent.

Further, it is assumed that since the aluminum support used for the lithographic printing method of the present disclosure has a specific structure, the adhesiveness between the support and the image recording layer is maintained, and both the UV printing durability and the property of suppressing residual color are excellent.

<Preparing Step>

The lithographic printing method according to the present disclosure includes a preparing step of preparing a lithographic printing plate precursor including an aluminum support, and an image recording layer that contains an acid color developing agent and an acid generator on the aluminum support.

The details of the aluminum support and each layer of the lithographic printing plate precursor used in the present disclosure will be described below.

The lithographic printing plate precursor used in the lithographic printing method according to the present disclosure may be a positive tone lithographic printing plate precursor or a negative tone lithographic printing plate precursor, but it is preferable that the lithographic printing plate is a negative tone lithographic printing plate precursor from the viewpoint of further exhibiting the effects of the present disclosure.

Further, from the viewpoint of further exhibiting the effects of the present disclosure, it is preferable that the lithographic printing plate precursor used in the present disclosure has an image recording layer that can be removed by acidic dampening water.

Further, the number of lithographic printing plate precursors prepared in the preparing step is not particularly limited and can be appropriately selected according to the desired printing.

<Exposing Step>

The lithographic printing method according to the present disclosure includes an exposing step of imagewise-exposing the lithographic printing plate precursor.

It is preferable that the exposing step includes an exposing step of imagewise-exposing the lithographic printing plate precursor to form an exposed portion and an unexposed portion. It is preferable that the lithographic printing plate precursor of the present disclosure is exposed to a laser through a transparent original picture having a line image, a halftone image, and the like or imagewise-exposed by laser beam scanning using digital data.

A light source having a wavelength of 750 nm to 1400 nm is preferably used. As the light source having a wavelength of 750 nm to 1400 nm, a solid-state laser or a semiconductor laser that radiates infrared rays is suitable. The output of the infrared laser is preferably 100 mW or greater, the exposure time per one pixel is preferably shorter than 20 microseconds, and the irradiation energy quantity is preferably in a range of 10 mJ/cm² to 300 mJ/cm². For the purpose of reducing the exposure time, it is preferable to use a multi-beam laser device. The exposure mechanism may be any of an internal drum system, an external drum system, or a flat bed system.

The image exposure can be performed using a plate setter according to a usual method. In a case of the on-press development, the lithographic printing plate precursor may be mounted on the printing press and then imagewise-exposed on the printing press.

From the viewpoint of color developability, it is preferable that the exposing step according to the present disclosure includes a step of imagewise-exposing the lithographic printing plate to generate an acid from the acid generator contained in the image recording layer so that the acid color developing agent develops color by the acid.

From the viewpoint of visibility, at least one maximum absorption wavelengths λmax of the image area of the exposed lithographic printing plate precursor is preferably in a range of 400 nm to 700 nm, more preferably in a range of 400 nm to 650 nm, and still more preferably in a range of 440 nm to 600 nm.

The maximum absorption wavelength λmax is acquired in an air atmosphere at 25° C. using a spectrophotometer.

Specifically, the lithographic printing plate precursor before and after exposure is cut into a size of 30 mm×50 mm and measured by an ultraviolet-visible spectrophotometer (model number: U-3900, manufactured by Hitachi High-Tech Corporation) using an integrated sphere. A value at which the maximum absorption wavelength λ is maximized can be set to λmax based on a difference between the reflection spectra obtained from the lithographic printing plate precursor before and after the exposure.

<Developing Step>

The lithographic printing method according to the present disclosure includes a developing step of supplying acidic dampening water to the lithographic printing plate precursor after exposure to remove the non-image area of the image recording layer.

The developing step may be a developing step of performing development by supplying printing ink and acidic dampening water to the lithographic printing plate precursor after exposure and transferring the non-image area of the image recording layer onto a dampening roller.

In the developing step, it is preferable that the development is performed by a so-called on-press development method.

According to the on-press development method, it is preferable that a lithographic printing plate is prepared from the exposed lithographic printing plate precursor by supplying oil-based printing ink and acidic dampening water which is an aqueous component on the printing press to remove the image recording layer of the non-image area.

That is, in a case where the lithographic printing plate precursor is exposed and mounted on the printing press without performing any development treatment thereon or the lithographic printing plate precursor is mounted on the printing press, image-exposed on the printing press, and printing ink and acidic dampening water are supplied to perform printing, the uncured image recording layer is removed by being dissolved or dispersed by the supplied dampening water in the non-image area at an initial state of the printing so that the hydrophilic surface is exposed to the portion thereof. In the image area, an oil-based ink receiving unit having a lipophilic surface is formed. From the viewpoint of preventing contamination due to the components of the image recording layer from which acidic dampening water has been removed, it is preferable to supply acidic dampening water and printing ink and preferable to supply printing ink first in a case where acidic dampening water and printing ink are supplied. In this manner, the lithographic printing plate precursor is on-press developed on the printing press and used as it is for printing a plurality of sheets.

A known printing ink for lithographic printing is suitably used as the printing ink. The printing ink is not particularly limited, and various known inks (such as an oil-based ink, a UV ink, and a newspaper ink) can be used as desired.

According to the lithographic printing method of the present disclosure, a UV ink may be used in the developing step from the viewpoint that a lithographic printing plate with excellent printing durability can be obtained even in a case where a UV ink is used as the printing ink.

[Acidic Dampening Water]

A known dampening water composition for lithographic printing or a diluted composition thereof can be used as the acidic dampening water.

In the present disclosure, the acidic dampening water denotes dampening water obtained by dispersing a dampening water composition described below in 300 mL of water at a concentration of 2% by mass such that the pH of the dispersion liquid of the 2 mass % dampening water composition at a liquid temperature of 25° C. is less than 7.

Further, the pH of the dampening water in the present disclosure is a value measured at 25° C. using HM-30R (manufactured by DKK-TOA Corporation).

Further, in a case where the lithographic printing plate precursor has a protective layer described below as the outermost layer, it is assumed that a part of the protective layer is removed and a part thereof remains on the surface of the image area or permeates into the image area by the printing ink during on-press development.

Suitable examples of the acidic dampening water include the following dampening water composition.

Acidic dampening water is frequently concentrated and commercialized for commercial use and is used as acidic dampening water by appropriately diluting such a concentrated solution for use.

The dampening water composition used in the present disclosure may be used as it is as acidic dampening water or may be diluted and used.

—Water—

The dampening water composition used in the present disclosure may be a concentrated solution and does not necessarily contain water, but it is preferable that the dampening water composition contains water.

The water is not particularly limited, and examples thereof include tap water, well water, distilled water, ion exchange water, and pure water. Among these, distilled water, ion exchange water, or pure water is preferably used.

The content of water is the content of residues other than each component described below, and is preferably 10% by mass or greater, more preferably 20% by mass or greater and 99.99% by mass or less, still more preferably 30% by mass or greater and 99.9% by mass or less, and particularly preferably 40% by mass or greater and 99% by mass or less with respect to the total mass of the dampening water composition.

Further, in a case where the dampening water composition used in the present disclosure is a concentrated solution, it is preferable that the concentrated solution is diluted with water to approximately 5 times by volume to 1000 times by volume to obtain the dampening water for use.

—Solvent—

It is preferable that the dampening water composition used in the present disclosure contains a solvent.

As the solvent, an organic solvent is preferable, and a known organic solvent can be used.

Further, it is preferable that the solvent is a compound in a liquid state at 1 atm and 20° C.

Further, from the viewpoint of a property of supplying dampening water to the plate, the solvent contains preferably a compound having a boiling point of 150° C. or higher, more preferably a compound having a boiling point of 150° C. or higher and 300° C. or lower, still more preferably a compound having a boiling point of 150° C. or higher and 250° C. or lower, and particularly preferably a compound having a boiling point of 150° C. or higher and 200° C. or lower.

The solvent has a function of enhancing the property of supplying dampening water to the plate, and a solvent that can be replaced with isopropyl alcohol, which is frequently added to dampening water of the related art is preferable.

Preferred examples of the organic solvent include a compound represented by Formula (solA).

R^{sol}—O(CH₂CH(CH₃)O)m^{sol}—H Formula (solA)

In Formula (solA), R^{sol} represents an alkyl group having 1 to 4 carbon atoms (number of carbon atoms), and m^{sol} represents an integer of 1 to 3.

In Formula (solA), R^{sol} may represent a linear alkyl group or a branched alkyl group.

Among these, it is preferable that R^{sol} represents an n-propyl group, an isopropyl group, an n-butyl group, an isobutyl group, an s-butyl group, or a t-butyl group.

Specific examples of the compound represented by Formula (solA) include dipropylene glycol monopropyl ether, tripropylene glycol monopropyl ether, dipropylene glycol monoisopropyl ether, tripropylene glycol monoisopropyl ether, propylene glycol monobutyl ether, dipropylene glycol monobutyl ether, tripropylene glycol monobutyl ether, propylene glycol monoisobutyl ether, dipropylene glycol monoisobutyl ether, tripropylene glycol monoisobutyl ether, propylene glycol monotertiary butyl ether, dipropylene glycol monotertiary butyl ether, and tripropylene glycol monotertiary butyl ether. Among these, it is preferable that the dampening water composition contains at least one compound selected from the group consisting of propylene glycol monobutyl ether, propylene glycol monotertiary butyl ether, dipropylene glycol monopropyl ether, dipropylene glycol monobutyl ether, and dipropylene glycol monotertiary butyl ether as the solvent.

Further, preferred examples of the organic solvent include a compound represented by Formula (solB).

HO(CH₂CH(CH₃)O)n^{sol}—H Formula (solB)

In Formula (solB), n^{sol} represents an integer of 1 to 5.

Specific preferred examples of the compound represented by Formula (solB) include propylene glycol, dipropylene glycol, and tripropylene glycol.

Further, examples of the organic solvent include 2-ethyl-1,3-hexanediol, ethylene glycol monomethyl ether, diethylene glycol monomethyl ether, triethylene glycol monomethyl ether, polyethylene glycol monomethyl ether, ethylene glycol monoethyl ether, diethylene glycol monoethyl ether, triethylene glycol monoethyl ether, ethylene glycol monoisobutyl ether, diethylene glycol monoisobutyl ether, triethylene glycol monoisobutyl ether, ethylene glycol monopropyl ether, diethylene glycol monopropyl ether, triethylene glycol monopropyl ether, ethylene glycol monobutyl ether, ethylene glycol monotertiary butyl ether, diethylene glycol monobutyl ether, diethylene glycol monotertiary butyl ether, triethylene glycol monobutyl ether, triethylene glycol monotertiary butyl ether, 3-methoxy-3-methylbutanol, 3-methoxybutanol, trimethylolpropane, polypropylene glycol having a molecular weight of 200 to 1000, and monomethyl ether, monoethyl ether, monopropyl ether, monoisopropyl ether, monobutyl ether, monoisobutyl ether, and monotertiary butyl ether of compounds thereof.

The dampening water composition used in the present disclosure may contain only one or two or more kinds of solvents, but from the viewpoints of the property of supplying dampening water to the plate and the property of suppressing contamination of dampening water, the dampening water composition contains preferably two or more kinds of solvents and more preferably two to four kinds of solvents.

The content of the solvent is preferably in a range of 0.05% by mass to 70% by mass and more preferably in a range of 0.2% by mass to 60% by mass with respect to the total mass of the dampening water composition.

Further, in a case where the dampening water composition used in the present disclosure is used as it is as dampening water or the dampening water composition used in the present disclosure is prepared as a concentrated solution, diluted, and used as dampening water, the content of the solvent is preferably in a range of 0.05% by mass to 10% by mass and more preferably in a range of 0.2% by mass to 4% by mass with respect to the total mass of the dampening water.

—Water-Soluble Polymer Compound—

From the viewpoint of the property of suppressing contamination of the non-image area, it is preferable that the dampening water composition used in the present disclosure contains a water-soluble polymer compound.

Specific examples of the water-soluble polymer compound include gum arabic, starch derivatives (such as dextrin, enzymatically decomposed dextrin, hydroxypropylated enzymatically decomposed dextrin, carboxymethylated starch, phosphoric acid starch, and octenyl succinated starch), an alginate, natural products of fibrous derivatives (such as carboxymethyl cellulose, carboxyethyl cellulose, hydroxyethyl cellulose, methyl cellulose, hydroxypropyl cellulose, hydroxypropylmethyl cellulose, and a glyoxal modified product thereof) and modified products thereof, and polyvinyl alcohol and derivatives thereof, and synthetic products such as polyvinylpyrrolidone, polyacrylamide and copolymers thereof, polyacrylic acid and copolymers thereof, a vinylmethyl ether/maleic acid anhydride copolymer, a vinyl acetate/maleic acid anhydride copolymer, polyallylamine, a polyallylamine salt, polydiallylamine, and a polydiallylamine salt.

Among the above-described water-soluble polymer compounds, at least one compound selected from the group consisting of hydroxypropyl cellulose, hydroxypropylmethyl cellulose, and polyvinylpyrrolidone is particularly preferable.

The dampening water composition used in the present disclosure may contain only one or two or more kinds of water-soluble polymer compounds.

The content of the water-soluble polymer compound is preferably in a range of 0.0001% by mass to 5% by mass, more preferably in a range of 0.001% by mass to 1% by mass, and particularly preferably in a range of 0.003% by mass to 1% by mass with respect to the total mass of the dampening water composition.

Further, in a case where the dampening water composition used in the present disclosure is used as it is as dampening water or the dampening water composition used in the present disclosure is prepared as a concentrated solution, diluted, and used as dampening water, from the viewpoint of the property of suppressing contamination of dampening water, the content of the water-soluble polymer compound is preferably in a range of 0.0001% by mass to 1% by mass, more preferably in a range of 0.001% by mass to 0.3% by mass, and particularly preferably in a range of 0.005% by mass to 0.2% by mass with respect to the total mass of the dampening water composition or the dampening water.

—Acidic Compound (pH Adjuster)—

From the viewpoint of adjusting the pH in an acidic region, it is preferable that the dampening water composition used in the present disclosure contains an acidic compound.

Examples of the acidic compound include organic acids, inorganic acids, and salts thereof. Among these, the dampening water composition contains preferably an organic acid or a salt thereof and more preferably an organic acid as the acidic compound.

Examples of the organic acid include citric acid, maleic acid, fumaric acid, succinic acid, adipic acid, glutaric acid, ascorbic acid, malic acid, tartaric acid, propionic acid, lactic acid, acetic acid, glycolic acid, gluconic acid, oxalic acid, malonic acid, levulinic acid, sulfanic acid, p-toluenesulfonic acid, phytic acid, and organic phosphonic acid.

Examples of the inorganic acid include phosphoric acid, nitric acid, sulfuric acid, and polyphosphoric acid.

Further, an alkali metal salt, an alkaline earth metal salt, an ammonium salt, or an organic amine salt of these organic acids or inorganic acids are also suitably used.

The dampening water composition used in the present disclosure may contain only one or two or more kinds of acidic compounds.

The content of the acidic compound is preferably in a range of 0.001% by mass to 5% by mass with respect to the total mass of the dampening water composition.

—Basic Compound (pH Adjuster)—

From the viewpoint of adjusting the pH, the dampening water composition used in the present disclosure may contain a basic compound such as an alkali metal hydroxide, a phosphoric acid alkali metal salt, an alkali carbonate metal salt, or a silicate, but it is preferable that the dampening water composition contains no basic compound.

—Chelate Compound—

It is preferable that the dampening water composition used in the present disclosure contains a chelate compound.

In a case where the dampening water composition used in the present disclosure is diluted by adding tap water, well water, or the like and used as dampening water, it is possible to suppress the influence of calcium ions contained in tap water or well water used for dilution on printing and to suppress contamination of a printed material by allowing the dampening water composition to contain a chelate compound.

Examples of the chelate compound include aminopolycarboxylic acids such as ethylenediamine tetraacetic acid, a potassium salt thereof, and a sodium salt thereof; diethylenetriamine pentaacetic acid, a potassium salt thereof, and a sodium salt thereof; triethylenetetramine hexaacetic acid, a potassium salt thereof, and a sodium salt thereof; hydroxyethyl ethylenediamine triacetic acid, a potassium salt thereof, and a sodium salt thereof; nitrilotriacetic acid, a potassium salt thereof, and a sodium salt thereof; 1,2-diaminocyclohexane tetraacetic acid, a potassium salt thereof, and a sodium salt thereof; and 1,3-diamino-2-propanol tetraacetic acid, a potassium salt thereof, and a sodium salt thereof; and organic phosphonic acids such as 2-phosphonobutane tricarboxylic acid-1,2,4, a potassium salt thereof, and a sodium salt thereof; 2-phosphonobutane tricarboxylic acid-2,3,4, a potassium salt thereof, and a sodium salt thereof; 1-phosphonoethane tricarboxylic acid-1,2,2, a potassium salt thereof, and a sodium salt thereof; 1-hydroxyethane-1,1-diphosphonic acid, a potassium salt, and a sodium salt thereof; aminotri(methylenephosphonic acid), a potassium salt thereof, and a sodium salt thereof, and phosphonoalkane tricarboxylic acids.

An ammonium slat or an organic amine salt is also effective in place of the sodium salt or the potassium salt of the chelating agent described above.

The dampening water composition used in the present disclosure may contain only one or two or more kinds of chelate compounds.

The content of the chelate compound is preferably in a range of 0.001% by mass to 3% by mass and more preferably in a range of 0.01% by mass to 1% by mass with respect to the total mass of the dampening water composition.

—Surfactant—

From the viewpoint of improving wettability, it is preferable that the dampening water composition used in the present disclosure contains a surfactant.

Examples of the surfactant include an anionic surfactant, a nonionic surfactant, a cationic surfactant, and an amphoteric surfactant.

Examples of the anionic surfactant include fatty acid salts, abietates, hydroxyalkane sulfonates, alkane sulfonates, dialkyl sulfosuccinates, linear alkyl benzene sulfonates, branched chain alkyl benzene sulfonates, alkyl naphthalene sulfonates, alkylphenoxypolyoxyethylene propylsulfonates, polyoxyethylene alkylsulfophenyl ether salts, N-methyl-N-oleyl taurine sodiums, N-alkyl sulfosuccinic acid monoamide disodium salts, petroleum sulfonates, hardened castor oil, sulfated beef oil, sulfuric acid ester salts of fatty acid alkyl ester, alkyl sulfuric acid ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkyl phosphoric acid ester salts, polyoxyethylene alkyl ether phosphoric acid ester salts, polyoxyethylene alkyl phenyl ether phosphoric acid ester salts, partially saponified products of a styrene-maleic acid anhydride copolymer, partially saponified products of an olefin-maleic acid anhydride copolymer, and naphthalene sulfonate formalin condensates. Among these, dialkyl sulfosuccinates, alkyl sulfuric acid esters, and alkyl naphthalene sulfonates are particularly preferable.

Examples of nonionic surfactant include polyoxy alkyl ethers, polyoxyethylene alkyl phenyl ethers, polyoxyethylene polystyryl phenyl ether, polyoxyethylene polyoxypropylene alkyl ether, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyglycerin fatty acid partial esters, polyoxyethylene castor oils, polyoxyethylene glycerin fatty acid partial esters, fatty acid diethanolamides, N,N-bis-2-hydroxyalkylamines, polyoxyethylene alkylamine, triethanolamine fatty acid ester, and trialkylamine oxide. Among these, polyoxyethylene alkyl phenyl ethers and polyoxyethylene-polyoxypropylene block polymers are preferable.

Examples of the cationic surfactant include alkylamine salts, quatemary ammonium salts, polyoxyethylene alkylamine salts, and polyethylene polyamine derivatives.

Further, examples of the amphoteric surfactant include alkylimidazolines.

Further, a fluorine-based surfactant can be suitably used as a surfactant.

Examples of the fluorine-based anionic surfactant include a perfluoroalkyl sulfonate, a perfluoroalkyl carboxylate, and perfluoroalkyl phosphoric acid ester, and examples of the fluorine-based nonionic surfactant include a perfluoroalkyl ethylene oxide adduct and a perfluoroalkyl propylene oxide adduct.

Examples of the fluorine-based cationic surfactant include a perfluoroalkyltrimethylammonium salt.

The dampening water composition used in the present disclosure may contain only one or two or more kinds of surfactants.

The content of the surfactant is preferably 10% by mass or less and more preferably in a range of 0.01% by mass to 3% by mass with respect to the total mass of the dampening water composition.

—Hydrotrope Compound—

From the viewpoint of reducing the viscosity of the composition and improving the solubility of a component such as a solvent in water, it is preferable that the dampening water composition used in the present disclosure contains a hydrotrope compound.

As the hydrotrope compound, an aromatic sulfonate such as a toluene sulfonate, a xylene sulfonate, or a cumene sulfonate can be preferably used. Preferred examples of these salt structures include an alkali metal salt, an ammonium salt, and an amine salt.

The dampening water composition used in the present disclosure may contain only one or two or more kinds of hydrotrope compounds.

The content of the hydrotrope compound is preferably in a range of 0.001% by mass to 5% by mass and more preferably in a range of 0.01% by mass to 3% by mass with respect to the total mass of the dampening water composition.

—Wetting Agent—

From the viewpoint of improving the wettability, it is preferable that the dampening water composition used in the present disclosure contains a wetting agent.

Preferred examples of the wetting agent include glycols and alcohols.

Examples of such a wetting agent include propylene glycol, dipropylene glycol, tripropylene glycol, tetrapropylene glycol, and pentapropylene glycol, ethylene glycol, diethylene glycol, triethylene glycol, polyethylene glycol, butylene glycol, hexylene glycol, ethyl alcohol, n-propyl alcohol, benzyl alcohol, glycerin, diglycerin, polyglycerin, and pentaerythritol.

The dampening water composition used in the present disclosure may contain only one or two or more kinds of wetting agents.

The content of the wetting agent is preferably in a range of 0.1% by mass to 3% by mass and more preferably in a range of 0.3% by mass to 2% by mass with respect to the total mass of the dampening water composition.

The dampening water composition used in the present disclosure can completely replace isopropyl alcohol.

Further, the print quality is not problematic even in a case where isopropyl alcohol, ethanol, n-propanol, t-butanol, amyl alcohol, and the like are used in combination up to an amount of approximately 15% by mass in dampening water at the time of use.

—Diol Compound—

From the viewpoint of improving the solubility of other components and suppressing contamination of a water supply roller, it is preferable that the dampening water composition used in the present disclosure contains a diol compound.

Specific preferred examples of the diol compound include 2-butyl-2-ethyl-1,3-propanediol, 2,4-diethyl-1,5-pentanediol, and 2-ethyl-1,3-hexanediol.

Further, the diol compound described in JP2009-96177A can be suitably used as the diol compound.

Further, as the diol compound, a diol compound which contains two hydroxy groups and in which the number of the shortest carbon atoms between the two hydroxy groups is in a range of 2 to 6, and the total number of carbon atoms is 9 is particularly preferable.

The dampening water composition used in the present disclosure may contain only one or two or more kinds of diol compounds.

The content of the diol compound is preferably in a range of 0.001% by mass to 2% by mass, more preferably in a range of 0.005% by mass to 1% by mass, still more preferably in a range of 0.01% by mass to 0.7% by mass, and particularly preferably in a range of 0.02% by mass to 0.5% by mass with respect to the total mass of the dampening water composition.

—Pyrrolidone Derivative—

From the viewpoint of improving the wettability, it is preferable that the dampening water composition used in the present disclosure contains a pyrrolidone derivative.

Preferred examples of the pyrrolidone derivative include a compound represented by Formula (pyr).

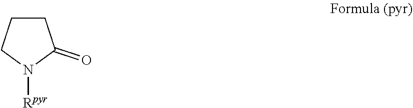

In Formula (pyr), R^{pyr} represents an alkyl group having 2 to 12 carbon atoms.

Specific examples of the pyrrolidone derivative include ethylpyrrolidone, butylpyrrolidone, pentylpyrrolidone, hexylpyrrolidone, octylpyrrolidone, and laurylpyrrolidone. These compounds may be used alone or in combination of two or more kinds thereof.

Among these compounds, a compound in which R^{pyr} in Formula (pyr) represents an alkyl group having 6 or more carbon atoms is preferable, and octylpyrrolidone is particularly preferable.

The dampening water composition used in the present disclosure may contain only one or two or more kinds of pyrrolidone derivatives.

The content of the pyrrolidone derivative is preferably in a range of 0.001% by mass to 2% by mass, more preferably in a range of 0.001% by mass to 1% by mass, and particularly preferably in a range of 0.01% by mass to 1% by mass with respect to the total mass of the dampening water composition.

—Acetylene Glycols, Acetylene Alcohols, and Alkylene Oxide Adducts Thereof—

The dampening water composition used in the present disclosure may contain at least one compound selected from the group consisting of acetylene glycols, acetylene alcohols, and alkylene oxide adducts thereof. Preferred examples of the alkylene oxide include ethylene oxide and propylene oxide.

Specific examples of such compounds include 3,5-dimethyl-1-hexyne-3-ol, 2,5-dimethyl-3-hexyne-2,5-diol, 2,4,7,9-tetramethyl-5-decyne-4,7-diol, 3,6-dimethyl-4-octyne-3,6-diol, 2-butyne-1,4-diol, 3-methyl-1-butyne-3-ol, and ethylene oxide and/or propylene oxide adducts thereof. Among these, a compound in which 4 to 10 ethylene oxides are added to 3,6-dimethyl-4-octyne-3,6-diol, 2,4,7,9-tetramethyl-5-decyne-4,7-diol, or 2,4,7,9-tetramethyl-5-decyne-4,7-diol is preferable.

The dampening water composition used in the present disclosure may contain only one or two or more kinds of acetylene glycols, acetylene alcohols, and alkylene oxide adducts thereof.

The content of the acetylene glycols, the acetylene alcohols, and the alkylene oxide adducts thereof is preferably in a range of 0.0001% by mass to 5% by mass and more preferably in a range of 0.001% by mass to 2% by mass with respect to the total mass of the dampening water composition.

—Saccharides—

From the viewpoint of the property of suppressing contamination of the non-image area, it is preferable that the dampening water composition used in the present disclosure contains saccharides.

The saccharides can be selected from monosaccharides, disaccharides, and oligosaccharides and also include sugar alcohol obtained by hydrogenation. Specific examples include D-erythrose, D-threose, D-arabinose, D-ribose, D-xylose, D-erythro-penturose, D-allulose, D-galactose, D-glucose, D-mannose, D-talose, β-D-fructose, α-L-sorbose, 6-deoxy-D-glucose, D-glycero-D-galactose, α-D-allo-heptulose, β-D-altro-3-heptulose, saccharose, lactose, D-maltose, isomaltose, inulobiose, hyalbiouron, maltotriose, D,L-arabitol, ribitol, xylitol, D,L-sorbitol, D,L-mannitol, D,L-iditol, D,L-talitol, dulcitol, allodulcitol, maltitol, and reduced sugar syrup. These saccharides may be used alone or in combination of two or more kinds thereof.

The dampening water composition used in the present disclosure may contain only one or two or more kinds of saccharides.

The content of the saccharides is preferably in a range of 0.01% by mass to 2% by mass and more preferably in a range of 0.05% by mass to 1% by mass with respect to the total mass of the dampening water composition.

—Preservative—

From the viewpoint of the storage stability, it is preferable that the dampening water composition used in the present disclosure contains a preservative.

Specific examples of the preservative include benzoic acid and derivatives thereof, phenol and derivatives thereof, formalin, imidazole derivatives, sodium dehydroacetate, 4-isothiazolin-3-one derivatives, benzotriazole derivatives, amidine or guanidine derivatives, quaternary ammonium salts, pyridine, quinoline or guanidine derivatives, diazine or triazole derivatives, oxazole or oxazine derivatives, halogenonitropropane compounds, bromonitroalcohol-based bromonitropropanol, 1,1-dibromo-1-nitro-2-ethanol, and 3-bromo-3-nitropentane-2,4-diol.

The dampening water composition used in the present disclosure may contain only one or two or more kinds of preservatives.

The content of the preservative varies depending on the kind of bacteria, mold, and yeasts, but is preferably in a range of 0.0001% by mass to 1% by mass with respect to the total mass of the dampening water composition.

—Other Additives—

The dampening water composition used in the present disclosure may contain other additives in addition to those described above.

The other additives are not particularly limited, and known additives can be used, and examples thereof include colorants, rust inhibitors, antifoaming agents, flavoring agents, and masking agents.

As the colorant, a food coloring agent or the like can be preferably used. Examples of the food coloring agent include yellow coloring agents such as CI Nos. 19140 and 15985, red coloring agents such as CI Nos. 16185, 45430, 16255, 45380, and 45100, purple coloring agents such as CI No. 42640, blue coloring agents such as CI Nos. 42090 and 73015, and green coloring agents such as CI No. 42095.

Examples of the rust inhibitor include benzotriazole, 5-methylbenzotriazole, thiosalicylic acid, benzimidazole, and derivatives thereof.

Preferred examples of the antifoaming agent include a silicone antifoaming agent. As the silicone antifoaming agent, any of an emulsified dispersion type antifoaming agent or a solubilized type antifoaming agent can be used. In addition, a non-silicone-based antifoaming agent can be used alone or in combination.

The dampening water composition used in the present disclosure may further contain a corrosion inhibitor such as magnesium nitrate, zinc nitrate, calcium nitrate, sodium nitrate, potassium nitrate, lithium nitrate, or ammonium nitrate, a hardening agent such as a chromium compound or an aluminum compound, a cyclic ether, for example, an organic solvent such as 4-butyrolactone, and a water-soluble surface-active organic metallic compound described in JP1986-193893A (JP-S61-193893A).

The content of each of the other additives is preferably in a range of 0.0001% by mass to 1% by mass with respect to the total mass of the dampening water composition, independently.

—pH of Acidic Dampening Water—

From the viewpoints of the UV printing durability and the property of suppressing residual color, the pH of the acidic dampening water (diluted composition) in a case where the dampening water composition used in the present disclosure is used as it is or diluted and used as acidic dampening water is preferably 2 or greater and less than 7, more preferably 3 or greater and 6 or less, and particularly preferably 4 or greater and 5.5 or less.

<Printing Step>

The lithographic printing method according to the present disclosure includes a printing step of performing printing using a lithographic printing plate obtained by the development with printing ink and acidic dampening water.

The printing ink used in the printing step is not particularly limited, and various known inks can be used as desired. Further, preferred examples of the printing ink include oil-based ink and ultraviolet curable ink (that is, UV ink).

Further, the printing step may be performed continuously with the on-press developing step or the developer developing step without stopping the printing press.

The recording medium is not particularly limited, and a known recording medium can be used as desired.

The lithographic printing method according to the present disclosure may include heating of the entire surface of the lithographic printing plate precursor before or during the exposure or between the exposure and the development as necessary. In a case where the surface is heated in the above-described manner, there is an advantage that the image forming reaction in the image recording layer is promoted, the sensitivity and the printing durability are improved, and the sensitivity is stabilized. In a case where the surface is heated before the development, it is preferable that the heating is performed under a mild temperature condition of 150° C. or lower. In this manner, problems of curing the non-image area and the like can be prevented. In a case where the surface is heated after the development, it is preferable that the heating is performed under a higher temperature condition than the condition described above and preferable that the heating is performed at 100° C. to 500° C. In a case where the temperature is in the above-described range, a sufficient image strengthening effect can be obtained, and problems such as deterioration of the support and thermal decomposition of the image area can be suppressed.

In the lithographic printing method according to the present disclosure, the exposing step, the developing step, and the printing step are performed on one lithographic printing plate precursor, but in a case where a plurality of lithographic printing plate precursors are prepared in the preparing step, the exposing step, the developing step, and the printing step may be performed on each of those plates.

<Drying Step>

From the viewpoints of the UV printing durability and the property of suppressing residual color, it is preferable that the lithographic printing method according to the present disclosure further includes a drying step of drying the acidic dampening water on the lithographic printing plate obtained by development.

The method of drying the acidic dampening water is not particularly limited, and the acidic dampening water may be dried by natural drying or by a known drying method used in the lithographic printing method.

The drying temperature is preferably in a range of 10° C. to 60° C. and more preferably in a range of 20° C. to 30° C.

Further, the drying time is not particularly limited, but is preferably in a range of 10 minutes to 180 minutes and more preferably in a range of 30 minutes to 120 minutes.

<Mounting Step>

It is preferable that the lithographic printing method according to the present disclosure includes a mounting step of mounting the exposed lithographic printing plate precursor on a plate cylinder of a printing press.

A known printing press and a plate cylinder can be used as the printing press and the plate cylinder to be used, and the printing press and the plate cylinder may be appropriately selected as desired.

Further, in the mounting step, the method of mounting the lithographic printing plate precursor on the plate cylinder and the fixing method are not particularly limited, and can be performed by known methods.

<Other Steps>

The lithographic printing method according to the present disclosure may include known steps other than the above-described steps. Examples of the other steps include a plate inspection step of confirming the position, the orientation, and the like of the lithographic printing plate precursor before each step and a confirmation step of confirming the printed image after the developing step.

<<Lithographic Printing Plate Precursor>>

Next, the lithographic printing plate precursor used in the lithographic printing method according to the present disclosure will be described.

The lithographic printing plate precursor used in the present disclosure includes an aluminum support described below, and an image recording layer containing an acid color developing agent and an acid generator on the aluminum support.

The lithographic printing plate precursor used in the present disclosure is not particularly limited, and a known positive tone or negative tone lithographic printing plate precursor can be used.

Among the lithographic printing plate precursors, a negative tone lithographic printing plate precursor is preferable from the viewpoint of further exhibiting the effects of the printing durability and the property of suppressing residual color.

The lithographic printing plate precursor used in the present disclosure may further include known layers such as a protective layer and an undercoat layer in addition to the image recording layer. The protective layer, the undercoat layer, and the like are not particularly limited, and known layers can be used.

<Aluminum Support>

The aluminum support in the lithographic printing plate precursor used in the present disclosure (hereinafter, also simply referred to as “support”) includes an aluminum plate and an anodized aluminum film disposed on the aluminum plate, the anodized film is positioned on a side of the image recording layer with respect to the aluminum plate, the anodized film has micropores extending from a surface of the anodized film on the side of the image recording layer in a depth direction, and the average diameter of the micropores in the surface of the anodized film is greater than 10 nm and 100 nm or less, and the specific surface area ΔS which is a value acquired by Equation (i) for a geometrically measured area So and an actual area Sₓ obtained by an approximate three-point method, based on three-dimensional data obtained by measuring 512×512 points in a range of 25 μm×25 μm on the surface of the anodized film on the side of the image recording layer using an atomic force microscope is 15% or greater and 60% or less.

ΔS=(Sₓ−S₀)/S₀×100(%) (i)

As the aluminum support in the present disclosure, an aluminum plate which has been subjected to a roughening treatment and an anodization treatment using known methods is preferable. That is, the aluminum support in the present disclosure includes an aluminum plate and an anodized aluminum film disposed on the aluminum plate.

An example of a preferred embodiment of the aluminum support used in the present disclosure (the aluminum support according to this example is also referred to as a “support (1)”) is described below.

That is, it is preferable that the support (1) includes an aluminum plate and an anodized aluminum film disposed on the aluminum plate, and the anodized film is positioned closer to a side of the image recording layer than a side of the aluminum plate, the anodized film has micropores extending from the surface on the side of the image recording layer in the depth direction, the average diameter of the micropores in the surface of the anodized film is greater than 10 nm and 100 nm or less, and the value of the brightness L* in the L*a*b* color system of the surface of the anodized film on the side of the image recording layer is in a range of 70 to 100.

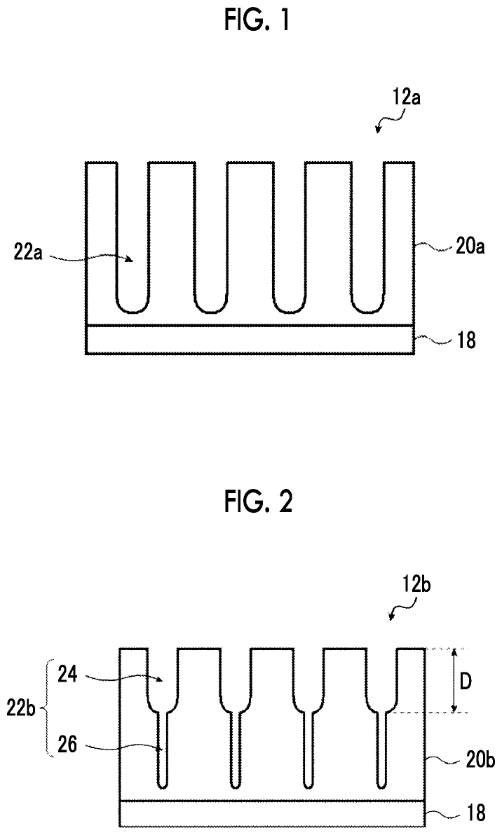

FIG. 1 is a schematic cross-sectional view illustrating an embodiment of an aluminum support 12a.

The aluminum support 12a has a laminated structure in which an aluminum plate 18 and an anodized aluminum film 20a (hereinafter, also simply referred to as an “anodized film 20a”) are laminated in this order. Further, the anodized film 20a in the aluminum support 12a is positioned closer to the side of the image recording layer than the side of the aluminum plate 18. That is, it is preferable that the lithographic printing plate precursor used in the present disclosure includes at least an anodized film and an image recording layer in order, on the aluminum plate.

—Anodized Film—

In the support used for the lithographic printing method according to the present disclosure, the anodized film is positioned on the side of the image recording layer with respect to the aluminum plate, and the anodized film has micropores extending from the surface of the anodized film on the side of the image recording layer in the depth direction.

Hereinafter, preferred embodiments of the anodized film 20a illustrated in FIG. 1 will be described.

The anodized film 20a is a film to be prepared on a surface of the aluminum plate 18 by performing an anodization treatment, and this film is substantially perpendicular to the film surface and has extremely fine micropores 22a uniformly distributed. The micropores 22a extend along the thickness direction (the aluminum plate 18 side) from the surface (the surface of the anodized film 20a on a side opposite to a side where the aluminum plate 18 is provided) of the anodized film 20a on the side of the image recording layer.

—Average Diameter of Micropores in Surface of Anodized Film—

The average diameter (average opening diameter, hereinafter, also simply referred to as “average diameter”) of the micropores 22a in the surface of the anodized film 20a is greater than 10 nm and 100 nm or less.

From the viewpoint of the balance between the UV printing durability, the property of suppressing residual color, and the image visibility, the average diameter thereof is more preferably in a range of 12.5 nm to 60 nm, still more preferably in a range of 15 nm to 50 nm, and particularly preferably in a range of 20 nm to 40 nm. The diameter inside the pores may be larger or smaller than that of the surface layer.

In a case where the average diameter thereof is greater than 10 nm, the UV printing durability, the property of suppressing residual color, and the image visibility are more excellent. Further, in a case where the average diameter thereof is 100 nm or less, the UV printing durability and the property of suppressing residual color are more excellent.

The average diameter of micropores 22a is calculated as an arithmetic average value obtained by observing 4 sheets (N=4) of the surfaces of the anodized film 20a using a field emission scanning electron microscope (FE-SEM) at a magnification of 150000, measuring the diameters of 50 micropores present in a range of 400 nm×600 nm in the obtained four sheets of images, and averaging the values.

Further, in a case where the shape of the micropores 22a is not circular, an equivalent circle diameter is used. The “equivalent circle diameter” is a diameter of a circle obtained by assuming the shape of an opening portion of a micropore as a circle having the same projected area as the projected area of the opening portion.

The depth of the micropores 22a is not particularly limited, but is preferably in a range of 10 nm to 3000 nm, more preferably in a range of 50 nm to 2000 nm, and still more preferably 300 nm to 1600 nm.

Further, the depth thereof is a value obtained by capturing (150000 times) an image of a cross section of the anodized film 20a, measuring the depth of 25 or more micropores 22a, and averaging the obtained values.

The shape of the micropores 22a is not particularly limited, and the shape thereof in FIG. 1 may be a substantially straight tubular shape (substantially columnar shape), but may be a conical shape whose diameter decreases toward the depth direction (thickness direction). Further, the shape of the bottom portion of the micropores 22a is not particularly limited, but may be a curved shape (projection shape) or a planar shape.

The value of the brightness L* in the L*a*b* color system of the surface of the aluminum support 12a on the side of the image recording layer (the surface of the anodized film 20a on the side of the image recording layer) is preferably in a range of 70 to 100. Here, from the viewpoint that the balance between the printing durability and the image visibility is more excellent, the value thereof is preferably in a range of 75 to 100 and more preferably in a range of 75 to 90.

The brightness L* is measured using a color difference meter Spectro Eye (manufactured by X-Rite Inc.).

A steepness a45 indicating the area ratio of a portion having an inclining degree of 45° or greater which is obtained by extracting components at a wavelength of 0.2 μm to 2 μm, on the surface of the anodized film 20a on the side of the image recording layer 16, is not particularly limited, but is preferably in a range of 2% to 30%, more preferably in a range of 2% to 25%, still more preferably in a range of 5% to 20%, and particularly preferably in a range of 5% to 18% from the viewpoint that stain resistance and deinking capability after being left to stand are more excellent.

The steepness a45 is a factor representing the surface shape and is a value acquired according to the following procedures (1) to (3).

(1) The surface shape is measured to acquire three-dimensional data.

Further, the surface shape of the aluminum support 12a on the anodized film 20a side is measured using an atomic force microscope (AFM) to acquire three-dimensional data.

The measurement is performed under the following conditions. Specifically, the aluminum support 12a is cut into a size of 1 cm² and set on a horizontal sample stand that is provided on a piezo scanner, a cantilever is allowed to approach the surface of the sample, scanning is performed in the XY direction when reaching a region where atomic force works, and the unevenness of the sample is captured by the displacement of the piezo in the Z direction. A piezo scanner capable of performing scanning a distance of 150 μm in the XY direction and a distance of 10 μm in the Z direction is used as the piezo scanner. The measurement is performed using a cantilever having a resonance frequency of 120 kHz to 150 kHz and a spring constant of 12 N/m to 20 N/m (SI-DF20, manufactured by Nanoprobes Inc.) in a dynamic force mode (DFM) as the cantilever. Further, by carrying out the least squares approximation of the acquired three-dimensional data, the slight inclination of the sample is corrected to acquire a reference surface.

During the measurement, 512×512 points in an area having a size of 25 μm×25 μm on the surface are measured. The resolution in the XY direction is 1.9 μm, the resolution in the Z direction is 1 nm, and the scanning speed is 60 μm/sec.

(2) The correction is performed.

In the calculation of the steepness a45, correction is made such that a component having a wavelength of 0.2 μm to 2 μm is selected from the three-dimensional data which has been acquired in the item (1) described above, and the component is used. Due to this correction, in a case where a surface of an aluminum support or the like used in the lithographic printing plate precursor which has deep unevenness is scanned using a probe of an AFM, a noise occurring in a case where the probe strikes an edge portion of a projection and springs so that a portion other than a pointed end of the probe is brought into contact with a wall surface of a deep depression can be eliminated.

The correction is carried out by performing fast Fourier transformation on the three-dimensional data acquired in the item (1) described above to acquire the frequency distribution, selecting a component having a wavelength of 0.2 to 2 μm, and performing Fourier inverse transformation.

(3) The steepness a45 is calculated.

Three points adjacent to one another are extracted using the three-dimensional data (f(x, y)) obtained by performing correction in (2) described above, an angle between a small triangle formed of these three points and the reference surface is calculated for all pieces of data to acquire the inclining degree distribution curve. In addition, the sum of the area of the small triangle is acquired and this area is set as the actual area. Based on the inclining degree distribution curve, the steepness a45 (unit: %) which is a ratio of the area of a portion having an inclining degree of 45° or greater to the actual area is calculated.

[Specific Surface Area ΔS]

In the support used for the lithographic printing method according to the present disclosure, the specific surface area ΔS which is a value acquired by Equation (i) for the geometrically measured area S₀ and the actual area Sₓ obtained by the approximate three-point method, based on three-dimensional data obtained by measuring 512×512 points in a range of 25 μm×25 μm on the surface of the anodized film 20a on the side of the image recording layer 16 using an atomic force microscope is 15% or greater and 60% or less,

ΔS=(Sₓ−S₀)/S₀×100(%) (i).

The geometrically measured area S₀ is an area in a range of 25 μm×25 μm.

From the viewpoint of the UV printing durability and the property of suppressing residual color, the specific surface area ΔS is preferably 20% or greater and 60% or less, more preferably in a range of 20% to 50%, and still more preferably in a range of 25% to 45%.

The specific surface area ΔS can be adjusted by changing the temperature of the alkaline aqueous solution used in the alkali etching treatment described below and controlling the etching amount of aluminum on the surface on which the roughening treatment has been performed.

According to the method of measuring ΔS described above, the three-dimensional data (f(x, y)) is obtained according to the same procedures as in the item (1) that is to be performed in a case of calculating the steepness a45.

Next, three points adjacent to one another are extracted using the three-dimensional data (f(x, y)) acquired in the above-described manner, the sum of the area of the small triangle formed of these three points is acquired, and this area is defined as the actual area Sₓ.

The surface area difference ΔS, that is, the specific surface area ΔS, is acquired from the obtained actual area Sₓ and the geometrically measured area So by Equation (i).

Specifically, the method of measuring ΔS is performed by cutting the aluminum support into a size of 1 cm² to obtain a sample, setting the sample on a horizontal sample stand that is provided on a piezo scanner, allowing a cantilever to approach the surface of the sample, performing scanning in the XY direction after reaching a region where the atomic force works, and capturing the unevenness of the sample by the displacement of the piezo in the Z direction. A piezo scanner capable of performing scanning a distance of 150 μm in the XY direction and a distance of 10 μm in the Z direction is used as the piezo scanner. The measurement is performed using a cantilever having a resonance frequency of 130 kHz to 200 kHz and a spring constant of 7 N/m to 20 N/m (OMCL-AC200-TS, manufactured by Olympus Corporation) in a dynamic force mode (DFM). Further, by carrying out the least squares approximation of the acquired three-dimensional data, the slight inclination of the sample is corrected to acquire a reference surface.

In addition, the measurement is performed by measuring 512×512 points in a range of 25 μm×25 μm on the surface of the sample. The specific surface area is acquired by setting the resolution in the X direction to 0.05 μm, the resolution in the Y direction to 1.9 μm, the resolution in the Z direction to 1 nm, and the scan speed to 18 μm/sec.

In the support (1), from the viewpoint of the UV printing durability and the property of suppressing residual color, an aspect in which the micropores are formed of large-diameter pores extending to a position at a depth of 10 nm to 1000 nm from the surface of the anodized film and small-diameter pores communicating with bottom portions of the large-diameter pores and extending to a position at a depth of 20 nm to 2000 nm from the communication positions, the average diameter of the large-diameter pores in the surface of the anodized film is in a range of 15 nm to 100 nm, and the average diameter of the small-diameter pores at the communication position is 13 nm or less (hereinafter, a support according to the above-described aspect will also be referred to as a “support (2)”) is also preferable.

FIG. 2 is a schematic cross-sectional view illustrating another embodiment of the aluminum support 12a other than the aluminum support illustrated in FIG. 1.

In FIG. 2, an aluminum support 12b includes the aluminum plate 18 and an anodized film 20b having micropores 22b formed of large-diameter pores 24 and small-diameter pores 26.

The micropores 22b in the anodized film 20b are formed of large-diameter pores 24 extending to a position at a depth (depth D: see FIG. 2) of 10 nm to 1000 nm from the surface of the anodized film and small-diameter pores 26 communicating with bottom portions of the large-diameter pores 24 and extending to a position at a depth of 20 nm to 2000 nm from the communication positions.

Hereinafter, the large-diameter pores 24 and the small-diameter pores 26 will be described in detail.

The average diameter of the large-diameter pores 24 in the surface of the anodized film 20b is the same as the average diameter of the micropores 22a in the surface of the anodized film 20a, and the average diameter thereof is, for example, preferably in a range of 20 nm to 100 nm, and from the viewpoints of the UV printing durability and the property of suppressing residual color, preferably in a range of 12.5 nm to 60 nm, more preferably in a range of 15 nm to 50 nm, and particularly preferably in a range of 20 nm to 40 nm.

The method of measuring the average diameter of the large-diameter pores 24 in the surface of the anodized film 20b is the same as the method of measuring the average diameter of the micropores 22a in the surface of the anodized film 20a.

The bottom portions of the large-diameter pores 24 are positioned at a depth of 10 nm to 1000 nm (hereinafter, also referred to as a depth D) from the surface of the anodized film. That is, the large-diameter pores 24 are pores extending from the surface of the anodized film to a position at a depth of 10 nm to 1000 nm in the depth direction (thickness direction).

Further, from the viewpoints of the UV printing durability and the property of suppressing residual color, the depth of the large-diameter pores is preferably in a range of 10 nm to 650 nm, more preferably in a range of 10 nm to 200 nm, and still more preferably in a range of 10 nm to 130 nm.

Further, the depth thereof is a value obtained by capturing (at a magnification of 150000) an image of a cross section of the anodized film 20b, measuring the depth of 25 or more large-diameter pores 24, and averaging the obtained values.

The shape of the large-diameter pores 24 is not particularly limited, and examples thereof include a substantially straight tubular shape (substantially columnar shape) and a conical shape whose diameter decreases toward the depth direction (thickness direction). Among these, a substantially straight tubular shape is preferable.

The small-diameter pores 26, as illustrated in FIG. 2, are pores communicating with the bottom portions of the large-diameter pores 24 and extending from the communication positions in the depth direction (thickness direction).

The average diameter of the small-diameter pores 26 in the communication position is preferably 13 nm or less. Further, the average diameter thereof is preferably 11 nm or less and more preferably 10 nm or less. The lower limit thereof is not particularly limited, but is 5 nm or greater in many cases.

The average diameter of small-diameter pores 26 is acquired by observing 4 sheets (N=4) of the surfaces of the anodized film 20b using a FE-SEM at a magnification of 150000 times, measuring the diameters of micropores (small-diameter pores) present in a range of 400 nm×600 nm in the obtained four sheets of images, and calculating the arithmetic average value thereof. Further, in a case where the depth of the large-diameter pores is large, the average diameter of the small-diameter pores may be acquired by cutting the upper portion (region where large-diameter pores are present) of the anodized film 20b (for example, cutting the portion by argon gas) as necessary and observing the surface of the anodized film 20b using the above-described FE-SEM.

Further, in a case where the shape of the small-diameter pores 26 is not circular, an equivalent circle diameter is used. The “equivalent circle diameter” is a diameter of a circle obtained by assuming the shape of an opening portion of a micropore as a circle having the same projected area as the projected area of the opening portion.

The bottom portions of the small-diameter pores 26 are in a position extending from the communication positions with the large-diameter pores 24 to a depth of 20 nm to 2000 nm in the depth direction. That is, the small-diameter pores 26 are pores extending from the communication positions with the large-diameter pores 24 in the depth direction (thickness direction), and the depth of the small-diameter pores 26 is in a range of 20 nm to 2000 nm. Further, the depth thereof is preferably in a range of 500 nm to 1500 nm.

In addition, the depth thereof is a value obtained by capturing (50000 times) an image of a cross section of the anodized film 20b, measuring the depth of 25 or more small-diameter pores, and averaging the obtained values.

The shape of the small-diameter pores 26 is not particularly limited, and examples thereof include a substantially straight tubular shape (substantially columnar shape) and a conical shape whose diameter decreases toward the depth direction. Among these, a substantially straight tubular shape is preferable.

—Method of Producing Aluminum Support—

As a method of producing the aluminum support used in the present disclosure, for example, a production method in which the following steps are sequentially performed is preferable.
Roughening treatment step: a step of performing a roughening treatment on an aluminum plate
Anodization treatment step: a step of anodizing the aluminum plate which has been subjected to the roughening treatment
Pore widening treatment step: a step of widening the diameters of micropores in the anodized film by bringing the aluminum plate having the anodized film obtained in the anodization treatment step into contact with an acid aqueous solution or an alkaline aqueous solution

Hereinafter, the procedures of each step will be described in detail.

[Roughening Treatment Step]

The roughening treatment step is a step of performing a roughening treatment including an electrochemical roughening treatment on a surface of an aluminum plate. It is preferable that the present step is performed before the anodization treatment step described below, but may not be performed particularly in a case where the surface of the aluminum plate already has a preferable surface shape.

The roughening treatment may be carried out by performing only an electrochemical roughening treatment, but may be carried out by combining an electrochemical roughening treatment and a mechanical roughening treatment and/or a chemical roughening treatment.

In a case where the mechanical roughening treatment and the electrochemical roughening treatment are used in combination, it is preferable that the electrochemical roughening treatment is performed after the mechanical roughening treatment.

It is preferable that the electrochemical roughening treatment is performed in an aqueous solution mainly containing nitric acid or hydrochloric acid using the direct current or the alternating current.

The method of performing the mechanical roughening treatment is not particularly limited, and the methods described in JP1975-040047B (JP-S50-040047B) are exemplified.

The chemical roughening treatment is also not particularly limited, and known methods are exemplified.

It is preferable that a chemical etching treatment described below is performed after the mechanical roughening treatment.

The chemical etching treatment to be performed after the mechanical roughening treatment is performed in order to smooth an edge portion of the uneven shape of the surface of the aluminum plate, prevent the ink from being caught during printing, improve the stain resistance of the printing plate, and remove unnecessary matter such as polishing material particles remaining on the surface.

Examples of the chemical etching treatment include etching carried out using an acid and etching carried out using an alkali, and a chemical etching treatment (hereinafter, also referred to as an “alkali etching treatment”) carried out using an alkaline aqueous solution is exemplified as a particularly excellent method in terms of etching efficiency.

An alkali agent used for the alkaline aqueous solution is not particularly limited, and examples thereof include caustic soda, caustic potash, sodium metasilicate, soda carbonate, soda aluminate, and soda gluconate.

The alkaline aqueous solution may contain aluminum ions.

The concentration of the alkali agent in the alkaline aqueous solution is preferably 0.01% by mass or greater, more preferably 3% by mass or greater, and preferably 30% by mass or less.

The specific surface area ΔS can be adjusted by changing the temperature of the alkaline aqueous solution used in the alkali etching treatment to control the etching amount of aluminum on the surface on which the roughening treatment has been performed.

From the above-described viewpoint, the liquid temperature of the alkaline aqueous solution is preferably in a range of 20° C. to 80° C., more preferably in a range of 20° C. to 70° C., still more preferably in a range of 20° C. to 55° C., and particularly preferably in a range of 25° C. to 55° C.

In a case where the alkali etching treatment is performed, it is preferable that the chemical etching treatment (hereinafter, also referred to as a “desmutting treatment”) is performed using an acidic aqueous solution at a low temperature in order to remove a product generated due to the alkali etching treatment.

The acid used for the acidic aqueous solution in the desmutting treatment is not particularly limited, and examples thereof include sulfuric acid, nitric acid, and hydrochloric acid. From the viewpoints of the UV printing durability and the property of suppressing residual color, the temperature of the acidic aqueous solution is preferably in a range of 20° C. to 80° C., more preferably in a range of 25° C. to 40° C., and still more preferably in a range of 30° C. to 40° C.

It is preferable that the roughening treatment step is performed according to a method of performing the treatments shown in the aspect A or the aspect B in order described below.

˜A Aspect˜
(2) A chemical etching treatment carried out using an alkaline aqueous solution (first alkali etching treatment)
(3) A chemical etching treatment carried out using an acidic aqueous solution (first desmutting treatment)
(4) An electrochemical roughening treatment carried out using an aqueous solution that mainly contains nitric acid (first electrochemical roughening treatment)
(5) A chemical etching treatment carried out using an alkaline aqueous solution (second alkali etching treatment)
(6) A chemical etching treatment carried out using an acidic aqueous solution (second desmutting treatment)
(7) Electrochemical roughening treatment carried out in aqueous solution mainly containing hydrochloric acid (second electrochemical roughening treatment)
(8) A chemical etching treatment carried out using an alkaline aqueous solution (third alkali etching treatment)
(9) A chemical etching treatment carried out using an acidic aqueous solution (third desmutting treatment)

˜B Aspect˜
(10) A chemical etching treatment carried out using an alkaline aqueous solution (fourth alkali etching treatment)
(11) A chemical etching treatment carried out using an acidic aqueous solution (fourth desmutting treatment)
(12) An electrochemical roughening treatment carried out using an aqueous solution that mainly contains hydrochloric acid (third electrochemical roughening treatment)
(13) A chemical etching treatment carried out using an alkaline aqueous solution (fifth alkali etching treatment)
(14) A chemical etching treatment carried out using an acidic aqueous solution (fifth desmutting treatment)

The mechanical roughening treatment (1) may be performed before the treatment (2) of the aspect A described above or before the treatment (10) of the aspect B described above, as necessary.

The amount of the aluminum plate to be dissolved in the first alkali etching treatment and the fourth alkali etching treatment is preferably in a range of 0.5 g/m² to 30 g/m² and more preferably in a range of 1.0 g/m² to 20 g/m².

As the aqueous solution that mainly contains nitric acid used for the first electrochemical roughening treatment according to the aspect A, an aqueous solution used for an electrochemical roughening treatment carried out using the direct current or the alternating current is exemplified. For example, an aqueous solution obtained by adding aluminum nitrate, sodium nitrate, or ammonium nitrate to 1 to 100 g/L of a nitric acid aqueous solution is exemplified.

As the aqueous solution that mainly contains hydrochloric acid used for the second electrochemical roughening treatment according to the aspect A and the third electrochemical roughening treatment according to the aspect B, an aqueous solution used for an electrochemical roughening treatment carried out using the direct current or the alternating current is exemplified. For example, an aqueous solution obtained by adding 0 g/L to 30 g/L of sulfuric acid to a 1 g/L to 100 g/L hydrochloric acid aqueous solution is exemplified. Further, nitrate ions such as aluminum nitrate, sodium nitrate, and ammonium nitrate; and hydrochloride ions such as aluminum chloride, sodium chloride, and ammonium chloride may be further added to this solution.

As the AC power source waveform of the electrochemical roughening treatment, a sine wave, a square wave, a trapezoidal wave, or a triangular wave can be used. The frequency is preferably in a range of 0.1 Hz to 250 Hz.

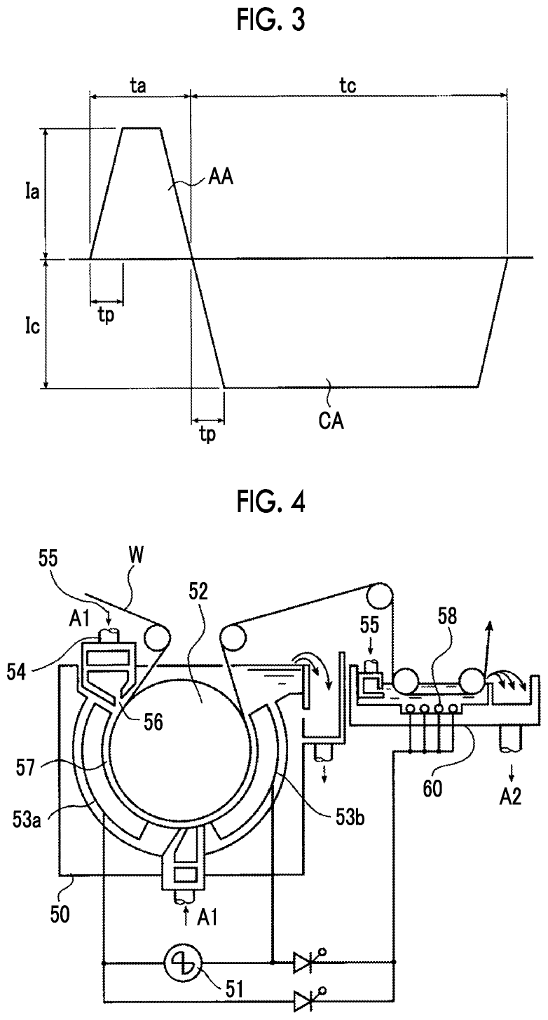

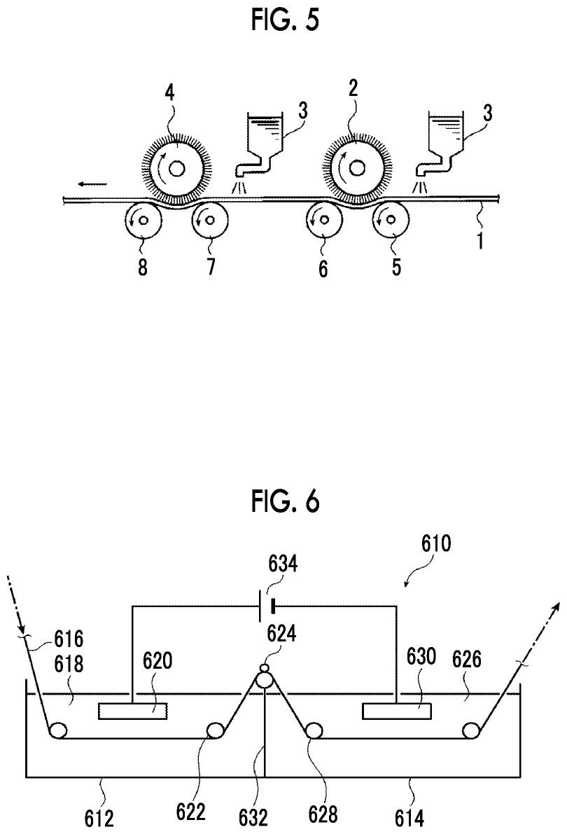

FIG. 3 is a graph showing an example of an alternating waveform current waveform diagram used for the electrochemical roughening treatment.

In FIG. 3, ta represents an anodic reaction time, tc represents a cathodic reaction time, tp represents a time taken for the current to reach the peak from 0, Ia represents the peak current on an anode cycle side, Ic represents the peak current on a cathode cycle side, AA represents the current of the aluminum plate during the anodic reaction, and CA represents the current of the aluminum plate during the cathodic reaction. In the trapezoidal wave, the time tp taken for the current to reach the peak from 0 is preferably in a range of 1 ms to 10 ms. As the preferable conditions for one cycle of the alternating current used for the electrochemical roughening, a ratio tc/ta of the cathodic reaction time tc to the anodic reaction time ta of the aluminum plate is in a range of 1 to 20, a ratio Qc/Qa of an electric quantity Qc in a case of the aluminum plate serving as a cathode to an electric quantity Qa in a case of the aluminum plate serving as an anode is in a range of 0.3 to 20, and the anodic reaction time ta is in a range of 5 ms to 1000 ms. The current density is preferably in a range of 10 A/dm² to 200 A/dm² in both an anode cycle side Ia and a cathode cycle side Ic of the current in terms of the peak value of the trapezoidal wave. The value of Ic/Ia is preferably in a range of 0.3 to 20. The total electric quantity of the aluminum plate used for the anodic reaction in a case where the electrochemical roughening is completed is preferably in a range of 25 C/dm² to 1000 C/dm².

A device illustrated in FIG. 4 can be used for the electrochemical roughening carried out using the alternating current.

FIG. 4 is a side view illustrating an example of a radial type cell in the electrochemical roughening treatment carried out using the alternating current.

In FIG. 4, 50 represents a main electrolytic cell, 51 represents an AC power source, 52 represents a radial drum roller, 53a and 53b represent a main pole, 54 represents an electrolytic solution supply port, 55 represents an electrolytic solution, 56 represents a slit, 57 represents an electrolytic solution passage, 58 represents an auxiliary anode, 60 represents an auxiliary anode cell, and W represents an aluminum plate. In FIG. 4, the arrow A1 indicates the liquid supply direction of the electrolytic solution, and the arrow A2 indicates the discharge direction of the electrolytic solution. In a case where two or more electrolytic cells are used, the electrolysis conditions may be the same as or different from each other.

The aluminum plate W is wound around the radial drum roller 52 disposed by being immersed in the main electrolytic cell 50 and is electrolyzed by the main poles 53a and 53b connected to the AC power source 51 in the transport process. The electrolytic solution 55 is supplied to the electrolytic solution passage 57 disposed between the radial drum roller 52 and the main pole 53a and between the radial drum roller 52 and the main pole 53b through the slit 56 from the electrolytic solution supply port 54. The aluminum plate W which has been treated in the main electrolytic cell 50 is electrolyzed in the auxiliary anode cell 60. The auxiliary anode 58 is disposed in the auxiliary anode cell 60 so as to face the aluminum plate W and the electrolytic solution 55 is supplied so as to flow through the space between the auxiliary anode 58 and the aluminum plate W.

From the viewpoint of easily producing a predetermined printing plate precursor, the amount of the aluminum plate to be dissolved in the second alkali etching treatment is preferably 1.0 g/m² or greater and more preferably in a range of 2.0 g/m² to 10 g/m².

From the viewpoint of easily producing a predetermined printing plate precursor, the amount of the aluminum plate to be dissolved in the third alkali etching treatment and the fourth alkali etching treatment is preferably 0.01 g/m² to 0.8 g/m² and more preferably in a range of 0.05 g/m² to 0.3 g/m².

In the chemical etching treatments (first to fifth desmutting treatments) carried out using an acidic aqueous solution, an acidic aqueous solution containing phosphoric acid, nitric acid, sulfuric acid, chromic acid, hydrochloric acid, or mixed acids containing two or more of these acids is suitably used.

The concentration of the acid in the acidic aqueous solution is preferably in a range of 0.5% by mass to 60% by mass.

[Anodization Treatment Step]

The procedures of the anodization treatment step are not particularly limited as long as the above-described micropores are obtained, and known methods are exemplified.

In the anodization treatment step, an aqueous solution such as sulfuric acid, phosphoric acid, or oxalic acid can be used as an electrolytic cell. For example, the concentration of the sulfuric acid may be in a range of 100 g/L to 300 g/L.

The conditions for the anodization treatment are appropriately set depending on the electrolytic solution to be used. As an example of the conditions, the liquid temperature is in a range of 5° C. to 70° C. (preferably in a range of 10° C. to 60° C.), the current density is in a range of 0.5 A/dm² to 60 A/dm² (preferably in a range of 5 A/dm² to 60 A/dm²), the voltage is in a range of 1 V to 100 V (preferably in a range of 5 V to 50 V), the electrolysis time is in a range of 1 second to 100 seconds (preferably in a range of 5 seconds to 60 seconds), and the coating amount is in a range of 0.1 g/m² to 5 g/m² (preferably in a range of 0.2 g/m² to 3 g/m²).

[Pore Widening Treatment]

The pore widening treatment is a treatment (the pore diameter widening treatment) of expanding the diameter (the pore diameter) of micropores present in the anodized film formed by the above-described anodization treatment step.

The pore widening treatment can be performed by bringing the aluminum plate obtained in the anodization treatment step into contact with an acid aqueous solution or an alkaline aqueous solution. The method of bringing the aluminum plate into contact with the solution is not particularly limited, and examples thereof include an immersion method and a spray method.

<Image Recording Layer>

The lithographic printing plate precursor used in the present disclosure includes an image recording layer containing an acid color developing agent and an acid generator.

It is preferable that the image recording layer is an image recording layer such as a photosensitive layer or a heat-sensitive layer containing an acid color developing agent and an acid generator. Here, examples of the image recording layer include the thermal positive tone image recording layers described in JP1995-285275A (JP-H07-285275A) and JP2003-345014A, the thermal negative tone image recording layers described in JP1995-20625A (JP-H07-20625A) or JP1999-218903A (JP-H11-218903A), and the photopoly negative tone image recording layers described in JP2001-100412A, JP2002-169282A, and JP2008-15504A.

Among these, the negative tone image recording layer containing an acid color developing agent and an acid generator is preferable as the image recording layer.

From the viewpoint of the UV printing durability, it is preferable that the image recording layer in the present disclosure is the outermost layer.

Hereinafter, the details of the negative tone lithographic printing plate precursor in which the image recording layer is a negative tone image recording layer will be described.

[Negative Tone Image Recording Layer]

The negative tone image recording layer suitable for the lithographic printing plate precursor used in the present disclosure contains an acid color developing agent and an acid generator.

As the negative tone image recording layer, a negative tone image recording layer that can be removed by acidic dampening water (preferably both the printing ink and the dampening water) is preferable, and a water-soluble or water-dispersible negative tone image recording layer is more preferable.

The negative tone image recording layer suitable for the lithographic printing plate precursor used in the present disclosure contains preferably an infrared absorbing agent, a polymerizable compound, and a polymerization initiator in addition to the acid color developing agent and the acid generator and more preferably an acid color developing agent, an acid generator, an infrared absorbing agent, a polymerizable compound, a polymerization initiator, and a polymer.

Further, it is preferable that the negative tone image recording layer according to the present disclosure is an on-press development type negative tone image recording layer.

Hereinafter, details of each component contained in the image recording layer will be described.

[Acid Color Developing Agent]

The image recording layer contains an acid color developing agent. Further, it is preferable that the image recording layer contains a leuco compound as the acid color developing agent.

The “acid color developing agent” used in the present disclosure indicates a compound that exhibits a property of developing color or decoloring so that the color of the image recording layer is changed by performing heating in a state of accepting an electron-accepting compound (for example, a proton such as an acid).

In particular, as the acid color developing agent, a colorless compound which has a partial skeleton such as a lactone, a lactam, a sultone, a spiropyran, an ester, or an amide and in which these partial skeletons are rapidly ring-opened or cleaved in a case of being brought into contact with an electron-accepting compound is preferable.

Examples of such an acid color developing agent include phthalides such as 3,3-bis(4-dimethylaminophenyl)-6-dimethylaminophthalide (referred to as “crystal violet lactone”), 3,3-bis(4-dimethylaminophenyl)phthalide, 3-(4-dimethylaminophenyl)-3-(4-diethylamino-2-methylphenyl)-6-dimethylaminophthalide, 3-(4-dimethylaminophenyl)-3-(1,2-dimethylindol-3-yl)phthalide, 3-(4-dimethylaminophenyl)-3-(2-methylindol-3-yl)phthalide, 3,3-bis(1,2-dimethylindol-3-yl)-5-dimethylaminophthalide, 3,3-bis(1,2-dimethylindol-3-yl)-6-dimethylaminophthalide, 3,3-bis(9-ethylcarbazol-3-yl)-6-dimethylaminophthalide, 3,3-bis(2-phenylindol-3-yl)-6-dimethylaminophthalide, and 3-(4-dimethylaminophenyl)-3-(1-methylpyrrol-3-yl)-6-dimethylaminophthalide,

3,3-bis[1,1-bis(4-dimethylaminophenypethylene-2-yl]-4,5,6,7-tetrachlorophthalide, 3,3-bis[1,1-bis(4-pyrrolidinophenypethylene-2-yl]-4,5,6,7-tetrabromophthalide, 3,3-bis[1-(4-dimethylaminophenyl)-1-(4-methoxyphenyl)ethylene-2-yl]-4,5,6,7-tetrachlorophthalide, 3,3-bis[1-(4-pyrrolidinophenyl)-1-(4-methoxyphenyl)ethylene-2-yl]4,5,6,7-tetrachlorophthalide, 3-[1,1-di(1-ethyl-2-methylindol-3-yl)ethylene-2-yl]-3-(4-diethylaminophenyl)phthalide, 3-[1,1-di(1-ethyl-2-methylindol-3-yl)ethylene-2-yl]-3-(4-N-ethyl-N-phenylaminophenyl)phthalide, 3-(2-ethoxy-4-diethylaminophenyl)-3-(1-n-octyl-2-methylindol-3-yl)-phthalide, 3,3-bis(1-n-octyl-2-methylindol-3-yl)-phthalide, and 3-(2-methyl-4-diethylaminophenyl)-3-(1-n-octyl-2-methylindol-3-yl)-phthalide,

4,4-bis-dimethylaminobenzhydrinbenzylether, N-halophenyl-leucoauramine, N-2,4,5-trichlorophenyl leucoauramine, rhodamine-B-anilinolactam, rhodamine-(4-nitroanilino)lactam, rhodamine-B-(4-chloroanilino)lactam, 3,7-bis(diethylamino)-10-benzoylphenoxazine, benzoyl leucomethylene blue, and 4-nitrobenzoyl methylene blue,

fluorans such as 3,6-dimethoxyfluoran, 3-dimethylamino-7-methoxyfluoran, 3-diethylamino-6-methoxyfluoran, 3-diethylamino-7-methoxyfluoran, 3-diethylamino-7-chlorofluoran, 3-diethylamino-6-methyl-7-chlorofluoran, 3-diethylamino-6,7-dimethylfluoran, 3-N-cyclohexyl-N-n-butylamino-7-methylfluoran, 3-diethylamino-7-dibenzylaminofluoran, 3-diethylamino-7-octylaminofluoran, 3-diethylamino-7-di-n-hexylaminofluoran, 3-diethylamino-7-anilinofluoran, 3-diethylamino-7-(2′-fluorophenylamino)fluoran, 3-diethylamino-7-(2′-chlorophenylamino)fluoran, 3-diethylamino-7-(3′-chlorophenylamino)fluoran, 3-diethylamino-7-(2′,3′-dichlorophenylamino)fluoran, 3-diethylamino-7-(3′-trifluoromethylphenylamino)fluoran, 3-di-n-butylamino-7-(2′-fluorophenylamino)fluoran, 3-di-n-butylamino-7-(2′chlorophenylamino)fluoran, 3-N-isopentyl-N-ethylamino-7-(2′-chlorophenylamino)fluoran,

3-N-n-hexyl-N-ethylamino-7-(2′-chlorophenylamino)fluoran, 3-diethylamino-6-chloro-7-anilinofluoran, 3-di-n-butylamino-6-chloro-7-anilinofluoran, 3-diethylamino-6-methoxy-7-anilinofluoran, 3-di-n-butylamino-6-ethoxy-7-anilinofluoran, 3-pyrrolidino-6-methyl-7-anilinofluoran, 3-piperidino-6-methyl-7-anilinofluoran, 3-morpholino-6-methyl-7-anilinofluoran, 3-dimethylamino-6-methyl-7-anilinofluoran, 3-diethylamino-6-methyl-7-anilinofluoran, 3-di-n-butylamino-6-methyl-7-anilinofluoran, 3-di-n-pentylamino-6-methyl-7-anilinofluoran, 3-N-ethyl-N-methylamino-6-methyl-7-anilinofluoran, 3-N-n-propyl-N-methylamino-6-methyl-7-anilinofluoran, 3-N-n-propyl-N-ethylamino-6-methyl-7-anilinofluoran, 3-N-n-butyl-N-methylamino-6-methyl-7-anilinofluoran, 3-N-n-butyl-N-ethylamino-6-methyl-7-anilinofluoran, 3-N-isobutyl-N-methylamino-6-methyl-7-anilinofluoran, 3-N-isobutyl-N-ethylamino-6-methyl-7-anilinofluoran, 3-N-isopentyl-N-ethylamino-6-methyl-7-anilinofluoran, 3-N-n-hexyl-N-methylamino-6-methyl-7-anilinofluoran, 3-N-cyclohexyl-N-ethylamino-6-methyl-7-anilinofluoran, 3-N-cyclohexyl-N-n-propylamino-6-methyl-7-anilinofluoran, 3-N-cyclohexyl-N-n-butylamino-6-methyl-7-anilinofluoran, 3-N-cyclohexyl-N-n-hexylamino-6-methyl-7-anilinofluoran, 3-N-cyclohexyl-N-n-octylamino-6-methyl-7-anilinofluoran,

3-N-(2′-methoxyethyl)-N-methylamino-6-methyl-7-anilinofluoran, 3-N-(2′-methoxyethyl)-N-ethylamino-6-methyl-7-anilinofluoran, 3-N-(2′-methoxyethyl)-N-isobutylamino-6-methyl-7-anilinofluoran, 3-N-(2′-ethoxyethyl)-N-methylamino-6-methyl-7-anilinofluoran, 3-N-(2′-ethoxyethyl)-N-ethylamino-6-methyl-7-anilinofluoran, 3-N-(3′-methoxypropyl)-N-methylamino-6-methyl-7-anilinofluoran, 3-N-(3′methoxypropyl)-N-ethylamino-6-methyl-7-anilinofluoran, 3-N-(3′-ethoxypropyl)-N-methylamino-6-methyl-7-anilinofluoran, 3-N-(3′ethoxypropyl)-N-ethylamino-6-methyl-7-anilinofluoran, 3-N-(2′-tetrahydrofurfuryl)-N-ethylamino-6-methyl-7-anilinofluoran, 3-N-(4′-methylphenyl)-N-ethylamino-6-methyl-7-anilinofluoran, 3-diethylamino-6-ethyl-7-anilinofluoran, 3-diethylamino-6-methyl-7-(3′-methylphenylamino)fluoran, 3-diethylamino-6-methyl-7-(2′,6′-dimethylphenylamino)fluoran, 3-di-n-butylamino-6-methyl-7-(2′,6′-dimethylphenylamino)fluoran, 3-di-n-butylamino-7-(2′,6′-dimethylphenylamino)fluoran, 2,2-bis[4′-(3-N-cyclohexyl-N-methylamino-6-methylfluoran)-7-ylaminophenyl]propane, 3-[4′-(4-phenylaminophenyl)aminophenyl]amino-6-methyl-7-chlorofluoran, and 3-[4′(dimethylaminophenyl)]amino-5,7-dimethylfluoran,

phthalides such as 3-(2-methyl-4-diethylaminophenyl)-3-(1-ethyl-2-methylindol-3-yl)-4-azaphthalide, 3-(2-n-propoxycarbonylamino-4-di-n-propylaminophenyl)-3-(1-ethyl-2-methylindol-3-yl)-4-azaphthalide, 3-(2-methylamino-4-di-n-propylaminophenyl)-3-(1-ethyl-2-methylindol-3-yl)-4-azaphthalide, 3-(2-methyl-4-di-n-hexylaminophenyl)-3-(1-n-octyl-2-methylindol-3-yl)-4,7-diazaphthalide, 3,3-bis(2-ethoxy-4-diethylaminophenyl)-4-azaphthalide, 3,3-bis(1-n-octyl-2-methylindol-3-yl)-4-azaphthalide, 3-(2-ethoxy-4-diethylaminophenyl)-3-(1-ethyl-2-methylindol-3-yl)-4-azaphthalide, 3-(2-ethoxy-4-diethylaminophenyl)-3-(1-octyl-2-methylindol-3-yl)-4-azaphthalide, 3-(2-ethoxy-4-diethylaminophenyl)-3-(1-octyl-2-methylindol-3-yl)-7-azaphthalide, 3-(2-ethoxy-4-diethylaminophenyl)-3-(1-ethyl-2-methylindol-3-yl)-4-azaphthalide, 3-(2-ethoxy-4-diethylaminophenyl)-3-(1-ethyl-2-methylindol-3-yl)-7-azaphthalide, 3-(2-hexyloxy-4-diethylaminophenyl)-3-(1-ethyl-2-methylindol-3-yl)-4-azaphthalide, 3-(2-hexyloxy-4-diethylaminophenyl)-3-(1-ethyl-2-methylindol-3-yl)-7-azaphthalide, 3-(2-ethoxy-4-diethylaminophenyl)-3-(1-ethyl-2-phenylindol-3-yl)-4-azaphthalide, 3-(2-ethoxy-4-diethylaminophenyl)-3-(1-ethyl-2-phenylindol-3-yl)-7-azaphthalide, 3-(2-butoxy-4-diethylaminophenyl)-3-(1-ethyl-2-phenylindol-3-yl)-4-azaphthalide, 3-(2-butoxy-4-diethylaminophenyl)-3-(1-ethyl-2-phenylindol-3-yl)-7-azaphthalide, 3-methyl-spiro-dinaphthopyran, 3-ethyl-spiro-dinaphthopyran, 3-phenyl-spiro-dinaphthopyran, 3-benzyl-spiro-dinaphthopyran, 3-methyl-naphtho-(3-methoxybenzo)spiropyran, 3-propyl-spiro-dibenzopyran-3,6-bis(dimethylamino)fluorene-9-spiro-3′-(6′-dimethylamino)phthalide, and 3,6-bis(diethylamino)fluorene-9-spiro-3′-(6′-dimethylamino)phthalide.

Further, other examples thereof include 2-anilino-6′-(N-ethyl-N-isopentyl)amino-3′-methylspiro[isobenzofuran-1(3H),9′-(9H)xanthene]-3-one, 2′-anilino-6′-(N-ethyl-N-(4-methylphenyl))amino-3′-methylspiro[isobenzofuran-1(3H),9′-(9H) xanthene]-3-one, 3′-N,N-dibenzylamino-6′-N,N-diethylaminospiro[isobenzofuran-1(3H),9′-(9H)xanthene]-3-one, and 2′-(N-methyl-N-phenyl)amino-6′-(N-ethyl-N-(4-methylphenyl))aminospiro[isobenzofuran-1(3H), 9′-(9H)xanthene]-3-one.

Among these, from the viewpoint of the color developability, it is preferable that the acid color developing agent used in the present disclosure is at least one compound selected from the group consisting of a spiropyran compound, a spirooxazine compound, a spirolactone compound, and a spirolactam compound.

From the viewpoint of the visibility, it is preferable that the color tone of the coloring agent after color development is green, blue, or black.

Further, from the viewpoints of the color developability and the visibility of the exposed portion, a leuco coloring agent is preferable as the acid color developing agent.

The leuco coloring agent is not particularly limited as long as the coloring agent has a leuco structure, but the leuco coloring agent has preferably a spiro structure and more preferably a spirolactone ring structure.

Further, from the viewpoints of the color developability and the visibility of the exposed portion, a leuco coloring agent having a phthalide structure or a fluorane structure is preferable as the leuco coloring agent.

Further, from the viewpoints of the color developability and the visibility of the exposed portion, the leuco coloring agent having a phthalide structure or a fluorane structure is preferably a compound represented by any of Formulae (Le-1) to (Le-3) and more preferably a compound represented by Formula (Le-2).

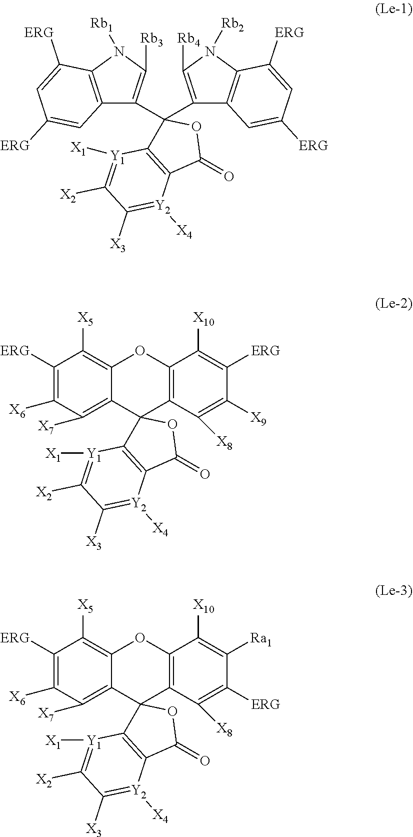

In Formulae (Le-1) to (Le-3), ERG's each independently represent an electron-donating group, X₁ to X₄ each independently represent a hydrogen atom, a halogen atom, or a dialkylanilino group, X₅ to X₁₀ each independently represent a hydrogen atom, a halogen atom, or a monovalent organic group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent a hydrogen atom, an alkyl group, or an aryl group.

From the viewpoints of the color developability and the visibility of the exposed portion, as the electron-donating group represented by ERG in Formulae (Le-1) to (Le-3), an amino group, an alkylamino group, an arylamino group, a dialkylamino group, a monoalkyl monoarylamino group, a diarylamino group, an alkoxy group, an aryloxy group, or an alkyl group is preferable, an amino group, an alkylamino group, an arylamino group, a dialkylamino group, a monoalkyl monoarylamino group, a diarylamino group, an alkoxy group, or an aryloxy group is more preferable, an arylamino group, a monoalkyl monoarylamino group, or a diarylamino group is still more preferable, and an arylamino group or a monoalkyl monoarylamino group is particularly preferable.

From the viewpoints of the color developability and the visibility of the exposed portion, X₁ to X₄ in Formulae (Le-1) to (Le-3) each independently represent preferably a hydrogen atom or a chlorine atom and more preferably a hydrogen atom.

From the viewpoints of the color developability and the visibility of the exposed portion, X₅ to X₁₀ in Formula (Le-2) or Formula (Le-3) each independently represent preferably a hydrogen atom, a halogen atom, an alkyl group, an aryl group, an amino group, an alkylamino group, an arylamino group, a dialkylamino group, a monoalkyl monoarylamino group, a diarylamino group, a hydroxy group, an alkoxy group, an aryloxy group, an acyl group, an alkoxycarbonyl group, an aryloxycarbonyl group, or a cyano group, more preferably a hydrogen atom, a halogen atom, an alkyl group, an aryl group, an alkoxy group, or an aryloxy group, still more preferably a hydrogen atom, a halogen atom, an alkyl group, or an aryl group, and particularly preferably a hydrogen atom.

From the viewpoints of the color developability and the visibility of the exposed portion, it is preferable that at least one of Y₁ or Y₂ in Formulae (Le-1) to (Le-3) represents C and more preferable that both Y₁ and Y₂ represent C.

From the viewpoints of the color developability and the visibility of the exposed portion, Ra₁ in Formulae (Le-1) to (Le-3) represents preferably an alkyl group or an alkoxy group, more preferably an alkoxy group, and particularly preferably a methoxy group.

From the viewpoints of the color developability and the visibility of the exposed portion, Rbᵢ to Rb₄ in Formulae (Le-1) to (Le-3) each independently represent preferably a hydrogen atom or an alkyl group, more preferably an alkyl group, and particularly preferably a methyl group.

Further, from the viewpoints of the color developability and the visibility of the exposed portion, a compound represented by any of Formulae (Le-4) to (Le-6) is more preferable, and a compound represented by Formula (Le-5) is still more preferable as the leuco coloring agent having a phthalide structure or a fluorane structure.

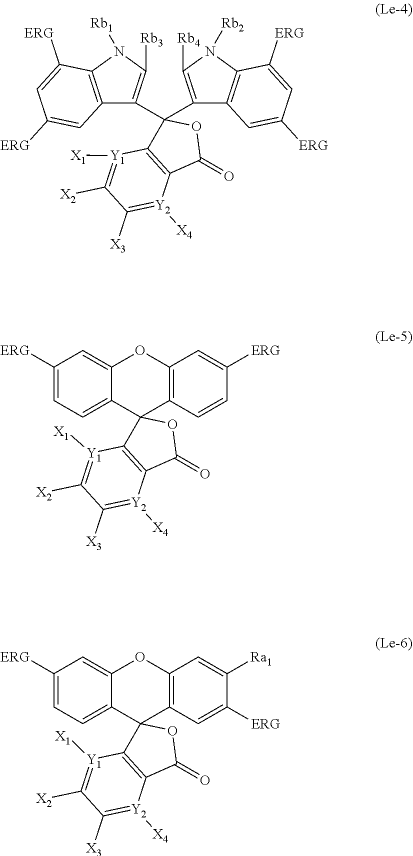

In Formulae (Le-4) to (Le-6), ERG's each independently represent an electron-donating group, X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent a hydrogen atom, an alkyl group, or an aryl group.

ERG, X₁ to X₄, Y₁, Y₂, Ra₁, and Rb₁ to Rb₄ in Formulae (Le-4) to (Le-6) each have the same definition as that for ERG, X₁ to X₄, Y₁, Y₂, Ra₁, and Rb₁ to Rb₄ in Formulae (Le-1) to (Le-3), and the preferable ranges thereof are also the same as described above.

Further, from the viewpoints of the color developability and the visibility of the exposed portion, a compound represented by any of Formulae (Le-7) to (Le-9) is still more preferable, and a compound represented by Formula (Le-8) is particularly preferable as the leuco coloring agent having a phthalide structure or a fluorane structure.

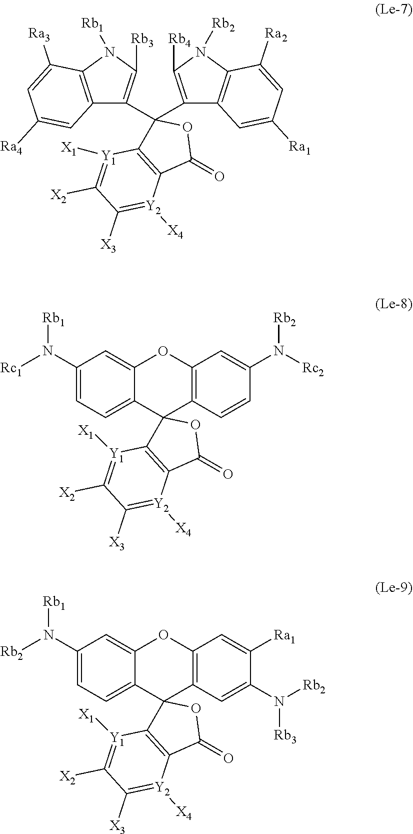

In Formulae (Le-7) to (Le-9), X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ to Ra₄ each independently represent a hydrogen atom, an alkyl group, or an alkoxy group, Rb₁ to Rb₄ each independently represent a hydrogen atom, an alkyl group, or an aryl group, and Rc₁ and Rc₂ each independently represent an aryl group.

X₁ to X₄, Y₁, and Y₂ in Formulae (Le-7) to (Le-9) each have the same definition as that for X₁ to X₄, Y₁, and Y₂ in Formulae (Le-1) to (Le-3), and the preferable ranges thereof are also the same as described above.

From the viewpoints of the color developability and the visibility of the exposed portion, Ra₁ to Ra₄ in Formulae (Le-7) to (Le-9) each independently represent preferably an alkyl group or an alkoxy group, more preferably an alkoxy group, and particularly preferably a methoxy group.

From the viewpoints of the color developability and the visibility of the exposed portion, Rb₁ to Rb₄ in Formulae (Le-7) to (Le-9) each independently represent preferably a hydrogen atom, an alkyl group, or an aryl group substituted with an alkyl group or an alkoxy group, more preferably a hydrogen atom or an alkyl group, and particularly preferably a hydrogen atom or a methyl group.

From the viewpoints of the color developability and the visibility of the exposed portion, Rc₁ and Rc₂ in Formula (Le-8) each independently represent preferably a phenyl group or an alkylphenyl group and more preferably a phenyl group.

In Formula (Le-8), from the viewpoints of the color developability and the visibility of the exposed portion, it is preferable that X₁ to X₄ represent a hydrogen atom and that Y₁ and Y₂ represent C.

Further, in Formula (Le-8), from the viewpoints of the color developability and the visibility of the exposed portion, Rb₁ and Rb₂ each independently represent preferably a hydrogen atom, an alkyl group, or an aryl group substituted with an alkyl group or an alkoxy group and more preferably a hydrogen atom or an alkyl group.

The alkyl group in Formulae (Le-1) to (Le-9) may be linear or branched or may have a ring structure.

Further, the number of carbon atoms of the alkyl group in Formulae (Le-1) to (Le-9) is preferably in a range of 1 to 20, more preferably in a range of 1 to 8, still more preferably in a range of 1 to 4, and particularly preferably 1 or 2.

The number of carbon atoms of the aryl group in Formulae (Le-1) to (Le-9) is preferably in a range of 6 to 20, more preferably in a range of 6 to 10, and particularly preferably in a range of 6 to 8.

Further, each of the monovalent organic group, the alkyl group, the aryl group, the dialkylanilino group, the alkylamino group, and the alkoxy group in Formulae (Le-1) to (Le-9) may have a substituent. Examples of the substituent include an alkyl group, an aryl group, a halogen atom, an amino group, an alkylamino group, an arylamino group, a dialkylamino group, a monoalkyl monoarylamino group, a diarylamino group, a hydroxy group, an alkoxy group, an aryloxy group, an acyl group, an alkoxycarbonyl group, an aryloxycarbonyl group, and a cyano group. Further, these substituents may be further substituted with these substituents.

Examples of the leuco coloring agent having a phthalide structure or a fluorane structure that are suitably used include the following compounds, and it goes without saying that the examples are not limited thereto. In addition, Me represents a methyl group.

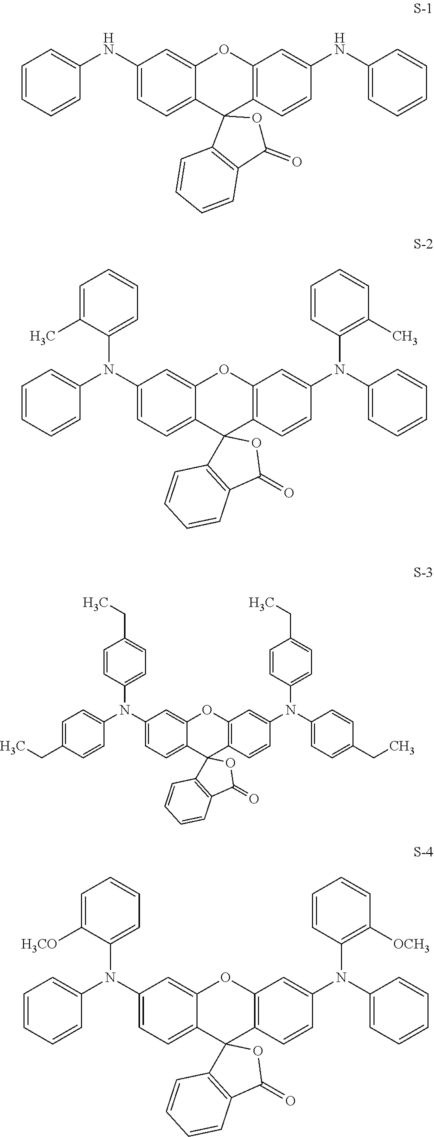 [SMILES: O=C1OC2(c3ccc(Nc4ccccc4)cc3Oc3cc(Nc4ccccc4)ccc32)c2ccccc21 ; Cc1ccccc1N(c1ccccc1)c1ccc2c(c1)Oc1cc(N(c3ccccc3)c3ccccc3C)ccc1C21OC(=O)c2ccccc21 ; CCc1ccc(N(c2ccc(CC)cc2)c2ccc3c(c2)Oc2cc(N(c4ccc(CC)cc4)c4ccc(CC)cc4)ccc2C32OC(=O)c3ccccc32)cc1 ; COc1ccccc1N(c1ccccc1)c1ccc2c(c1)Oc1cc(N(c3ccccc3)c3ccccc3OC)ccc1C21OC(=O)c2ccccc21]

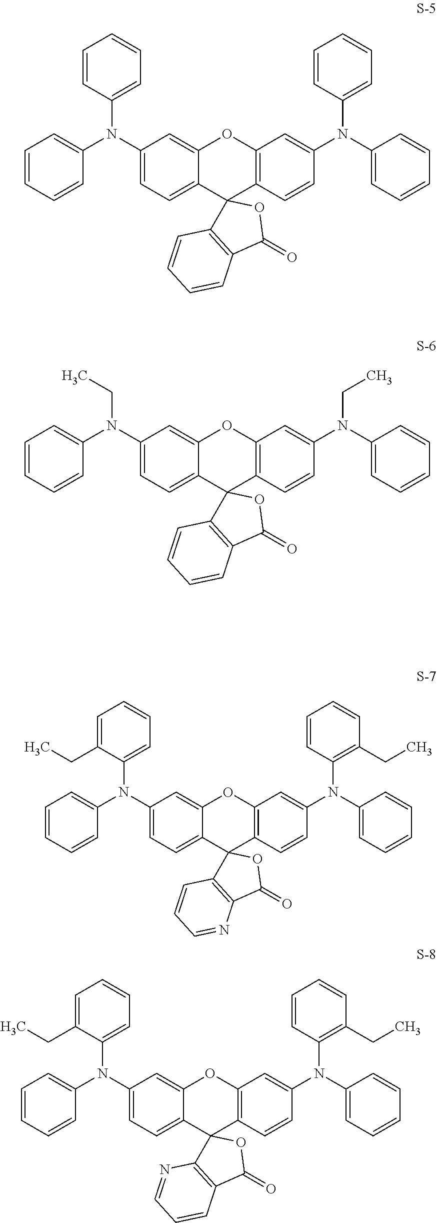 [SMILES: O=C1OC2(c3ccc(N(c4ccccc4)c4ccccc4)cc3Oc3cc(N(c4ccccc4)c4ccccc4)ccc32)c2ccccc21 ; CCN(c1ccccc1)c1ccc2c(c1)Oc1cc(N(CC)c3ccccc3)ccc1C21OC(=O)c2ccccc21 ; CCc1ccccc1N(c1ccccc1)c1ccc2c(c1)Oc1cc(N(c3ccccc3)c3ccccc3CC)ccc1C21OC(=O)c2ncccc21 ; CCc1ccccc1N(c1ccccc1)c1ccc2c(c1)Oc1cc(N(c3ccccc3)c3ccccc3CC)ccc1C21OC(=O)c2cccnc21]

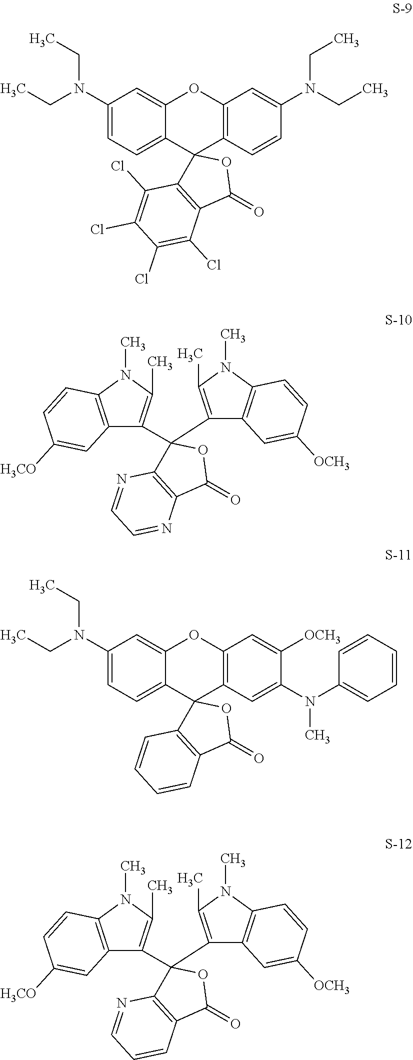

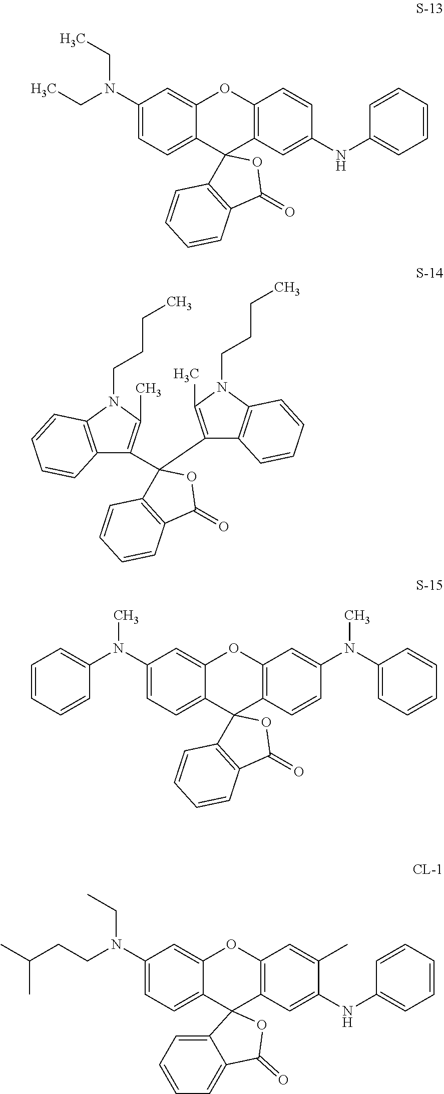 [SMILES: CCN(CC)c1ccc2c(c1)Oc1ccc(Nc3ccccc3)cc1C21OC(=O)c2ccccc21 ; CCCCn1c(C)c(C2(c3c(C)n(CCCC)c4ccccc34)OC(=O)c3ccccc32)c2ccccc21 ; CN(c1ccccc1)c1ccc2c(c1)Oc1cc(N(C)c3ccccc3)ccc1C21OC(=O)c2ccccc21 ; CCN(CCC(C)C)c1ccc2c(c1)Oc1cc(C)c(Nc3ccccc3)cc1C21OC(=O)c2ccccc21]

As the acid color developing agent, a commercially available product can be used, and examples thereof include ETAC, RED500, RED520, CVL, S-205, BLACK305, BLACK400, BLACK100, BLACK500, H-7001, GREEN300, NIRBLACK78, BLUE220, H-3035, BLUE203, ATP, H-1046, and H-2114 (all manufactured by Fukui Yamada Chemical Co., Ltd.), ORANGE-DCF, Vermilion-DCF, PINK-DCF, RED-DCF, BLMB, CVL, GREEN-DCF, and TH-107 (all manufactured by Hodogaya Chemical Co., Ltd.), ODB, ODB-2, ODB-4, ODB-250, ODB-BlackXV, Blue-63, Blue-502, GN-169, GN-2, Green-118, Red-40, and Red-8 (all manufactured by Yamamoto Chemicals Inc.), and Crystal Violet Lactone (manufactured by Tokyo Chemical Industry Co., Ltd.). Among these commercially available products, ETAC, S-205, BLACK305, BLACK400, BLACK100, BLACK500, H-7001, GREEN300, NIRBLACK78, H-3035, ATP, H-1046, H-2114, GREEN-DCF, Blue-63, GN-169, and Crystal Violet Lactone are preferable from the viewpoint that the visible light absorbance of a film to be formed is satisfactory.

From the viewpoint of visibility, the molar absorption coefficient c at the maximum absorption wavelength of the acid color developing agent is preferably in a range of 20000 to 100000, more preferably in a range of 20000 to 80000, still more preferably in a range of 30000 to 80000, particularly preferably in a range of 40000 to 70000, and most preferably in a range of 50000 to 70000.

0.04 mmol of an acid color developing agent sample to be measured (for example, 19.3 mg in a case where the acid color developing agent sample is S-15) is precisely weighed in a 100 mL volumetric flask. Approximately 90 mL of acetic acid is added thereto, visual confirmation whether the measurement sample is completely dissolved is made, and the volume of the mixture is increased to 100 mL with acetic acid, thereby preparing a coloring agent solution A.

Approximately 80 mL of acetic acid is added to a separate 100 mL volumetric flask, 5 mL of ion exchange water and 5 mL of the coloring agent solution A are respectively added thereto using a 5 mL volumetric pipette, and the mixture is gently shaken and mixed. Visual confirmation whether the acid color developing agent sample to be measured is not precipitated is made, and the volume of the mixture is increased to 100 mL with acetic acid, thereby preparing a coloring agent solution B. Here, the coloring agent solution B has a measurement sample concentration of 0.02 mmol/L.

A measurement cell (quartz glass, optical path width: 10 mm) is filled with the coloring agent solution B, and measurement is carried out using an ultraviolet-visible spectrophotometer (model number: UV-1800, manufactured by Shimadzu Corporation). Further, the blank is set as a liquid containing water and acetic acid at a ratio of 5:95.

The absorption maximum wavelength in a visible light region (380 nm to 750 nm) is read from the obtained spectrum, and the molar absorption coefficient c can be calculated from the absorbance at that wavelength.

These acid color developing agents may be used alone or in combination of two or more kinds of components.

The content of the acid color developing agent is preferably in a range of 0.5% by mass to 10% by mass and more preferably in a range of 1% by mass to 5% by mass with respect to the total mass of the image recording layer.

[Acid Generator]

The image recording layer contains an acid generator.

Further, in a case where the lithographic printing plate precursor used in the present disclosure contains a polymerization initiator described below, a polymerization initiator that also functions as an acid generator may be used, and it is regarded that a polymerization initiator that functions as an acid generator is included in an acid generator in a case where the lithographic printing plate precursor contains the polymerization initiator functioning as an acid generator.

In the present disclosure, the acid generator is a compound that generates an acid by light or heat and denotes a compound that is decomposed by irradiation with infrared rays or a heat treatment at 100° C. or higher to generate an acid. As the acid to be generated, a strong acid having a pKa of 2 or less, such as sulfonic acid or hydrochloric acid, is preferable. The acid color developing agent can develop color by the acid generated from the acid generator.

Examples of the acid generator suitably used in the image recording layer in the present disclosure include the acid generators described in paragraphs 0116 to 0130 of WO2016/047392A.

Among these, from the viewpoints of the sensitivity and the stability, it is preferable to use an onium salt compound as the acid generator. Hereinafter, the onium salt compound will be described.

Examples of the onium salt compound that can be suitably used in the present disclosure include a compound known as a compound that is decomposed by exposure to infrared rays or by thermal energy generated from an infrared absorbing agent upon exposure to generate an acid. Examples of the onium salt compound suitable for the present disclosure include compounds having the following onium salt structures, which contain a known thermal polymerization initiator or a bond with a small bond dissociation energy, from the viewpoint of the sensitivity.

Examples of the onium salt suitably used in the present disclosure include a diazonium salt, an iodonium salt, a sulfonium salt, an ammonium salt, a pyridinium salt, and an azinium salt that are known. Among these, a sulfonate, a carboxylate, BF₄⁻, PF₆⁻, ClO₄⁻, and the like of triaryl sulfonium or diaryl iodonium are preferable.

Examples of the onium salt that can be used as the acid generator in the present disclosure include an onium salt represented by any of Formulae (III) to (V).

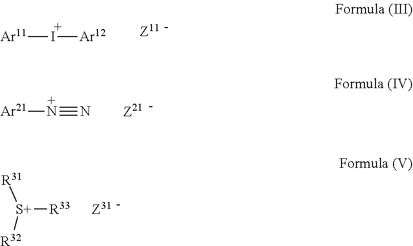

In Formula (III), Ar¹¹ and Ar¹² each independently represent an aryl group having 20 or less carbon atoms which may have a substituent. Preferred examples of the substituent in a case where the aryl group has a substituent include a halogen atom, a nitro group, an alkyl group having 12 or less carbon atoms, an alkoxy group having 12 or less carbon atoms, or an aryloxy group having 12 or less carbon atoms. Z¹¹⁻ represents a counter ion selected from the group consisting of sulfonate ions having a fluorine atom such as a halide ion, a perchlorate ion, a tetrafluoroborate ion, a hexafluorophosphate ion, a sulfonate ion, and a perfluoroalkyl sulfonate ion and preferably a perchlorate ion, a hexafluorophosphate ion, an aryl sulfonate ion, or a perfluoroalkyl sulfonate ion.

In Formula (IV), Ar²¹ represents an aryl group having 1 to 20 carbon atoms which may have a substituent. Preferred examples of the substituent include a halogen atom, a nitro group, an alkyl group having 1 to 12 carbon atoms, an alkoxy group having 1 to 12 carbon atoms, an aryloxy group having 1 to 12 carbon atoms, an alkylamino group having 1 to 12 carbon atoms, a dialkylamino group having 2 to 12 carbon atoms, and an arylamino group having 6 to 12 carbon atoms or a diarylamino group having 6 to 12 carbon atoms (the numbers of carbon atoms of the two aryl groups are each independently in a range of 6 to 12). Z²¹⁻ represents a counterion that has the same definition as that for Z¹¹⁻.

In Formula (V), R³¹, R³², and R³³ may be the same as or different from each other and represent a hydrocarbon group having 1 to 20 carbon atoms which may have a substituent. Preferred examples of the substituent include a halogen atom, a nitro group, an alkyl group having 1 to 12 carbon atoms, an alkoxy group having 1 to 12 carbon atoms, and an aryloxy group having 1 to 12 carbon atoms. Z³¹⁻ represents a counterion that has the same definition as that for Z¹¹⁻.

Specific examples of the onium salt that can be suitably used in the image recording layer in the present disclosure are the same as the compounds described in paragraphs 0121 to 0124 of WO2016/047392A.

Further, other examples of the compound represented by Formulae (III) to (V) include the compounds described as the examples of the radical polymerization initiator in paragraphs 0036 to 0045 of JP2008-195018A, and these compounds can be suitably used as the acid generator according to the present disclosure.

More preferable examples of the acid generator that can be used in the present disclosure include the following compounds (PAG-1) to (PAG-5).

Further, more preferred examples of the acid generator that can be used in the present disclosure include an electron-accepting polymerization initiator described below.

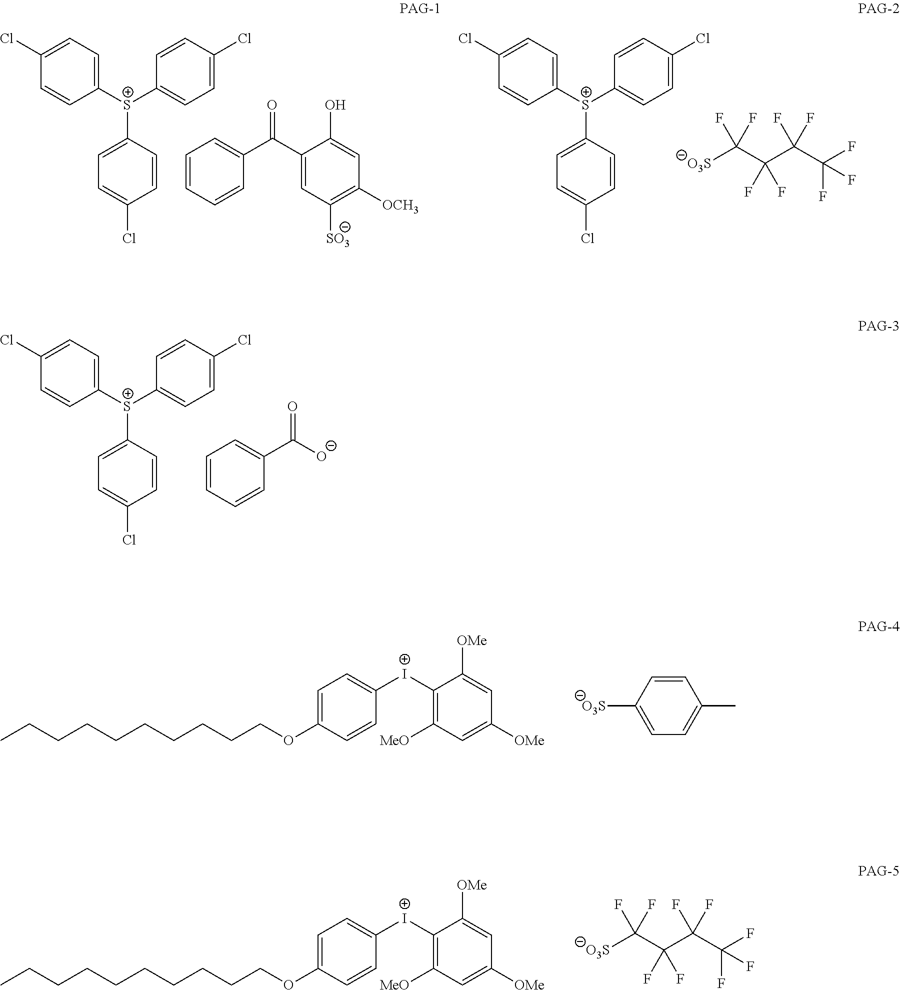

The acid generator may be used alone or in combination of two or more kinds thereof.

The content of the acid generator is preferably in a range of 0.5% by mass to 30% by mass, more preferably in a range of 1% by mass to 25% by mass, still more preferably in a range of 5% by mass to 20% by mass, and particularly preferably in a range of 5% by mass to 10% by mass with respect to the total mass of the image recording layer.

[Polymerization Initiator]

It is preferable that the image recording layer further contains a polymerization initiator.

Further, it is preferable that the image recording layer contains an electron-accepting polymerization initiator as the polymerization initiator.

(Electron-Accepting Polymerization Initiator)

Further, an electron-accepting radical polymerization initiator is preferable as the electron-accepting polymerization initiator.

Examples of the electron-accepting radical polymerization initiator include an organic halide (a), a carbonyl compound (b), an azo compound (c), an organic peroxide (d), a metallocene compound (e), an azide compound (f), a hexaaryl biimidazole compound (g), a disulfone compound (i), an oxime ester compound (j), and an onium salt compound (k).

As the organic halide (a), for example, the compounds described in paragraphs 0022 to 0023 of JP2008-195018A are preferable.

As the carbonyl compound (b), for example, the compounds described in paragraph 0024 of JP2008-195018A are preferable.

As the azo compound (c), for example, the azo compounds and the like described in JP1996-108621A (JP-H08-108621A) can be used.

As the organic peroxide (d), for example, the compounds described in paragraph 0025 of JP2008-195018A are preferable.

As the metallocene compound (e), for example, the compounds described in paragraph 0026 of JP2008-195018A are preferable.

Examples of the azide compound (f) include compounds such as 2,6-bis(4-azidobenzylidene)-4-methylcyclohexanone.

As the hexaaryl biimidazole compound (g), for example, the compounds described in paragraph 0027 of JP2008-195018A are preferable.

Examples of the disulfone compound (i) include the compounds described in JP1986-166544A (JP-S61-166544A) and JP2002-328465A.

As the oxime ester compound (j), for example, the compounds described in paragraphs 0028 to 0030 of JP2008-195018A are preferable.

Among the electron-accepting polymerization initiators, from the viewpoints of the UV printing durability, the visibility, and the on-press developability, an oxime ester compound and an onium salt compound are preferable, and an onium salt compound is more preferable.

Among the onium salt compounds, from the viewpoints of the UV printing durability, the visibility, and the on-press developability, an iodonium salt compound, a sulfonium salt compound, or an azinium salt compound is preferable, an iodonium salt compound or a sulfonium salt compound is more preferable, and an iodonium salt compound is particularly preferable.

Specific examples of these compounds are shown below, but the present invention is not limited thereto.

As an example of the iodonium salt, a diphenyl iodonium salt is preferable, and a diphenyl iodonium salt substituted with an electron-donating group such as an alkyl group or an alkoxyl group is particularly preferable. Further, an asymmetric diphenyl iodonium salt is still more preferable. Specific examples thereof include diphenyliodonium=hexafluorophosphate, 4-methoxyphenyl-4-(2-methylpropyl)phenyliodonium=hexafluorophosphate, 4-(2-methylpropyl)phenyl-p-tolyliodonium=hexafluorophosphate, 4-hexyloxyphenyl-2,4,6-trimethoxyphenyliodonium=hexafluorophosphate, 4-hexyloxyphenyl-2,4-diethoxyphenyliodonium=tetrafluoroborate, 4-octyloxyphenyl-2,4,6-trimethoxyphenyliodonium=1-perfluorobutane sulfonate, 4-octyloxyphenyl-2,4,6-trimethoxyphenyliodonium=hexafluorophosphate, and bis(4-t-butylphenyl)iodonium=tetraphenylborate.

Specific examples of the sulfonium salt include triphenylsulfonium=hexafluorophosphate, triphenylsulfonium=benzoylformate, bis(4-chlorophenyl)phenylsulfonium=benzoylformate, bis(4-chlorophenyl)-4-methylphenylsulfonium=tetrafluoroborate, tris(4-chlorophenyl)sulfonium=3,5-bis(methoxycarbonyl)benzene sulfonate, and tris(4-chlorophenyl)sulfonium=hexafluorophosphate.

Among these, from the viewpoints of the UV printing durability, the visibility, and the on-press developability, an iodonium salt is preferable as the electron-accepting polymerization initiator.

It is particularly preferable that the onium salt compound used as the electron-accepting polymerization initiator is used in combination with an infrared absorbing agent having maximum absorption wavelength in a wavelength range of 750 nm to 1400 nm.

Examples of the electron-accepting polymerization initiator include a peroxide such as benzoyl peroxide; hydroperoxide such as cumylhydroperoxide; an azo compound such as azobis-isobutyronitrile; a 2,4,5-triarylimidazolyl dimer (hexaarylbisimidazole) as disclosed in U.S. Pat. No. 4,565,769A (Dueber et al.); trihalomethyltriazine; a borate; and a mixture thereof.

More preferable examples of the electron-accepting polymerization initiator (also serving as an acid generator) that can be used in the present disclosure include the following compounds (I-1) to (I-3), and it goes without saying that the examples are not limited thereto.

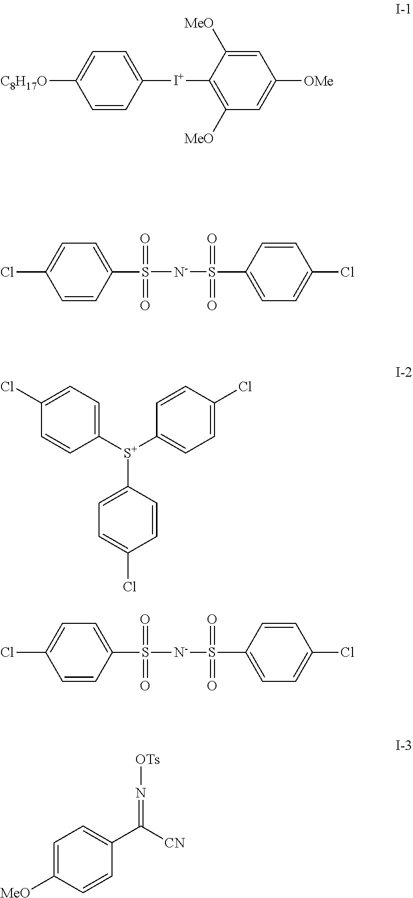

The electron-accepting polymerization initiator may be used alone or in combination of two or more kinds thereof.

In a case where the electron-accepting polymerization initiator functions as an acid generator, it is regarded that the content thereof is included in the content of the acid color developing agent.

The content of the electron-accepting polymerization initiator in the image recording layer is preferably in a range of 0.5% by mass to 30% by mass, more preferably in a range of 1% by mass to 25% by mass, still more preferably in a range of 5% by mass to 20% by mass, and particularly preferably in a range of 5% by mass to 15% by mass with respect to the total mass of the image recording layer.

(Relationship Between Electron-Accepting Polymerization Initiator and Infrared Absorbing Agent)

From the viewpoint of improving the sensitivity and the UV printing durability, the image recording layer in the present disclosure contains the electron-accepting polymerization initiator and the infrared absorbing agent, and the value obtained by subtracting the value of LUMO of the electron-accepting polymerization initiator from the value of LUMO of the infrared absorbing agent (that is, value of LUMO of infrared absorbing agent—value of LUMO of electron-accepting polymerization initiator) is preferably 1.00 eV or less, more preferably 0.80 eV or less, and particularly preferably in a range of 0.80 eV to −0.10 eV.

Further, the negative values indicate that the LUMO of the electron-accepting polymerization initiator is greater than the LUMO of the infrared absorbing agent.

(Electron-Donating Polymerization Initiator (Polymerization Assistant))

It is preferable that the image recording layer contains an electron-donating polymerization initiator (also referred to as a “polymerization assistant”) as a polymerization initiator. Further, it is more preferable that the polymerization initiator contains the electron-accepting polymerization initiator and the electron-donating polymerization initiator.

The electron-donating polymerization initiator in the present disclosure is a compound that generates polymerization initiating species such as a radical by donating one electron, through intermolecular electron transfer, to the orbit where one electron of the infrared absorbing agent is escaped in a case where electrons of the infrared absorbing agent are excited or transferred between molecules upon exposure to infrared rays.

It is preferable that the electron-donating polymerization initiator is an electron-donating radical polymerization initiator.

From the viewpoint of improving the printing durability of the lithographic printing plate, it is more preferable that the image recording layer contains the following five kinds of electron-donating polymerization initiators.

(i) Alkyl or arylate complex: It is considered that a carbon-hetero bond is cleaved by oxidation to generate an active radical. Specifically, a borate compound is preferable.

(ii) N-arylalkylamine compound: It is considered that a C—X bond on carbon adjacent to nitrogen is cleaved by oxidation to generate an active radical. It is preferable that X represents a hydrogen atom, a carboxyl group, a trimethylsilyl group, or a benzyl group. Specific examples thereof include N-phenylglycines (the phenyl group may or may not have a substituent) and N-phenyliminodiacetic acid (the phenyl group may or may not have a substituent).

(iii) Sulfur-containing compound: The nitrogen atom of the above-described amines can be replaced with a sulfur atom to generate an active radical by the same action as described above. Specific examples thereof include phenylthioacetic acid (the phenyl group may or may not have a substituent).

(iv) Tin-containing compound: The nitrogen atom of the above-described amines can be replaced with a tin atom to generate an active radical by the same action as described above.

(v) Sulfinates: An active radical can be generated by oxidation. Specific examples thereof include sodium arylsulfinate.

Among these, from the viewpoint of the UV printing durability, it is preferable that the image recording layer contains a borate compound as the electron-donating polymerization initiator.

From the viewpoints of the UV printing durability and the color developability, a tetraaryl borate compound or a monoalkyl triaryl borate compound is preferable, and a tetraaryl borate compound is more preferable as the borate compound.

The counter cation of the borate compound is not particularly limited, and an alkali metal ion or a tetraalkylammonium ion is preferable, and a sodium ion, a potassium ion, or a tetrabutylammonium ion is more preferable.

Specific preferred examples of the borate compound include sodium tetraphenyl borate.

B-1 to B-9 are shown below as specific preferred examples of the electron-donating polymerization initiator, but it goes without saying that the present invention is not limited thereto. Further, in the following chemical formulae, Ph represents a phenyl group, and Bu represents an n-butyl group.

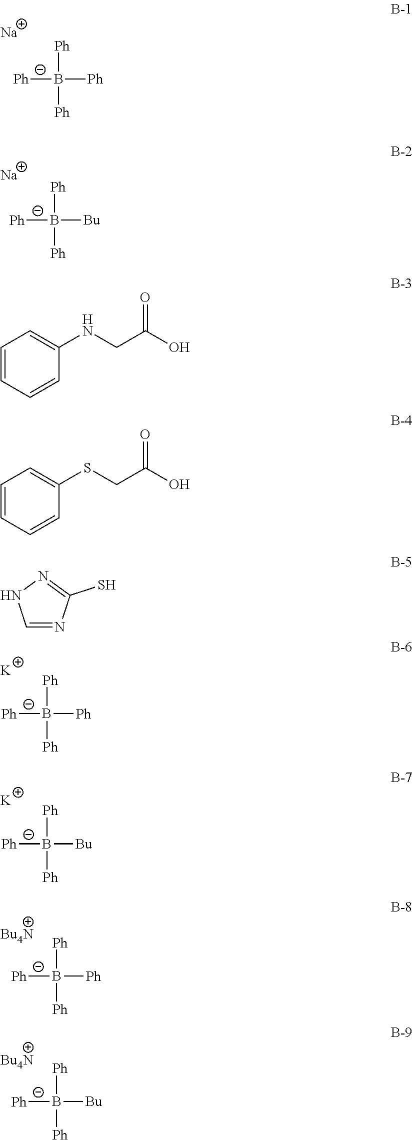

Further, from the viewpoint that the sensitivity is improved and UV plate skipping is unlikely to occur, the highest occupied molecular orbital (HOMO) of the electron-donating polymerization initiator used in the present disclosure is preferably −6.00 eV or greater, more preferably −5.95 eV or greater, and still more preferably −5.93 eV or greater.

Further, the upper limit thereof is preferably −5.00 eV or less and more preferably −5.40 eV or less.

The electron-donating polymerization initiator may be used alone or in combination of two or more kinds thereof.

From the viewpoints of the sensitivity and the printing durability, the content of the electron-donating polymerization initiator is preferably in a range of 0.01% by mass to 30% by mass, more preferably in a range of 0.05% by mass to 25% by mass, and still more preferably in a range of 0.1% by mass to 20% by mass with respect to the total mass of the image recording layer.

In the present disclosure, in a case where the image recording layer contains an onium ion and an anion in the above-described electron-donating polymerization initiator, the image recording layer is designed to contain an electron-accepting polymerization initiator and an electron-donating polymerization initiator.

(Relationship Between Electron-Donating Polymerization Initiator and Infrared Absorbing Agent)

From the viewpoints of improving the sensitivity and the UV printing durability, the image recording layer in the present disclosure contains the electron-donating polymerization initiator and the infrared absorbing agent, and the value of “HOMO of infrared absorbing agent—HOMO of electron-donating polymerization initiator” is preferably 0.70 eV or less and more preferably in a range of 0.70 eV to −0.10 eV.

Further, the negative values indicate that the HOMO of the electron-donating polymerization initiator is greater than the HOMO of the infrared absorbing agent.

[Polymer]

It is preferable that the image recording layer contains a polymer.

Examples of the polymer include a binder polymer and polymer particles.

Among these, from the viewpoints of the on-press developability and the UV printing durability, it is preferable that the image recording layer contains polymer particles.

(Binder Polymer)

The image recording layer may contain a binder polymer, but it is preferable that the image recording layer does not contain a binder polymer from the viewpoints of the on-press developability and the UV printing durability.

The binder polymer is a polymer other than the polymer particles, that is, a binder polymer that is not in the form of particles.

Preferred examples of the binder polymer include a (meth)acrylic resin, a polyvinyl acetal resin, and a polyurethane resin.

Among these, as the binder polymer, a known binder polymer used in the image recording layer of the lithographic printing plate precursor can be suitably used. As an example, the binder polymer used in the on-press development type lithographic printing plate precursor (hereinafter, also referred to as a binder polymer for on-press development) will be described in detail.

As the binder polymer for on-press development, a binder polymer having an alkylene oxide chain is preferable. The binder polymer having an alkylene oxide chain may have a poly(alkylene oxide) moiety in the main chain or in a side chain. Further, the binder polymer may be a graft polymer having poly(alkylene oxide) in a side chain or a block copolymer of a block formed of a poly(alkylene oxide)-containing repeating unit and a block formed of an (alkylene oxide)-free repeating unit.

A polyurethane resin is preferable in a case where the binder polymer has a poly(alkylene oxide) moiety in the main chain. Examples of the polymer of the main chain in a case of having a poly(alkylene oxide) moiety in a side chain include a (meth)acrylic resin, a polyvinyl acetal resin, a polyurethane resin, a polyurea resin, a polyimide resin, a polyamide resin, an epoxy resin, a polystyrene resin, a novolak type phenol resin, a polyester resin, synthetic rubber, and natural rubber. Among these, a (meth)acrylic resin is particularly preferable.

Further, other preferred examples of the binder polymer include a polymer compound (hereinafter, also referred to as a “star type polymer compound”) which has a polymer chain bonded to a nucleus through a sulfide bond by using a hexa- to decafunctional polyfunctional thiol as the nucleus and in which the polymer chain contains a polymerizable group. As the star type polymer compound, for example, compounds described in JP2012-148555A can be preferably used.

Examples of the star type polymer compound include compounds having a polymerizable group such as an ethylenically unsaturated bond in the main chain or in a side chain and preferably in a side chain for improving coated-film hardness of an image area as described in JP2008-195018A. Crosslinking occurs between polymer molecules by a polymerizable group so that curing is promoted.

Preferred examples of the polymerizable group include an ethylenically unsaturated group such as a (meth)acryl group, a vinyl group, an allyl group, or a styryl group and an epoxy group. Among these, from the viewpoint of polymerization reactivity, a (meth)acryl group, a vinyl group, or a styryl group is more preferable and a (meth)acryl group is particularly preferable. These groups can be introduced to a polymer by a polymer reaction or copolymerization. For example, a reaction between a polymer having a carboxy group in a side chain thereof and glycidyl methacrylate or a reaction between a polymer having an epoxy group and ethylenically unsaturated group-containing carboxylic acid such as methacrylic acid can be used. These groups may be used in combination.

The weight-average molecular weight (Mw) of the binder polymer in terms of polystyrene that is measured by the GPC method is preferably 2000 or greater, more preferably 5000 or greater, and still more preferably in a range of 10000 to 300000.

As necessary, hydrophilic polymers such as polyvinyl alcohol and polyacrylic acid described in JP2008-195018A can be used in combination. Further, a lipophilic polymer and a hydrophilic polymer can be used in combination.

In the image recording layer used in the present disclosure, the binder polymer may be used alone or in combination of two or more kinds thereof.

The image recording layer may contain an optional amount of the binder polymer, but from the viewpoints of the on-press developability, the UV printing durability, and the property of suppressing UV plate skipping, it is preferable that the image recording layer contains no binder polymer or the content of the binder polymer is greater than 0% by mass and 20% by mass or less with respect to the total mass of the image recording layer, more preferable that the image recording layer contains no binder polymer or the content of the binder polymer is greater than 0% by mass and 10% by mass or less with respect to the total mass of the image recording layer, still more preferable that the image recording layer contains no binder polymer or the content of the binder polymer is greater than 0% by mass and 5% by mass or less with respect to the total mass of the image recording layer, particularly preferable that the image recording layer contains no binder polymer or the content of the binder polymer is greater than 0% by mass and 2% by mass or less with respect to the total mass of the image recording layer, and most preferable that the image recording layer contains no binder polymer.

(Polymer Particles)

From the viewpoint of the UV printing durability, it is preferable that the image recording layer contains polymer particles.

It is preferable that the polymer particles are selected from the group consisting of thermoplastic polymer particles, thermally reactive polymer particles, polymer particles containing a polymerizable group, microcapsules encapsulating a hydrophobic compound, and microgels (crosslinked polymer particles). Among these, polymer particles containing a polymerizable group and a microgel are preferable. According to a particularly preferred embodiment, the polymer particles contain at least one ethylenically unsaturated polymerizable group. Due to the presence of such polymer particles, the effects of improving the printing durability of the exposed portion and the on-press developability of the non-image area can be obtained.

Further, it is preferable that the polymer particles are thermoplastic polymer particles.

Further, from the viewpoint of the UV printing durability, it is preferable that the polymer particles are addition polymerization type resin particles.

The oil dispersibility index of the polymer particles is not particularly limited, but is preferably 10% or greater, more preferably 50% or greater, still more preferably 60% or greater, and particularly preferably 65% or greater and 100% or less from the viewpoints of the UV printing durability, the on-press developability, and the property of suppressing dampening water turbidity.

A method of measuring the oil dispersibility index for polymer particles is described below.

0.1 g of an aqueous dispersion of polymer particles (preferably approximately 20% by mass of the solid content) is placed in a cylindrical cylinder container with a bottom area of 1 cm³ and mixed with 1.0 g of a washing liquid for AN oil-based ink, DYECLEAN (manufactured by Nisseki Mitsubishi Co., Ltd.). A desktop centrifuge “CHIBITAN-R XX42CFORT (manufactured by Yamato Scientific Co., Ltd.)” is used for mixing, and the mixture is stirred at room temperature (25° C.) for 5 minutes. The ratio (%) of the washing liquid/particle interface height h1 immediately after stirring to the liquid level height h2 is evaluated as the oil dispersibility index of the particles.

Preferred examples of the thermoplastic polymer particles include thermoplastic polymer particles described in Research Disclosure No. 33303 on January, 1992, JP1997-123387A (JP-H09-123387A), JP1997-131850A (JP-H09-131850A), JP1997-171249A (JP-H09-171249A), JP1997-171250A (JP-H09-171250A), and EP931647B.

Specific examples of a polymer constituting thermoplastic polymer particles include homopolymers or copolymers of monomers such as acrylate or methacrylate having structures of ethylene, styrene, vinyl chloride, methyl acrylate, ethyl acrylate, methyl methacrylate, ethyl methacrylate, vinylidene chloride, acrylonitrile, vinyl carbazole, and polyalkylene, and mixtures of these. Among these, copolymers containing polystyrene, styrene, and acrylonitrile, and polymethyl methacrylate are preferable. The average particle diameter of the thermoplastic polymer particles is preferably in a range of 0.01 μm to 3.0 μm.

Examples of the thermally reactive polymer particles include polymer particles having a thermally reactive group. The thermally reactive polymer particles are crosslinked by a thermal reaction and have hydrophobic regions formed by a change in functional groups during the crosslinking.

As the thermally reactive group in polymer particles having a thermally reactive group, a functional group that performs any reaction may be used as long as a chemical bond is formed, but a polymerizable group is preferable. Preferred examples of the polymerizable group include an ethylenically unsaturated group that performs a radical polymerization reaction (such as an acryloyl group, a methacryloyl group, a vinyl group, or an allyl group); a cationically polymerizable group (such as a vinyl group, a vinyloxy group, an epoxy group, or an oxetanyl group); an isocyanate group that performs an addition reaction or a block body thereof, an epoxy group, a vinyloxy group, and a functional group having active hydrogen atoms as the reaction partners of these (such as an amino group, a hydroxy group, or a carboxy group); a carboxy group that performs a condensation reaction and a hydroxy group or an amino group as a reaction partner thereof; and an acid anhydride that performs a ring opening addition reaction and an amino group or a hydroxy group as a reaction partner thereof.

The microcapsule is a microcapsule in which at least a part of constituent components of the image recording layer is encapsulated as described in JP2001-277740A and JP2001-277742A. Further, the constituent components of the image recording layer may be contained in a portion other than the microcapsule. Moreover, a preferred embodiment of the image recording layer containing the microcapsule is an embodiment in which hydrophobic constituent components are encapsulated by a microcapsule and hydrophilic constituent components are contained by a portion other than the microcapsule.

The microgel (crosslinked polymer particles) may contain a part of the constituent components of the image recording layer in at least one of the surface or the inside thereof. In particular, a reactive microgel having a radically polymerizable group on the surface thereof is preferable from the viewpoint of the sensitivity of the lithographic printing plate precursor to be obtained and the printing durability of the lithographic printing plate to be obtained.

The constituent components of the image recording layer can be made into microcapsules or microgel particles using a known method.

From the viewpoints of the printing durability, the stain resistance, and the storage stability of the lithographic printing plate to be obtained, it is preferable that the polymer particles are obtained by reacting a polyvalent isocyanate compound which is an adduct of a polyhydric phenol compound containing two or more hydroxy groups in a molecule and isophorone diisocyanate with a compound having active hydrogen.

As the polyhydric phenol compound, a compound having a plurality of benzene rings containing a phenolic hydroxy group is preferable.

As the compound having active hydrogen, a polyol compound or a polyamine compound is preferable, a polyol compound is more preferable, and at least one compound selected from the group consisting of propylene glycol, glycerin, and trimethylolpropane is still more preferable.

As the resin particles obtained by reacting the compound containing active hydrogen with the polyvalent isocyanate compound which is an adduct of a polyhydric phenol compound containing two or more hydroxy groups in a molecule and isophorone diisocyanate, polymer particles described in paragraphs 0032 to 0095 of JP2012-206495A are preferably exemplified.

Further, from the viewpoints of the printing durability and the solvent resistance of the lithographic printing plate to be obtained, it is preferable that the polymer particles have a hydrophobic main chain and both a constitutional unit i) containing a pendant-cyano group directly bonded to the hydrophobic main chain and a constitutional unit ii) containing a pendant group having a hydrophilic polyalkylene oxide segment.

As the hydrophobic main chain, an acrylic resin chain is preferably exemplified.

Preferred examples of the pendant-cyano group include —[CH₂CH(C≡N)—] and —[CH₂C(CH₃)(C≡N)—].

Further, the constitutional unit having a pendant-cyano group can be easily derived from an ethylenically unsaturated monomer such as acrylonitrile or methacrylonitrile or a combination of these.

Further, as the alkylene oxide in the hydrophilic polyalkylene oxide segment, ethylene oxide or propylene oxide is preferable and ethylene oxide is more preferable.

The repetition number of alkylene oxide structures in the hydrophilic polyalkylene oxide segment is preferably in a range of 10 to 100, more preferably in a range of 25 to 75, and still more preferably in a range of 40 to 50.

As the resin particles which have a hydrophobic main chain and both the constitutional unit i) containing a pendant-cyano group directly bonded to the hydrophobic main chain and the constitutional unit ii) containing a pendant group having a hydrophilic polyalkylene oxide segment, those described in paragraphs 0039 to 0068 of JP2008-503365A are preferably exemplified.

Further, from the viewpoints of the UV printing durability and the on-press developability, it is preferable that the polymer particles contain a hydrophilic group.

The hydrophilic group is not particularly limited as long as the hydrophilic group has a hydrophilic structure, and examples thereof include an acid group such as a carboxy group, a hydroxy group, an amino group, a cyano group, and a polyalkylene oxide structure.

Among these, from the viewpoints of the UV printing durability and the on-press developability, a polyalkylene oxide structure is preferable, and a polyethylene oxide structure, a polypropylene oxide structure, or a polyethylene/propylene oxide structure is more preferable.

Further, from the viewpoints of the on-press developability and a property of suppressing development scum in a case of on-press development, as the polyalkylene oxide structure, the constitutional unit has preferably a polypropylene oxide structure and more preferably a polyethylene oxide structure and a polypropylene oxide structure.

Further, from the viewpoints of the printing durability, the impressing property, and the on-press developability, the polymer particles contain preferably a constitutional unit containing a cyano group or a group represented by Formula Z, more preferably a constitutional unit represented by Formula (AN) or a group represented by Formula Z, and particularly preferably a group represented by Formula Z, as the hydrophilic group.

*-Q-W—Y Formula Z

In Formula Z, Q represents a divalent linking group, W represents a divalent group having a hydrophilic structure or a divalent group having a hydrophobic structure, Y represents a monovalent group having a hydrophilic structure or a monovalent group having a hydrophobic structure, any one of W or Y has a hydrophilic structure, and * represents a bonding site with respect to another structure.

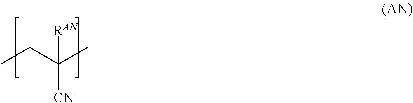

In Formula (AN), R^{AN} represents a hydrogen atom or a methyl group.

From the viewpoint of the UV printing durability, it is preferable that the polymer contained in the polymer particles has a constitutional unit formed of a compound containing a cyano group.

It is preferable that the cyano group is introduced as a constitutional unit containing a cyano group, typically using a compound (monomer) containing a cyano group. Examples of the compound containing a cyano group include an acrylonitrile compound, and suitable examples thereof include (meth)acrylonitrile.

As the constitutional unit containing a cyano group, a constitutional unit formed of an acrylonitrile compound is preferable, and a constitutional unit formed of (meth)acrylonitrile, that is, a constitutional unit represented by Formula (AN) is more preferable.

In a case where the polymer contains a polymer having a constitutional unit containing a cyano group, from the viewpoint of the UV printing durability, the content of the constitutional unit containing a cyano group or preferably the content of the constitutional unit represented by Formula (AN) in the polymer having a constitutional unit containing a cyano group is preferably in a range of 5% by mass to 90% by mass, more preferably in a range of 20% by mass to 80% by mass, and particularly preferably in a range of 30% by mass to 60% by mass with respect to the total mass of the polymer having a constitutional unit containing a cyano group.

From the viewpoint of the UV printing durability, it is preferable that the polymer particles have a constitutional unit formed of an aromatic vinyl compound.

The aromatic vinyl compound may be a compound having a structure in which a vinyl group is bonded to an aromatic ring, and examples thereof include a styrene compound and a vinylnaphthalene compound. Among these, a styrene compound is preferable, and styrene is more preferable.

Examples of the styrene compound include styrene, p-methylstyrene, p-methoxystyrene, β-methylstyrene, p-methyl-β-methylstyrene, α-methylstyrene, and p-methoxy-β-methylstyrene. Among these, styrene is preferable.

Examples of the vinylnaphthalene compound include 1-vinylnaphthalene, methyl-1-vinylnaphthalene, β-methyl-1-vinylnaphthalene, 4-methyl-1-vinylnaphthalene, and 4-methoxy-1-vinylnaphthalene. Among these, 1-vinylnaphthalene is preferable.

Further, preferred examples of the constitutional unit formed of the aromatic vinyl compound include a constitutional unit represented by Formula Z1.

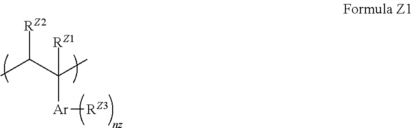

In Formula Z1, R^{Z1} and R^{Z2} each independently represent a hydrogen atom or an alkyl group, Ar represents an aromatic ring group, R^{Z3} represents a substituent, and nz represents an integer of 0 to the maximum number of substituents for Ar.

In Formula Z1, R^{Z1} and R^{Z2} each independently represent preferably a hydrogen atom or an alkyl group having 1 to 4 carbon atoms, more preferably a hydrogen atom or a methyl group, and still more preferably a hydrogen atom.

In Formula Z1, Ar represents preferably a benzene ring or a naphthalene ring and more preferably a benzene ring.

In Formula Z1, RZ³ represents preferably an alkyl group or an alkoxy group, more preferably an alkyl group having 1 to 4 carbon atoms or an alkoxy group having 1 to 4 carbon atoms, and still more preferably a methyl group or a methoxy group.

In Formula Z1, in a case where a plurality of R^{Z3}'s are present, the plurality of R^{Z3}'s may be the same as or different from each other.

In Formula Z1, nz represents preferably an integer of 0 to 2, more preferably 0 or 1, and still more preferably 0.

The polymer particles may contain only one or two or more kinds of constitutional units formed of an aromatic vinyl compound.

From the viewpoint of the ink impressing property, the content of the constitutional unit formed of the aromatic vinyl compound in the polymer particles is preferably in a range of 0.1% by mass to 20% by mass, more preferably in a range of 0.5% by mass to 15% by mass, and particularly preferably in a range of 1% by mass to 10% by mass with respect to the total mass of the polymer particles.

From the viewpoint of the UV printing durability, the polymer particles have preferably a crosslinked structure and more preferably a constitutional unit having a crosslinked structure.

It is considered that since the polymer particles have a crosslinked structure, the hardness of the polymer particles is improved, the strength of the image area is improved, and thus the printing durability (UV printing durability) is further improved even in a case where an ultraviolet curable ink that is more likely to deteriorate a plate than other inks is used.

The crosslinked structure is not particularly limited, but a constitutional unit formed by polymerizing a polyfunctional ethylenically unsaturated compound or a constitutional unit in which one or more reactive groups form a covalent bond inside a particle is preferable. From the viewpoints of the UV printing durability and the on-press developability, the number of functional groups in the polyfunctional ethylenically unsaturated compound is preferably in a range of 2 to 15, more preferably in a range of 3 to 10, still more preferably in a range of 4 to 10, and particularly preferably in a range of 5 to 10.

That is, from the viewpoints of the UV printing durability and the on-press developability, it is preferable that the constitutional unit having a crosslinked structure is a bifunctional to pentadeca-functional branched unit.

Further, an n-functional branched unit indicates a branched unit having n molecular chains, that is, a constitutional unit having an n-functional branching point (crosslinked structure).

Further, it is also preferable that a crosslinked structure is formed by a polyfunctional mercapto compound.

The ethylenically unsaturated group in the polyfunctional ethylenically unsaturated compound is not particularly limited, and examples thereof include a (meth)acryloxy group, a (meth)acrylamide group, an aromatic vinyl group, and a maleimide group.

Further, it is preferable that the polyfunctional ethylenically unsaturated compound is a polyfunctional (meth)acrylate compound, a polyfunctional (meth)acrylamide compound, or a polyfunctional aromatic vinyl compound.

Examples of the polyfunctional (meth)acrylate compound include diethylene glycol diacrylate, triethylene glycol diacrylate, tetraethylene glycol diacrylate, trimethylolpropane diacrylate, trimethylolpropane triacrylate, 1,4-butanediol diacrylate, 1,6-hexanediol diacrylate, polyethylene glycol diacrylate, polypropylene glycol diacrylate, tricyclodecane dimethylol diacrylate, ditrimethylolpropane tetraacrylate, pentaerythritol triacrylate, pentaerythritol tetraacrylate, dipentaerythritol triacrylate, dipentaerythritol hexaacrylate, and triacrylate of tris(β-hydroxyethyl)isocyanurate.

Examples of the polyfunctional (meth)acrylate compound include N,N′-methylene bisacrylamide, and N-[tris(3-acrylamidopropoxymethyl)methyl]acrylamide.

Examples of the polyfunctional aromatic vinyl compound include divinylbenzene.

The number of carbon atoms in the branched unit is not particularly limited, but is preferably in a range of 8 to 100 and more preferably in a range of 8 to 70.

The polymer particles may have only one or two or more kinds of constitutional units having a crosslinked structure.

From the viewpoints of the UV printing durability and the on-press developability, the content of the constitutional unit having a crosslinked structure in the polymer particles is preferably in a range of 0.1% by mass to 20% by mass, more preferably in a range of 0.5% by mass to 15% by mass, and particularly preferably in a range of 1% by mass to 10% by mass with respect to the total mass of the polymer particles.

Further, from the viewpoints of the printing durability, the impressing property, and the on-press developability, it is preferable that the polymer particles include polymer particles containing a group represented by Formula Z.

Q in Formula Z represents preferably a divalent linking group having 1 to 20 carbon atoms and more preferably a divalent linking group having 1 to 10 carbon atoms.

Further, Q in Formula Z represents preferably an alkylene group, an arylene group, an ester bond, an amide bond, or a group formed by combining two or more of these groups and more preferably a phenylene group, an ester bond, or an amide bond.

It is preferable that the divalent group having a hydrophilic structure as W in Formula Z is a polyalkyleneoxy group or a group in which —CH₂CH₂NR^{W}— is bonded to one terminal of a polyalkyleneoxy group. Further, R^{W} represents a hydrogen atom or an alkyl group.

It is preferable that the divalent group having a hydrophobic structure as W in Formula Z is —R^{WA}—, —O—R^{WA}—O—, —R^{W}N—R^{WA}—NR^{W}—, —OC(═O)—R^{WA}—O—, or —OC(═O)—R^{WA}—O—. Further, R^{WA}'s each independently represent a linear, branched, or cyclic alkylene group having 6 to 120 carbon atoms, a haloalkylene group having 6 to 120 carbon atoms, an arylene group having 6 to 120 carbon atoms, an alkarylene group having 6 to 120 carbon atoms (a divalent group obtained by removing one hydrogen atom from an alkylaryl group), or an aralkylene group having 6 to 120 carbon atoms, and R^{W} represents a hydrogen atom or an alkyl group.

It is preferable that the monovalent group having a hydrophilic structure as Y in Formula Z is —OH, —C(═O)OH, a polyalkyleneoxy group having a hydrogen atom or an alkyl group at a terminal, or a group in which —CH₂CH₂N(R^{W})— is bonded to a terminal of a polyalkyleneoxy group having a hydrogen atom or an alkyl group at the other terminal. Even in this case, R^{W} represents a hydrogen atom or an alkyl group.

It is preferable that the monovalent group having a hydrophobic structure as Y in Formula Z is a linear, branched, or cyclic alkyl group having 6 to 120 carbon atoms, a haloalkyl group having 6 to 120 carbon atoms, an aryl group having 6 to 120 carbon atoms, an alkaryl group (an alkylaryl group) 7 to 120 carbon atoms, an aralkyl group having 7 to 120 carbon atoms, —OR^{WB}, —C(═O)OR^{WB}, or —OC(═O)R^{WB}. R^{WB} represents an alkyl group having 6 to 20 carbon atoms.

From the viewpoints of the printing durability, the impressing property, and the on-press developability, as the polymer particles containing a group represented by Z, it is more preferable that W represents a divalent group having a hydrophilic structure and more preferable that Q represents a phenylene group, an ester bond, or an amide bond, W represents a polyalkyleneoxy group, and Y represents a polyalkyleneoxy group having a hydrogen atom or an alkyl group at the terminal.

Further, from the viewpoints of the printing durability, the impressing property, the property of suppressing UV plate skipping, and the on-press developability, the polymer particles include preferably polymer particles containing a polymerizable group and more preferably polymer particles containing a polymerizable group on the surface of each particle.

Further, from the viewpoint of the printing durability, it is preferable that the polymer particles include polymer particles containing a hydrophilic group and a polymerizable group.

The polymerizable group may be a cationically polymerizable group or a radically polymerizable group, but a radically polymerizable group is preferable from the viewpoint of the reactivity.

The polymerizable group is not particularly limited as long as the group is polymerizable, but from the viewpoint of the reactivity, an ethylenically unsaturated group is preferable, a vinylphenyl group (styryl group), a (meth)acryloxy group, or a (meth)acrylamide group is more preferable, and a (meth)acryloxy group is particularly preferable.

Further, it is preferable that the polymer in the polymer particles containing a polymerizable group has a constitutional unit containing a polymerizable group.

Further, a polymerizable group may be introduced to the surface of the polymer particles by a polymer reaction.

Further, from the viewpoints of the printing durability, the impressing property, the property of suppressing UV plate skipping, the on-press developability, and the property of suppressing development scum during the on-press development, the polymer particles contain preferably a resin having a urea bond, more preferably a resin having a structure obtained by reacting at least water with an isocyanate compound represented by Formula (Iso), and particularly preferably a resin having a structure obtained by reacting at least water with an isocyanate compound represented by Formula (Iso) and a polyethylene oxide structure and a polypropylene oxide structure as a polyoxyalkylene structure. Further, it is preferable that the particles containing a resin having a urea bond are microgels.

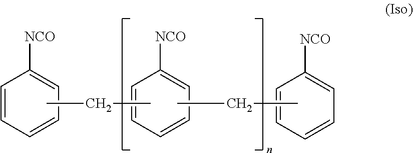

In Formula (Iso), n represents an integer of 0 to 10.

The following reaction will be described as an example of the reaction between the isocyanate compound represented by Formula (Iso) and water. The following example is an example using n=0, 4, 4-isomer.

As described below, in a case where the isocyanate compound represented by Formula (Iso) and water react with each other, a part of the isocyanate group is hydrolyzed by water to generate an amino group, and the generated amino group and the isocyanate group react with each other to generate a urea bond, thereby forming a dimer. Further, the following reaction is repeated to form a resin having a urea bond.

Further, in the following reaction, a structure such as an alcohol compound or an amine compound can be introduced to a resin having a urea bond by adding a compound (compound having active hydrogen) having reactivity with an isocyanate group such as an alcohol compound or an amine compound.

Preferred examples of the compound having active hydrogen include those described in the section of the microgel.

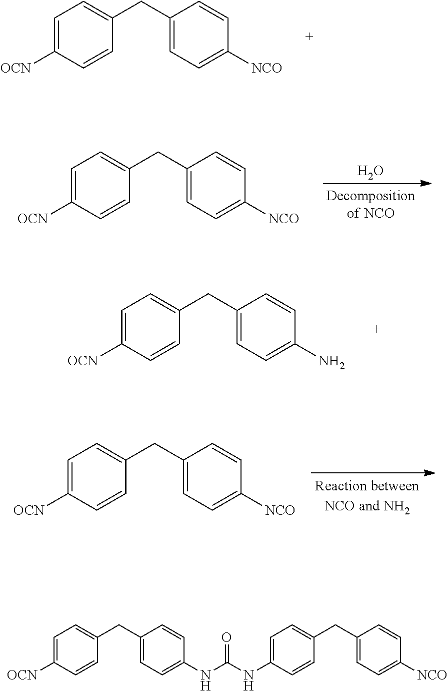

Further, the resin having a urea bond contains preferably an ethylenically unsaturated group and more preferably a group represented by Formula (PETA).

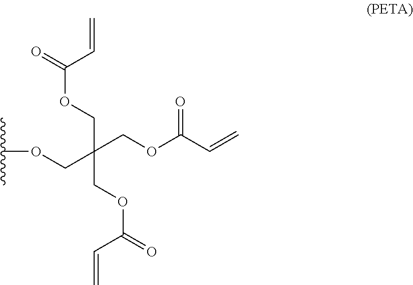 [SMILES: *OCC(COC(=O)C=C)(COC(=O)C=C)COC(=O)C=C]

In Formula (PETA), the wavy line portion represents a bonding position with respect to other structures.

The average particle diameter of the particles is preferably in a range of 0.01 μm to 3.0 μm, more preferably in a range of 0.03 μm to 2.0 μm, and still more preferably in a range of 0.10 μm to 1.0 μm. In a case where the average particle diameter thereof is in the above-described range, excellent resolution and temporal stability are obtained.

The average primary particle diameter of the particles in the present disclosure is obtained by measuring the diameter of each particle according to a light scattering method or capturing an electron micrograph of the particles and measuring the particle diameters of a total of 5000 particles on the image, and calculating the average value thereof. Further, the particle diameter of a spherical particle having the same particle area as the particle area on the image is set as the particle diameter of a non-spherical particle.

Further, the average particle diameter in the present disclosure is the volume average particle diameter unless otherwise specified.

The image recording layer may contain only one or two or more kinds of particles, particularly, polymer particles.

From the viewpoints of the developability and the UV printing durability, the content of the particles, particularly the polymer particles, in the image recording layer is preferably in a range of 5% by mass to 90% by mass, more preferably in a range of 10% by mass to 90% by mass, still more preferably in a range of 20% by mass to 90% by mass, and particularly preferably in a range of 50% by mass to 90% by mass with respect to the total mass of the image recording layer.

Further, from the viewpoints of the developability and the UV printing durability, the content of the polymer particles in the image recording layer is preferably in a range of 20% by mass to 100% by mass, more preferably in a range of 35% by mass to 100% by mass, still more preferably in a range of 50% by mass to 100% by mass, and particularly preferably in a range of 80% by mass to 100% by mass with respect to the total mass of the components having a molecular weight of 3000 or greater in the image recording layer.

(Synthesis of Polymer Particles)

A method of synthesizing the polymer particles is not particularly limited, and any method may be used as long as the polymer particles can be synthesized with the various resins described above. Examples of the method of synthesizing polymer particles include known methods of synthesizing polymer particles, such as an emulsion polymerization method, a suspension polymerization method, a dispersion polymerization method, a soap-free polymerization method, and a microemulsion polymerization method.

In addition, a known method of synthesizing microcapsules, a method of synthesizing microgels (crosslinked polymer particles), or the like may be used for synthesizing polymer particles.

[Chain Transfer Agent]

The image recording layer may contain a chain transfer agent. The chain transfer agent contributes to improvement of the printing durability of the lithographic printing plate.

As the chain transfer agent, a thiol compound is preferable, a thiol having 7 or more carbon atoms is more preferable from the viewpoint of the boiling point (difficulty in volatilization), and a compound containing a mercapto group on an aromatic ring (aromatic thiol compound) is still more preferable. It is preferable that the thiol compound is a monofunctional thiol compound.

Specific examples of the chain transfer agent include the following compounds.

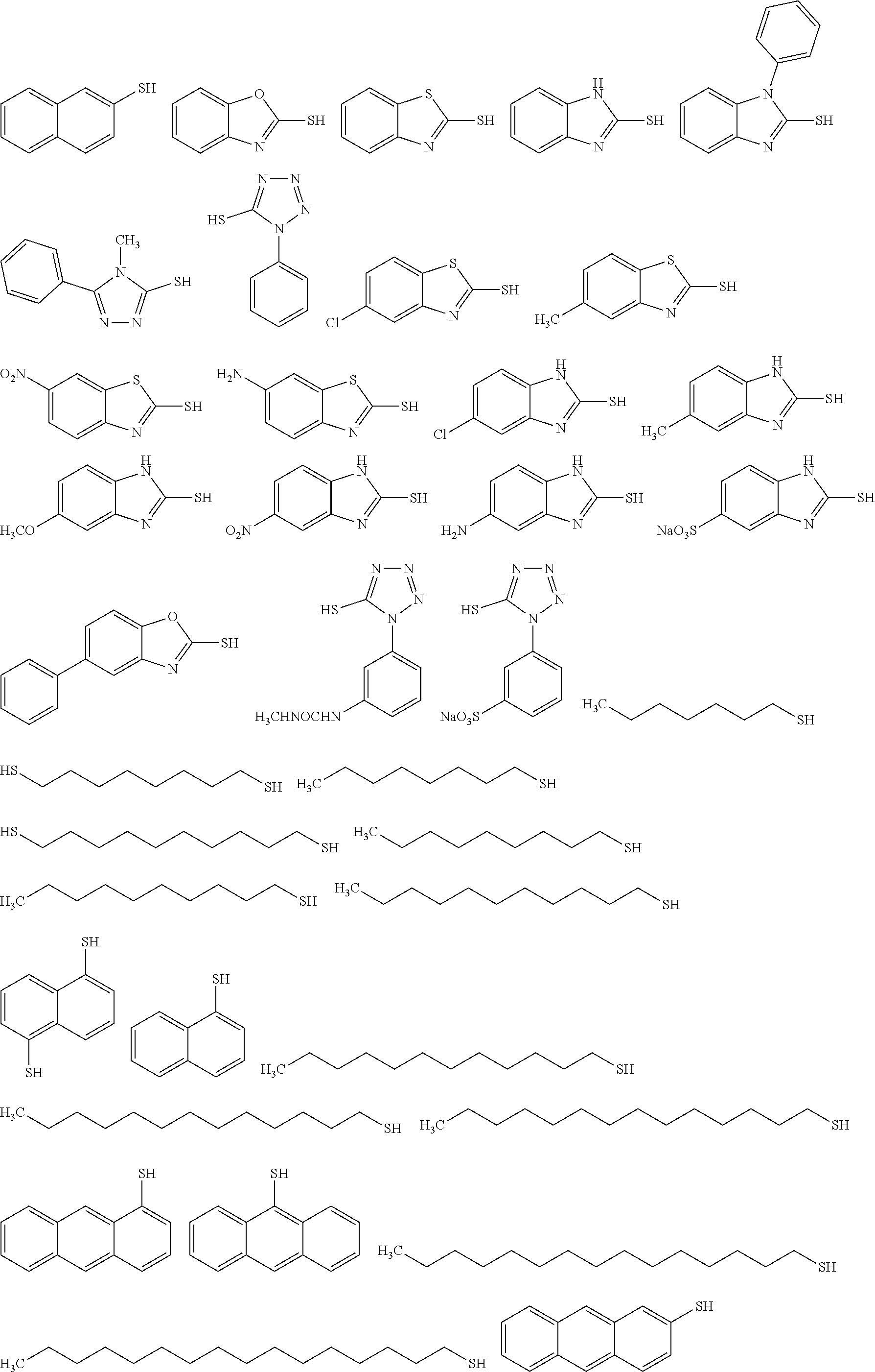

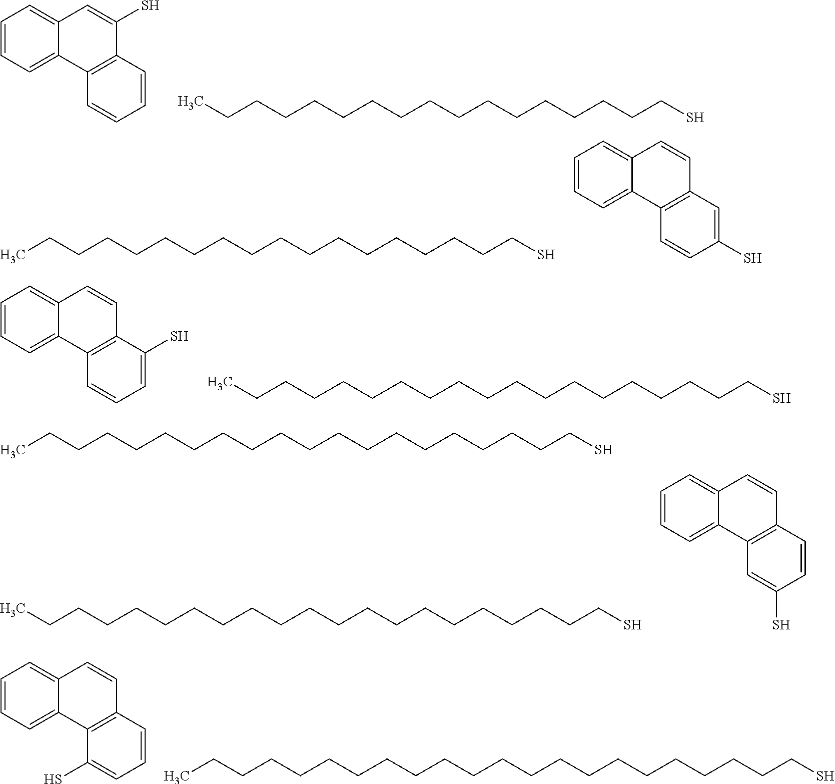

The chain transfer agent may be used alone or in combination of two or more kinds thereof.

The content of the chain transfer agent is preferably in a range of 0.01% by mass to 50% by mass, more preferably in a range of 0.05% by mass to 40% by mass, and still more preferably in a range of 0.1% by mass to 30% by mass with respect to total mass of the image recording layer.

[Low-Molecular-Weight Hydrophilic Compound]

In order to suppress a decrease in printing durability and to improve the developability, the image recording layer may contain a low-molecular-weight hydrophilic compound. As the low-molecular-weight hydrophilic compound, a compound having a molecular weight of less than 1000 is preferable, a compound having a molecular weight of less than 800 is more preferable, and a compound having a molecular weight of less than 500 is still more preferable.

As the low-molecular-weight hydrophilic compound, examples of a water-soluble organic compound include glycols such as ethylene glycol, diethylene glycol, triethylene glycol, propylene glycol, dipropylene glycol, and tripropylene glycol and ether or ester derivatives thereof; polyols such as glycerin, pentaerythritol, and tris(2-hydroxyethyl) isocyanurate; organic amines such as triethanolamine, diethanolamine, and monoethanolamine and salts thereof; organic sulfonic acids such as alkylsulfonic acid, toluenesulfonic acid, and benzenesulfonic acid and salts thereof; organic sulfamic acids such as alkyl sulfamic acid and salts thereof; organic sulfuric acids such as alkyl sulfuric acid and alkyl ether sulfuric acid and salts thereof; organic phosphonic acids such as phenyl phosphonic acid and salts thereof; organic carboxylic acids such as tartaric acid, oxalic acid, citric acid, malic acid, lactic acid, gluconic acid, and amino acids and salts thereof; and betaines.

Among these, it is preferable that the image recording layer contains at least one selected from the group consisting of polyols, organic sulfates, organic sulfonates, and betaines, as the low-molecular-weight hydrophilic compound.

Specific examples of the organic sulfonates include an alkyl sulfonate such as sodium n-butyl sulfonate, sodium n-hexyl sulfonate, sodium 2-ethylhexyl sulfonate, sodium cyclohexyl sulfonate, or sodium n-octyl sulfonate; an alkyl sulfonate containing an ethylene oxide chain such as sodium 5,8,11-trioxapentadecane-1-sulfonate, sodium 5,8,11-trioxaheptadecane-1-sulfonate, sodium 13-ethyl-5,8,11-trioxaheptadecane-1-sulfonate, or sodium 5,8,11,14-tetraoxatetradecosane-1-sulfonate; an aryl sulfonate such as sodium benzene sulfonate, sodium p-toluene sulfonate, sodium p-hydroxybenzene sulfonate, sodium p-styrene sulfonate, sodium isophthalic acid dimethyl-5-sulfonate, sodium 1-naphthyl sulfonate, sodium 4-hydroxynaphthyl sulfonate, disodium 1,5-naphthalene disulfonate, or trisodium 1,3,6-naphthalene trisulfonate; and compounds described in paragraphs 0026 to 0031 of JP2007-276454A and paragraphs 0020 to 0047 of JP2009-154525A. The salt may be potassium salt or lithium salt.

Examples of the organic sulfates include an alkyl, an alkenyl, an alkynyl, and an aryl of polyethylene oxide and a sulfate of heterocyclic monoether. The number of ethylene oxide units is preferably in a range of 1 to 4. As a salt, a sodium salt, a potassium salt, or a lithium salt is preferable. Specific examples thereof include compounds described in paragraphs 0034 to 0038 of JP2007-276454A.

As betaines, compounds having 1 to 5 carbon atoms of hydrocarbon substituents to nitrogen atoms are preferable. Specific examples thereof include trimethyl ammonium acetate, dimethyl propyl ammonium acetate, 3-hydroxy-4-trimethyl ammonio butyrate, 4-(1-pyridinio)butyrate, 1-hydroxyethyl-1-imidazolioacetate, trimethyl ammonium methane sulfonate, dimethyl propyl ammonium methane sulfonate, 3-trimethylammonio-1-propane sulfonate, and 3-(1-pyridinio)-1-propane sulfonate.

Since the low-molecular-weight hydrophilic compound has a small structure of a hydrophobic portion and does not almost exhibit a surfactant action, the hydrophobicity or coated-film hardness of an image area is not degraded by dampening water permeating into an exposed portion (image area) of the image recording layer and the ink receiving property or printing durability of the image recording layer can be maintained satisfactorily.

The content of the low-molecular-weight hydrophilic compounds is preferably in a range of 0.5% by mass to 20% by mass, more preferably in a range of 1% by mass to 15% by mass, and still more preferably in a range of 2% by mass to 10% by mass with respect to the total mass of the image recording layer. In a case where the content thereof is in the above-described range, excellent developability and printing durability can be obtained.

The low-molecular-weight hydrophilic compounds may be used alone or in mixture of two or more kinds thereof.

[Oil Sensitizing Agent]

In order to improve the impressing property, the image recording layer may contain an oil sensitizing agent such as a phosphonium compound, a nitrogen-containing low-molecular-weight compound, or an ammonium group-containing polymer. Particularly, in a case where a protective layer contains an inorganic layered compound, these compounds function as a surface coating agent of the inorganic layered compound and suppress degradation of the impressing property due to the inorganic layered compound during the printing.

As the oil sensitizing agent, it is preferable that a phosphonium compound, a nitrogen-containing low-molecular-weight compound, and an ammonium group-containing polymer are used in combination and more preferable that a phosphonium compound, quatemary ammonium salts, and an ammonium group-containing polymer are used in combination.

Examples of the phosphonium compound include phosphonium compounds described in JP2006-297907A and JP2007-50660A. Specific examples thereof include tetrabutyl phosphonium iodide, butyl triphenyl phosphonium bromide, tetraphenyl phosphonium bromide, 1,4-bis(triphenylphosphonio)butane=di(hexafluorophosphate), 1,7-bis(triphenylphosphonio)heptane=sulfate, and 1,9-bis(triphenylphosphonio)nonane=naphthalene-2,7-disulfonate.

Examples of the nitrogen-containing low-molecular-weight compound include amine salts and quaternary ammonium salts. Further, examples thereof include imidazolinium salts, benzimidazolinium salts, pyridinium salts, and quinolinium salts. Among these, quaternary ammonium salts and pyridinium salts are preferable. Specific examples thereof include tetramethyl ammonium=hexafluorophosphate, tetrabutylammonium=hexafluorophosphate, dodecyltrimethylammonium=p-toluene sulfonate, benzyltriethylammonium=hexafluorophosphate, benzyldimethyloctylammonium=hexafluorophosphate, benzyldimethyldodecylammonium=hexafluorophosphate, and compounds described in paragraphs 0021 to 0037 of JP2008-284858A and paragraphs 0030 to 0057 of JP2009-90645A.

The ammonium group-containing polymer is not limited as long as the polymer contains an ammonium group in the structure thereof, but a polymer that contains, as a copolymerization component, 5% by mole to 80% by mole of (meth)acrylate containing an ammonium group in a side chain is preferable. Specific examples thereof include polymers described in paragraphs 0089 to 0105 of JP2009-208458A.

The reduced specific viscosity (unit: ml/g) of the ammonium group-containing polymer which is acquired by the measuring method described in JP2009-208458A is preferably in a range of 5 to 120, more preferably in a range of 10 to 110, and particularly preferably in a range of 15 to 100. In a case where the reduced specific viscosity is converted to the weight-average molecular weight (Mw), the value thereof is preferably in a range of 10000 to 1500000, more preferably in a range of 17000 to 140000, and particularly preferably in a range of 20000 to 130000.

Hereinafter, specific examples of the ammonium group-containing polymer will be described.

(1) A 2-(trimethylammonio)ethylmethacrylate=p-toluene sulfonate/3,6-dioxaheptylmethacrylate copolymer (molar ratio of 10/90, Mw of 45000);

(2) A 2-(trimethylammonio)ethylmethacrylate=hexafluorophosphate/3,6-dioxaheptylmethacrylate copolymer (molar ratio of 20/80, Mw of 60000);

(3) A 2-(ethyldimethylammonio)ethylmethacrylate=p-toluene sulfonate/hexylmethacrylate copolymer (molar ratio of 30/70, Mw of 45000);

(4) A 2-(trimethylammonio)ethylmethacrylate=hexafluorophosphate/2-ethylhexylmethacrylate copolymer (molar ratio of 20/80, Mw of 60000);

(5) A 2-(trimethylammonio)ethylmethacrylate=methylsulfate/hexylmethacrylate copolymer (molar ratio of 40/60, Mw of 70000);

(6) A 2-(butyldimethylammonio)ethylmethacrylate=hexafluorophosphate/3,6-dioxaheptylmethacrylate copolymer (molar ratio of 25/75, Mw of 65000);

(7) A 2-(butyldimethylammonio)ethylacrylate=hexafluorophosphate/3,6-dioxaheptylmethacrylate copolymer (molar ratio of 20/80, Mw of 65000);

(8) A 2-(butyldimethylammonio)ethylmethacrylate=13-ethyl-5,8,11-trioxa-1-heptadecanesulfonate/3,6-dioxaheptylmethacrylate copolymer (molar ratio of 20/80, Mw of 75000); and

(9) A 2-(butyldimethylammonio)ethylmethacrylate=hexafluorophosphate/3,6-dioxaheptylmethacrylate/2-hydroxy-3-methacryloxypropylmethacrylate copolymer (molar ratio of 15/80/5, Mw of 65000)

The content of the oil sensitizing agent is preferably in a range of 0.01% by mass to 30.0% by mass, more preferably in a range of 0.1% by mass to 15.0% by mass, and still more preferably in a range of 1% by mass to 10% by mass with respect to the total mass of the image recording layer.

[Infrared Absorbing Agent]

It is preferable that the image recording layer contains an infrared absorbing agent.

Examples of the infrared absorbing agents include pigments and dyes.

As dyes used as infrared absorbing agents, commercially available dyes and known dyes described in the literatures such as “Dye Handbook” (edited by the Society of Synthetic Organic Chemistry, Japan, published in 1970) can be used. Specific examples thereof include dyes such as an azo dye, a metal complex salt azo dye, a pyrazolone azo dye, a naphthoquinone dye, an anthraquinone dye, a phthalocyanine dye, a carbonium dye, a quinone imine dye, a methine dye, a cyanine dye, a squarylium coloring agent, a pyrylium salt, and a metal thiolate complex.

Among the above-described dyes, a cyanine coloring agent, a squarylium coloring agent, a pyrylium salt, a nickel thiolate complex, and an indolenine cyanine coloring agent are particularly preferable. Further, other examples thereof include a cyanine coloring agent and an indolenine cyanine coloring agent. Among these, a cyanine coloring agent is particularly preferable.

Specific examples of the cyanine coloring agent include compounds described in paragraphs 0017 to 0019 of JP2001-133969A and compounds described in paragraphs 0016 to 0021 of JP2002-023360A and paragraphs 0012 to 0037 of JP2002-040638A, preferred examples thereof include compounds described in paragraphs 0034 to 0041 of JP2002-278057A and paragraphs 0080 to 0086 of JP2008-195018A, and particularly preferred examples thereof include compounds described in paragraphs 0035 to 0043 of JP2007-90850A and compounds described in paragraphs 0105 to 0113 of JP2012-206495A.

Further, compounds described in paragraphs 0008 and 0009 of JP1993-5005A (JP-H05-5005A) and paragraphs 0022 to 0025 of JP2001-222101A can be preferably used.

As the pigments, compounds described in paragraphs 0072 to 0076 of JP2008-195018A are preferable.

Further, an infrared absorbing agent that is decomposed upon exposure to infrared rays (also referred to as a “decomposable infrared absorbing agent”) can also be suitably used.

Further, as the infrared absorbing agent that is decomposed by exposure to infrared rays, those described in JP2008-544322A, WO2016/027886A, WO2017/141882A, or WO2018/043259A can be suitably used.

The infrared absorbing agent may be used alone or in combination of two or more kinds thereof. Further, pigments and dyes may be used in combination as the infrared absorbing agent.

The content of the infrared absorbing agent in the image recording layer is preferably in a range of 0.1% by mass to 10.0% by mass and more preferably in a range of 0.5% by mass to 5.0% by mass with respect to total mass of the image recording layer.

[Polymerizable Compound]

It is preferable that the image recording layer contains a polymerizable compound. In the present disclosure, the polymerizable compound indicates a compound containing a polymerizable group.

The polymerizable group is not particularly limited as long as a known polymerizable group is used, and an ethylenically unsaturated group is preferable. Further, the polymerizable group may be a radically polymerizable group or a cationically polymerizable group, but a radically polymerizable group is preferable.

Examples of the radically polymerizable group include a (meth)acryloyl group, an allyl group, a vinylphenyl group, and a vinyl group. Among these, from the viewpoint of the reactivity, a (meth)acryloyl group is preferable.

The molecular weight (the weight-average molecular weight in a case of having a molecular weight distribution) of the polymerizable compound is preferably 50 or greater and less than 2500.

The polymerizable compound used in the present disclosure may be, for example, a radically polymerizable compound or a cationically polymerizable compound, but it is preferable that the polymerizable compound is an addition polymerizable compound having at least one ethylenically unsaturated bond (ethylenically unsaturated compound). As the ethylenically unsaturated compound, a compound having at least one terminal ethylenically unsaturated bond is preferable, and a compound having two or more terminal ethylenically unsaturated bonds is more preferable. The polymerizable compound may have a chemical form such as a monomer, a pre-polymer, that is, a dimer, a trimer, or an oligomer, or a mixture thereof.

Among these, from the viewpoint of the UV printing durability, the image recording layer contains preferably a tri- or higher functional polymerizable compound, more preferably a hepta- or higher functional polymerizable group, and still more preferably a deca- or higher functional polymerizable group, as the polymerizable compound. Further, from the viewpoint of the UV printing durability of the lithographic printing plate to be obtained, the polymerizable compound contains preferably a tri- or higher functional (preferably hepta- or higher functional and more preferably deca- or higher functional) ethylenically unsaturated compound and more preferably a tri- or higher functional (preferably hepta- or higher functional and more preferably deca- or higher functional) (meth)acrylate compound.

(Oligomer)

As the polymerizable compound contained in the image recording layer, it is preferable that the image recording layer contains a polymerizable compound which is an oligomer (hereinafter, also simply referred to as “oligomer”).

In the present disclosure, the oligomer indicates a polymerizable compound having a molecular weight (a weight-average molecular weight in a case of having a molecular weight distribution) of 600 to 10000 and containing at least one polymerizable group.

From the viewpoint that the chemical resistance and the UV printing durability are more excellent, the molecular weight of the oligomer is preferably in a range of 1000 to 5000.

Further, from the viewpoint of improving the UV printing durability, the number of polymerizable groups in one molecule of the oligomer is preferably 2 or greater, more preferably 3 or greater, still more preferably 6 or greater, and particularly preferably 10 or greater.

Further, the upper limit of the number of polymerizable groups in the oligomer is not particularly limited, but the number of polymerizable groups is preferably 20 or less.

From the viewpoints of the UV printing durability, the visibility, and the on-press developability, an oligomer having 7 or more polymerizable groups and a molecular weight of 1000 or greater 10000 or less is preferable, and an oligomer having 7 or greater 20 or less polymerizable groups and a molecular weight of 1000 or greater and 5000 or less is more preferable as the oligomer.

From the viewpoints of the UV printing durability, the visibility, and the on-press developability, the oligomer contains preferably at least one selected from the group consisting of a compound having a urethane bond, a compound having an ester bond, and a compound having an epoxy residue, and more preferably a compound having a urethane bond.

The epoxy residue in the present specification indicates a structure formed of an epoxy group and means, for example, the same structure as the structure obtained by the reaction between an acid group (a carboxylic acid group or the like) and an epoxy group.
—Compound Having Urethane Bond—

The compound having a urethane bond is not particularly limited, and examples thereof include a compound obtained by reacting a polyisocyanate compound with a compound containing a hydroxy group and a polymerizable group.

Examples of the polyisocyanate compound include bifunctional to pentafunctional polyisocyanate compounds. Among these, a bifunctional or trifunctional polyisocyanate compound is preferable.

Preferred examples of the polyisocyanate compound include 1,3-bis(isocyanatomethyl)cyclohexane, isophorone diisocyanate, trimethylene diisocyanate, tetramethylene diisocyanate, pentamethylene diisocyanate, hexamethylene diisocyanate, 1,3-cyclopentane diisocyanate, 9H-fluorene-2,7-diisocyanate, 9H-fluorene-9-one-2,7-diisocyanate, 4,4′-diphenylmethane diisocyanate, 1,3-phenylene diisocyanate, tolylene-2,4-diisocyanate, tolylene-2,6-diisocyanate, 1,3-bis(isocyanatomethyl)cyclohexane, 2,2-bis(4-isocyanatophenyl)hexafluoropropane, 1,5-diisocyanatonaphthalene, dimers of these polyisocyanates, and trimmers (isocyanurate bond) thereof. Further, a biuret product obtained by reacting the above-described polyisocyanate compound with a known amine compound may be used.

As the compound containing a hydroxy group and a polymerizable group, a compound containing one hydroxy group and one or more polymerizable groups is preferable, and a compound containing one hydroxy group and two or more polymerizable groups is more preferable.

Examples of the compound containing a hydroxy group and a polymerizable group include hydroxyethyl (meth)acrylate, glycerin di(meth)acrylate, trimethylolpropane di(meth)acrylate, pentaerythritol tri(meth)acrylate, and dipentaerythritol penta(meth)acrylate.

As the compound having a urethane bond, for example, a compound containing at least a group represented by Formula (Ac-1) or Formula (Ac-2) is preferable, and a compound containing at least a group represented by Formula (Ac-1) is more preferable.

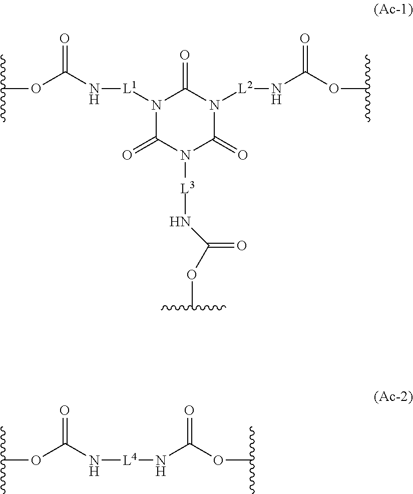

In Formulae (Ac-1) and (Ac-2), L¹ to L⁴ each independently represent a divalent hydrocarbon group having 2 to 20 carbon atoms, and the wavy line represents a bonding position with respect to another structure.

L¹ to L⁴ each independently represent preferably an alkylene group having 2 to 20 carbon atoms, more preferably an alkylene group having 2 to 10 carbon atoms, and still more preferably an alkylene group having 4 to 8 carbon atoms. Further, the alkylene group may have a branched or ring structure, but it is preferable that the alkylene group is a linear alkylene group.

It is preferable that each wavy line in Formula (Ac-1) or Formula (Ac-2) is independently bonded directly to the wavy line in a group represented by Formula (Ae-1) or Formula (Ae-2).

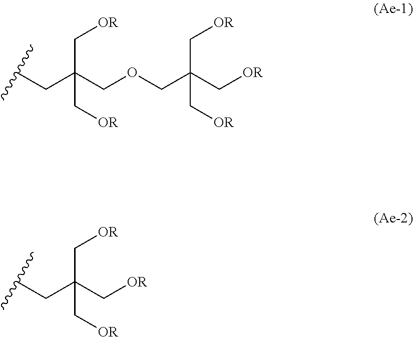

In Formulae (Ae-1) and (Ae-2), R's each independently represent an acryloyloxy group or a methacryloyloxy group, and the wavy line represents a bonding position with respect to the wavy line in Formulae (Ac-1) and (Ac-2).

Further, as the compound having a urethane bond, a compound in which a polymerizable group is introduced to polyurethane obtained by the reaction between a polyisocyanate compound and a polyol compound through a polymer reaction may be used. For example, a compound having a urethane bond may be obtained by reacting a compound that contains an epoxy group and a polymerizable group with a polyurethane oligomer obtained by reacting a polyol compound containing an acid group with a polyisocyanate compound.

—Compound Having Ester Bond—

The number of polymerizable groups in the compound having an ester bond is preferably 3 or greater and more preferably 6 or greater.

—Compound Having Epoxy Residue—

As the compound having an epoxy residue, a compound containing a hydroxy group in the compound is preferable.

Further, the number of polymerizable groups in the compound having an epoxy residue is preferably in a range of 2 to 6 and more preferably 2 or 3.

The compound having an epoxy residue can be obtained, for example, by reacting acrylic acid with a compound containing an epoxy group.

From the viewpoint of improving the chemical resistance, the UV printing durability, and the property of suppressing on-press development scum, the content of the oligomer is preferably in a range of 30% by mass and 100% by mass, more preferably in a range of 50% by mass to 100% by mass, and still more preferably in a range of 80% by mass to 100% by mass with respect to the total mass of the polymerizable compound in the image recording layer.

The polymerizable compound may further contain a polymerizable compound other than the oligomer described above.

The polymerizable compound other than the oligomer may be, for example, a radically polymerizable compound or a cationically polymerizable compound, but it is preferable that the polymerizable compound is an addition polymerizable compound having at least one ethylenically unsaturated group (ethylenically unsaturated compound). As the ethylenically unsaturated compound, a compound containing at least one ethylenically unsaturated group at the terminal is preferable, and a compound containing two or more ethylenically unsaturated groups at the terminal is more preferable.

From the viewpoint of the chemical resistance, it is preferable that the polymerizable compound other than the oligomer is a low-molecular-weight polymerizable compound. The low-molecular-weight polymerizable compound may have a chemical form such as a monomer, a dimer, a trimer, or a mixture thereof.

Further, from the viewpoint of the chemical resistance, at least one polymerizable compound selected from the group consisting of a polymerizable compound containing three or more ethylenically unsaturated groups and a polymerizable compound having an isocyanuric ring structure is preferable as the low-molecular-weight polymerizable compound.

In the present disclosure, the low-molecular-weight polymerizable compound indicates a polymerizable compound having a molecular weight (a weight-average molecular weight in a case of having a molecular weight distribution) of 50 or greater and less than 600.

From the viewpoint that the chemical resistance, the UV printing durability, and the property of suppressing on-press development scum are excellent, the molecular weight of the low-molecular-weight polymerizable compound is preferably 100 or greater and less than 600, more preferably 300 or greater and less than 600, and still more preferably 400 or greater and less than 600.

In a case where the polymerizable compound includes a low-molecular-weight polymerizable compound as a polymerizable compound other than the oligomer (the total amount in a case where the polymerizable compound includes two or more kinds of low-molecular-weight polymerizable compounds), from the viewpoints of the chemical resistance, the UV printing durability, and the property of suppressing on-press development scum, the ratio of the oligomer to the low-molecular-weight polymerizable compound (oligomer/low-molecular-weight polymerizable compound) is preferably in a range of 10/1 to 1/10, more preferably in a range of 10/1 to 3/7, and still more preferably in a range of 10/1 to 7/3 on a mass basis.

Examples of the polymerizable compound include unsaturated carboxylic acids (for example, acrylic acid, methacrylic acid, itaconic acid, crotonic acid, isocrotonic acid, and maleic acid), esters thereof, and amides thereof. Among these, esters of unsaturated carboxylic acids and polyhydric alcohol compounds, and amides of unsaturated carboxylic acids and polyhydric amine compounds are preferably used. Further, an addition reaction product of unsaturated carboxylic acid esters having a nucleophilic substituent such as a hydroxy group, an amino group, or a mercapto group or amides with monofunctional or polyfunctional isocyanates or epoxies, and a dehydration condensation reaction product with a monofunctional or polyfunctional carboxylic acid are also suitably used. Further, an addition reaction product of unsaturated carboxylic acid esters having an electrophilic substituent such as an isocyanate group or an epoxy group or amides with monofunctional or polyfunctional alcohols, amines, and thiols, and a substitution reaction product of unsaturated carboxylic acid esters having a releasable substituent such as a halogen atom or a tosyloxy group or amides with monofunctional or polyfunctional alcohols, amines, and thiols are also suitable. As another example, a compound group in which the unsaturated carboxylic acid is substituted with unsaturated phosphonic acid, styrene, vinyl ether, or the like can also be used. These compounds are described in JP2006-508380A, JP2002-287344A, JP2008-256850A, JP2001-342222A, JP1997-179296A (JP-H09-179296A), JP1997-179297A (JP-H09-179297A), JP1997-179298A (JP-H09-179298A), JP2004-294935A, JP2006-243493, JP2002-275129A, JP2003-64130A, JP2003-280187A, and JP1998-333321A (JP-H10-333321A).

Specific examples of the monomer of the ester of a polyhydric alcohol compound and an unsaturated carboxylic acid include acrylic acid ester such as ethylene glycol diacrylate, 1,3-butanediol diacrylate, tetramethylene glycol diacrylate, propylene glycol diacrylate, trimethylolpropane triacrylate, hexanediol diacrylate, tetraethylene glycol diacrylate, pentaerythritol tetraacrylate, sorbitol triacrylate, isocyanuric acid ethylene oxide (EO) modified triacrylate, and a polyester acrylate oligomer. Examples of the methacrylic acid ester include tetramethylene glycol dimethacrylate, neopentyl glycol dimethacrylate, trimethylolpropane trimethacrylate, ethylene glycol dimethacrylate, pentaerythritol trimethacrylate, bis[p-(3-methacryloxy-2-hydroxypropoxy)phenyl]dimethylmethane, and bis[p-(methacryloxyethoxy)phenyl]dimethylmethane. Further, specific examples of the monomer of the amide of a polyvalent amine compound and an unsaturated carboxylic acid include methylene bisacrylamide, methylene bismethacrylamide, 1,6-hexamethylene bisacrylamide, 1,6-hexamethylene bismethacrylamide, diethylenetriamine trisacrylamide, xylylene bisacrylamide, and xylylene bismethacrylamide.

Further, a urethane-based addition-polymerizable compound produced by the addition reaction of an isocyanate and a hydroxy group is also suitable, and specific examples thereof include a vinyl urethane compound containing two or more polymerizable vinyl groups in one molecule, which is obtained by adding a vinyl monomer containing a hydroxy group represented by Formula (M) to a polyisocyanate compound containing two or more isocyanate groups in one molecule described in JP1973-41708B (JP-S48-41708B).

CH₂═C(R^{M4})COOCH₂CH(R^{M5})OH (M)

In Formula (M), R^{M4} and R^{M5} each independently represent a hydrogen atom or a methyl group.

Further, suitable examples of the urethane compound include urethane acrylates described in JP1976-37193A (JP-S51-37193A), JP1990-32293B (JP-H02-32293B), JP1990-16765B (JP-H02-16765B), JP2003-344997A, and JP2006-65210A, urethane compounds having an ethylene oxide skeleton described in JP1983-49860B (JP-S58-49860B), JP1981-17654B (JP-S56-17654B), JP1987-39417B (JP-S62-39417B), JP1987-39418B (JP-S62-39418B), JP2000-250211A, and JP2007-94138A, and urethane compounds containing a hydrophilic group described in U.S. Pat. No. 7,153,632A, JP1996-505958A (JP-H08-505958A), JP2007-293221A, and JP2007-293223A.

Specific examples of the oligomer which is a kind of the polymerizable compound are shown below, but the oligomer used in the present disclosure is not limited thereto.

As the oligomer, a commercially available product may be used, and examples thereof include UA510H, UA-306H, UA-306I, and UA-306T (all manufactured by Kyoeisha Chemical Co., Ltd.), UV-1700B, UV-6300B, and UV7620EA (all manufactured by The Nippon Synthetic Chemical Industry Co., Ltd.), U-15HA (manufactured by SHIN-NAKAMURA CHEMICAL Co., Ltd.), and EBECRYL450, EBECRYL657, EBECRYL885, EBECRYL800, EBECRYL3416, and EBECRYL860 (all manufactured by Daicel-Allnex Ltd.), but the present disclosure is not limited thereto.

The details of the method of using the polymerizable compound such as the structure of the polymerizable compound, whether the polymerizable compound is used alone or in combination, and the amount of addition can be optionally set.

From the viewpoint of the UV printing durability, it is preferable that the image recording layer contains two or more kinds of polymerizable compounds.

The content of the polymerizable compound (the total content of polymerizable compounds in a case where the image recording layer contains two or more kinds of polymerizable compounds) is preferably in a range of 5% by mass to 75% by mass, more preferably in a range of 10% by mass to 70% by mass, still more preferably in a range of 10% by mass to 60% by mass, and particularly preferably in a range of 10% by mass to 40% by mass with respect to the total mass of the image recording layer.

[Hydrophilic Macromolecular Compound]

The image recording layer may contain a hydrophilic macromolecular compound. Examples of the hydrophilic macromolecular compound include a cellulose compound.

Examples of the cellulose compound include cellulose and a compound in which at least a part of cellulose is modified (modified cellulose compound). Among these, a modified cellulose compound is preferable.

Preferred examples of the modified cellulose compound include a compound in which at least a part of the hydroxy group of cellulose is substituted with at least one group selected from the group consisting of an alkyl group and a hydroxyalkyl group.

The degree of substitution of the compound in which at least a part of the hydroxy group of cellulose is substituted with at least one group selected from the group consisting of an alkyl group and a hydroxyalkyl group is preferably in a range of 0.1 to 6.0 and more preferably in a range of 1 to 4.

As the modified cellulose compound, an alkyl cellulose compound or a hydroxyalkyl cellulose compound is preferable, and a hydroxyalkyl cellulose compound is more preferable.

Preferred examples of the alkyl cellulose compound include methyl cellulose.

Preferred examples of the hydroxyalkyl cellulose compound include hydroxypropyl cellulose.

The molecular weight (the weight-average molecular weight in a case of having a molecular weight distribution) of the hydrophilic macromolecular compound is preferably in a range of 3000 to 5000000 and more preferably in a range of 5000 to 200000.

[Other Components]

The image recording layer may contain, as other components, a surfactant, a polymerization inhibitor, a higher fatty acid derivative, a plasticizer, inorganic particles, an inorganic layered compound, and the like. Specifically, as the other components, the description in paragraphs 0114 to 0159 of JP2008-284817A can be referred to.

[Formation of Image Recording Layer]

The image recording layer of the lithographic printing plate precursor used in the present disclosure can be formed by dispersing or dissolving each of the above-described required components in a known solvent to prepare a coating solution, coating a support with the coating solution using a known method such as a bar coater coating method, and drying the coating solution, as described in paragraphs 0142 and 0143 of JP2008-195018A.

As the solvent, a known solvent can be used. Specific examples thereof include water, acetone, methyl ethyl ketone (2-butanone), cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 1-methoxy-2-propanol, 3-methoxy-1-propanol, methoxy methoxy ethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethylsulfoxide, γ-butyrolactone, methyl lactate, and ethyl lactate.

The solvent may be used alone or in combination of two or more kinds thereof. The concentration of solid contents in the coating solution is preferably in a range of 1% by mass to 50% by mass.

The coating amount (solid content) of the image recording layer after the coating and the drying varies depending on the applications thereof, but from the viewpoints of satisfactory sensitivity and satisfactory film-coating characteristics of the image recording layer, the coating amount thereof is preferably in a range of 0.3 g/m² to 3.0 g/m².

<Undercoat Layer>

It is preferable that the lithographic printing plate precursor used in the present disclosure includes an undercoat layer (also referred to as an interlayer) between the image recording layer and the support. Since adhesion of the support to the image recording layer is stronger in an exposed portion and the image recording layer is easily peeled off from the support in an unexposed portion, the undercoat layer contributes to improvement of the developability without degrading the printing durability. Further, in a case of infrared laser exposure, since the undercoat layer functions as a heat insulating layer, the undercoat layer also has an effect of preventing heat generated by exposure from being diffused in the support, and thus the sensitivity is not degraded.

Examples of the compound used for the undercoat layer include a polymer containing an adsorptive group which can be adsorbed on the surface of the support and a hydrophilic group. A polymer which contains an adsorptive group and a hydrophilic group for the purpose of improving the adhesiveness to the image recording layer and further contains a crosslinkable group is preferable. The compound used for the undercoat layer may be a low-molecular-weight compound or a polymer. The compound used for the undercoat layer may be used in the form of a mixture of two or more kinds thereof as necessary.

In a case where the compound used for the undercoat layer is a polymer, a copolymer of a monomer containing an adsorptive group, a monomer containing a hydrophilic group, and a monomer containing a crosslinkable group is preferable.

Preferred examples of the adsorptive group that can be adsorbed on the surface of the support include a phenolic hydroxy group, a carboxy group, —PO₃H₂, —OPO₃H₂, —CONHSO₂—, —SO₂NHSO₂—, and —COCH₂COCH₃. As the hydrophilic group, a sulfo group or a salt thereof, or a salt of a carboxy group is preferable. As the crosslinkable group, an acrylic group, a methacrylic group, an acrylamide group, a methacrylamide group, or an allyl group is preferable.

The polymer may contain a crosslinkable group introduced by forming salts between a polar substituent of the polymer and a compound that has a substituent having the opposite charge to the polar substituent and an ethylenically unsaturated bond or may be formed by further copolymerization of monomers other than the monomers described above and preferably hydrophilic monomers.

Specifically, a silane coupling agent having an ethylenic double bond reactive group, which can be addition-polymerized, described in JP1998-282679A (JP-H10-282679A); and a phosphorous compound having an ethylenic double bond reactive group described in JP1990-304441A (JP-H02-304441A) are suitably exemplified. Further, crosslinkable groups (preferably ethylenically unsaturated bond groups) described in JP2005-238816A, JP2005-125749A, JP2006-239867A, and JP2006-215263A, and low-molecular-weight or high-molecular-weight compounds containing functional groups and hydrophilic groups that interact with the surface of a support are preferably used.

More preferred examples thereof include high-molecular-weight polymers containing adsorptive groups which can be adsorbed on the surface of a support, hydrophilic groups, and crosslinkable groups described in JP2005-125749A and JP2006-188038A.

The content of the ethylenically unsaturated bond group in the polymer used for the undercoat layer is preferably in a range of 0.1 mmol to 10.0 mmol and more preferably in a range of 0.2 mmol to 5.5 mmol with respect to 1 g of the polymer.

The weight-average molecular weight (Mw) of the polymer used for the undercoat layer is preferably 5000 or greater and more preferably in a range of 10000 to 300000.

[Hydrophilic Compound]

From the viewpoint of the developability, it is preferable that the undercoat layer contains a hydrophilic compound.

The hydrophilic compound is not particularly limited, and a known hydrophilic compound used for the undercoat layer can be used.

Preferred examples of the hydrophilic compound include phosphonic acids containing an amino group such as carboxymethyl cellulose and dextrin, organic phosphonic acids, organic phosphoric acids, organic phosphinic acids, amino acids, and hydrochlorides of amines containing a hydroxy group.

Preferred examples of the hydrophilic compound include a compound containing an amino group or a functional group having polymerization inhibiting ability and a group interacting with the surface of a support (for example, 1,4-diazabicyclo[2.2.2]octane (DABCO), 2,3,5,6-tetrahydroxy-p-quinone, chloranil, sulfophthalic acid, ethylenediaminetetraacetic acid (EDTA) or a salt thereof, hydroxyethyl ethylenediamine triacetic acid or a salt thereof, dihydroxyethyl ethylenediamine diacetic acid or a salt thereof, or hydroxyethyl imino diacetic acid or a salt thereof).

From the viewpoint of the property of suppressing scratches and stains, it is preferable that the image recording layer contains hydroxycarboxylic acid or a salt thereof as the hydrophilic compound.

Further, from the viewpoint of the property of suppressing scratches and stains, it is preferable that the hydrophilic compound (preferably hydroxycarboxylic acid or a salt thereof) is contained not only in the undercoat layer but also in the layer on the aluminum support. The layer on the aluminum support is preferably a layer on a side where the image recording layer is formed and preferably a layer in contact with the aluminum support.

As the layer on the aluminum support, an undercoat layer or an image recording layer is preferable as the layer in contact with the aluminum support. Further, a layer other than the layer in contact with the aluminum support, for example, the protective layer or the image recording layer may contain a hydrophilic compound and preferably hydroxycarboxylic acid or a salt thereof.

In the lithographic printing plate precursor used in the present disclosure, it is preferable that the image recording layer contains hydroxycarboxylic acid or a salt thereof from the viewpoint of the property of suppressing scratches and stains.

Further, in the lithographic printing plate precursor used in the present disclosure, an aspect in which the surface of the aluminum support on the side of the image recording layer is subjected to a surface treatment with a composition containing at least hydroxycarboxylic acid or a salt thereof (for example, an aqueous solution) is also preferable. In a case of the above-described aspect, at least a part of the treated hydroxycarboxylic acid or the salt thereof is detected in a state of being contained in a layer on the side of the image recording layer (for example, the image recording layer or the undercoat layer) in contact with the aluminum support.

By allowing the layer on the side of the image recording layer in contact with the aluminum support such as the undercoat layer to contain hydroxycarboxylic acid or a salt thereof, the surface of the aluminum support on the side of the image recording layer can be made hydrophilic, the contact angle with water on the surface of the aluminum support on the side of the image recording layer by the aerial water droplet method can be easily set to 110° or less, and thus the property of suppressing scratches and stains is excellent.

The hydroxycarboxylic acid is a general term for organic compounds containing one or more carboxy groups and one or more hydroxy groups in one molecule and is also referred to as hydroxy acid, oxy acid, oxycarboxylic acid, or alcoholic acid (see Iwanami Physics and Chemistry Dictionary, 5th Edition, published by Iwanami Shoten Co., Ltd. (1998)).

It is preferable that the hydroxycarboxylic acid or a salt thereof is represented by Formula (HC).

R^{HC}(OH)_{mhc}(COOMHC)_{nhc} Formula (HC)

In Formula (HC), R^{HC} represents an (mhc+nhc)-valent organic group, M^{HC}'s each independently represent a hydrogen atom, an alkali metal, or an onium, mhc and nhc each independently represent an integer of 1 or greater, and in a case where n represents 2 or greater, M's may be the same as or different from each other.

In Formula (HC), examples of the (mhc+nhc)-valent organic group represented by R^{HC} include a (mhc+nhc)-valent hydrocarbon group. The hydrocarbon group may have a substituent and/or a linking group.

Examples of the hydrocarbon group include an (mhc+nhc)-valent group derived from an aliphatic hydrocarbon, such as an alkylene group, an alkanetriyl group, an alkanetetrayl group, an alkanepentayl group, an alkenylene group, an alkenetriyl group, an alkenetetrayl group, an alkenepentayl group, an alkynylene group, an alkyntriyl group, an alkyntetrayl group, or alkynpentayl group, and an (mhc+nhc)-valent group derived from an aromatic hydrocarbon, such as an arylene group, an arylenetriyl group, an arylenetetrayl group, and an arylenepentayl group. Examples of the substituent other than the hydroxyl group and the carboxyl group include an alkyl group, an alkenyl group, an alkynyl group, an aralkyl group, and an aryl group. Specific examples of the substituent include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclohexyl group, a cyclopentyl group, a 2-norbomyl group, a methoxymethyl group, a methoxyethoxyethyl group, an allyloxymethyl group, a phenoxymethyl group, an acetyloxymethyl group, a benzoyloxymethyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group, a 3-butynyl group, a phenyl group, a biphenyl group, a naphthyl group, a tolyl group, a xylyl group, a mesityl group, a cumenyl group, a methoxyphenyl group, an ethoxyphenyl group, a phenoxyphenyl group, an acetoxyphenyl group, a benzoyloxyphenyl group, a methoxycarbonylphenyl group, an ethoxycarbonylphenyl group, and a phenoxycarbonylphenyl group. The linking group is composed of at least one atom selected from the group consisting of a hydrogen atom, a carbon atom, an oxygen atom, a nitrogen atom, a sulfur atom, and a halogen atom, and the number of atoms thereof is preferably in a range of 1 to 50. Specific examples thereof include an alkylene group, a substituted alkylene group, an arylene group, and a substituted arylene group, and the linking group may have a structure in which a plurality of these divalent groups are linked to each other via any of an amide bond, an ether bond, a urethane bond, a urea bond, or an ester bond.

Examples of the alkali metal represented by M^{HC} include lithium, sodium, and potassium, and sodium is particularly preferable. Examples of onium include ammonium, phosphonium, and sulfonium. Among these, ammonium is particularly preferable.

Further, from the viewpoint of the property of suppressing scratches and stains, MHC represents preferably an alkali metal or an onium and more preferably an alkali metal.

The total number of mhc's and nhc's is preferably 3 or more, more preferably in a range of 3 to 8, and still more preferably in a range of 4 to 6.

The hydroxycarboxylic acid or a salt thereof has a molecular weight of preferably 600 or less, more preferably 500 or less, and particularly preferably 300 or less. Further, the molecular weight thereof is preferably 76 or greater.

Specific examples of the hydroxycarboxylic acid or hydroxycarboxylic acid constituting the salt of the hydroxycarboxylic acid include gluconic acid, glycolic acid, lactic acid, tartronic acid, hydroxybutyric acid (2-hydroxybutyric acid, 3-hydroxybutyric acid, or γ-hydroxybutyric acid), malic acid, tartaric acid, citramalic acid, citric acid, isocitric acid, leucic acid, mevalonic acid, pantoic acid, ricinoleic acid, ricinelaidic acid, cerebronic acid, quinic acid, shikimic acid, a monohydroxybenzoic acid derivative (salicylic acid, cleosortic acid (homosalicylic acid, hydroxy (methyl)benzoic acid), vanillic acid, or syringic acid), a dihydroxybenzoic acid derivative (pyrocatechuic acid, resorcylic acid, protocatechuic acid, gentisic acid, or orsellinic acid), a trihydroxybenzoic acid derivative (galvanic acid), a phenylacetic acid derivative (mandelic acid, benzilic acid, or atrolactic acid), a hydrosilicic acid derivative (melilotic acid, phloretic acid, coumaric acid, umbellic acid, caffeic acid, ferulic acid, sinapinic acid, cerebronic acid, or carminic acid).

Among these, as the hydroxycarboxylic acid or the hydroxycarboxylic acid constituting the salt of the hydroxycarboxylic acid, from the viewpoint of the property of suppressing scratches and stains, a compound having two or more hydroxy groups is preferable, a compound having 3 or more hydroxy groups is more preferable, a compound having 5 or more hydroxy groups is still more preferable, and a compound having 5 to 8 hydroxy groups is particularly preferable.

Further, gluconic acid or shikimic acid is preferable as those having one carboxy group and two or more hydroxy groups.

Citric acid or malic acid is preferable as those having two or more carboxy groups and one hydroxy group.

Tartaric acid is preferable as those having two or more carboxy groups and two or more hydroxy groups.

Among these, gluconic acid is particularly preferable as the hydroxycarboxylic acid.

The hydrophilic compound may be used alone or in combination of two or more kinds thereof.

In a case where the undercoat layer contains a hydrophilic compound, preferably hydroxycarboxylic acid or a salt thereof, the content of the hydrophilic compound, preferably hydroxycarboxylic acid or a salt thereof, is preferably in a range of 1% by mass to 50% by mass, more preferably in a range of 5% by mass to 40% by mass, more preferably in a range of 8% by mass to 30% by mass, and particularly preferably in a range of 10% by mass to 30% by mass with respect to the total mass of the undercoat layer.

In addition to the compound for the undercoat layer, the undercoat layer may contain a chelating agent, a secondary or tertiary amine, a polymerization inhibitor, and the like in order to prevent stains over time.

The undercoat layer is applied according to a known method. The coating amount (solid content) of the undercoat layer is preferably in a range of 0.1 mg/m² to 100 mg/m² and more preferably in a range of 1 mg/m² to 30 mg/m².

<Protective Layer>

The lithographic printing plate precursor used in the present disclosure may have a protective layer (also referred to as an overcoat layer) on the image recording layer. The protective layer has a function of suppressing a reaction of inhibiting image formation through oxygen blocking, a function of preventing generation of damage to the image recording layer, and a function of preventing ablation in a case of exposure to a high illuminance laser.

Such a protective layer having the above-described characteristics is described in U.S. Pat. No. 3,458,311A and JP1980-49729B (JP-S55-49729B). As a polymer with low oxygen permeability which is used for a protective layer, any of a water-soluble polymer and a water-insoluble polymer is appropriately selected and then used and two or more kinds thereof can be used in the form of a mixture as necessary. Specific examples thereof include polyvinyl alcohol, modified polyvinyl alcohol, polyvinylpyrrolidone, a water-soluble cellulose derivative, and poly(meth)acrylonitrile.

As the modified polyvinyl alcohol, acid-modified polyvinyl alcohol containing a carboxy group or a sulfo group is preferably used. Specific examples thereof include modified polyvinyl alcohol described in JP2005-250216A and JP2006-259137A.

It is preferable that the protective layer contains an inorganic layered compound in order to improve the oxygen-blocking property. The inorganic layered compound indicates a particle having a thin tabular shape, and examples thereof include a mica group such as natural mica and synthetic mica, talc represented by Formula: 3MgO.4SiO.H₂O, teniolite, montmorillonite, saponite, hectorite, and zirconium phosphate.

An inorganic layered compound which has been preferably used is a mica compound. Examples of the mica compound include a mica group such as synthetic mica and natural mica represented by Formula: A(B,C)₂₋₅D₄O₁₀(OH,F,O)₂ [here, A represents any of K, Na, or Ca, B and C represent any of Fe (II), Fe (III), Mn, Al, Mg, or V, and D represents Si or Al].

In the mica group, examples of the natural mica include muscovite, soda mica, phlogopite, biotite, and lepidolite. Examples of the synthetic mica include non-swellable mica such as fluorophlogopite KMg₃(AlSi₃O₁₀)F₂ or potassium tetrasilicic mica KMg_{2.5}(Si₄O₁₀)F₂; and swellable mica such as Na tetrasilicic mica NaMg_{2.5}(Si₄O₁₀)F₂, Na or Li teniolite (Na,Li)Mg₂Li(Si₄O₁₀)F₂, or montmorillonite-based Na or Li hectorite (Na,Li)_{1/8}Mg_{2/5}Li_{1/8}(Si₄O₁₀)F₂. Further, synthetic smectite is also useful.

Among the above-described mica compounds, fluorine-based swellable mica is particularly useful. In other words, swellable synthetic mica has a laminated structure formed of unit crystal lattice layers having a thickness of 10 Å to 15 Å (1 Å=0.1 nm), and substitution of metal atoms in the lattice is significantly larger than that in other clay minerals. As the result, the lattice layers causes shortage of a positive charge. In order to compensate for this, cations such as Li⁺, Na⁺, Ca²⁺, and Mg²⁺ are adsorbed between layers. Cations interposed between layers are referred to as exchangeable cations and can be exchanged for various cations. Particularly, in a case where interlayer cations are Li⁺ and Na⁺, since the ion radii thereof is small, bonds between layered crystal lattices are weak and largely swollen due to water. In a case where shearing is applied in this state, cleavage easily occurs so that a sol stabilized in water is formed. The swellable synthetic mica has such a strong tendency and is particularly preferably used.

As the shape of the mica compound, from the viewpoint of controlling diffusion, it is preferable that the thickness thereof is as small as possible and the plane size thereof is as large as possible within a range where the smoothness of the coating surface or the permeability of actinic rays is not inhibited. Therefore, the aspect ratio thereof is preferably 20 or greater, more preferably 100 or greater, and particularly preferably 200 or greater. The aspect ratio is a ratio of the major diameter to the thickness of a particle and can be measured using, for example, a projection drawing obtained from a micrograph of particles. The effects to be obtained increase as the aspect ratio increases.

In the particle diameter of the mica compound, the average major diameter thereof is preferably in a range of 0.3 μm to 20 μm, more preferably in a range of 0.5 μm to 10 μm, and particularly preferably in a range of 1 μm to 5 μm. The average thickness of the particles is preferably 0.1 μm or less, more preferably 0.05 μm or less, and particularly preferably 0.01 μm or less. Specifically, for example, as a preferable embodiment of swellable synthetic mica which is a representative compound, the thickness thereof is in a range of 1 nm to 50 nm and the surface size (major diameter) is in a range of 1 μm to 20 μm.

The content of the inorganic layered compound is preferably in a range of 1% by mass to 60% by mass and more preferably in a range of 3% by mass to 50% by mass with respect to the total solid content of the protective layer. In a case where a plurality of kinds of inorganic layered compounds are used in combination, it is preferable that the total amount of the inorganic layered compounds is the content described above. In a case where the content thereof is in the above-described range, the oxygen-blocking property is improved and satisfactory sensitivity is obtained. Further, degradation of the impressing property can be prevented.

The protective layer may contain known additives such as a plasticizer for imparting flexibility, a surfactant for improving the coating properties, and inorganic particles for controlling the slipperiness of the surface. Further, the protective layer may contain an oil sensitizing agent described in the section of the image recording layer.

The protective layer is coated according to a known method. The coating amount (solid content) of the protective layer is preferably in a range of 0.01 g/m² to 10 g/m², more preferably in a range of 0.02 g/m² to 3 g/m², and particularly preferably in a range of 0.02 g/m² to 1 g/m².

### EXAMPLES

Hereinafter, the present disclosure will be described in detail with reference to examples, but the present disclosure is not limited thereto. In the present examples, “%” and “part” respectively indicate “% by mass” and “part by mass” unless otherwise specified. Further, in a polymer compound, the molecular weight indicates the weight-average molecular weight (Mw) and the proportion of repeating constitutional units indicates mole percentage unless otherwise specified. Further, the weight-average molecular weight (Mw) is a value in terms of polystyrene obtained by performing measurement using gel permeation chromatography (GPC). Further, the average particle diameter indicates a volume average particle diameter unless otherwise specified.

In the examples, the HOMO and LUMO of the infrared absorbing agent, the LUMO of the electron-accepting polymerization initiator, the HOMO of the electron-donating polymerization initiator, the average diameter of micropores, the specific surface area ΔS, the molar absorption coefficient c and the maximum absorption wavelength at the maximum absorption wavelength were respectively measured by the above-described methods.

(1) Preparation of Support: Surface Treatment: Mechanical Roughening Treatment, Anodization Treatment: Sulfuric Acid

<<Mechanical Roughening Treatment (Brush Grain Method: MGV)>>

Specifically, while supplying a suspension of a pumice (a specific gravity of 1.1 g/cm³) to the surface of the aluminum plate as a polishing slurry liquid, a mechanical roughening treatment was performed using rotating bundle bristle brushes, and the surface of the aluminum plate was grained. In the mechanical roughening treatment, the median diameter (pin) of the polishing material was set to 30 μm, the number of brushes was set to 4, and the number of times of revolutions per minute of the brush (rpm: revolutions per minute) was set to 250 rpm. The material of the bundle bristle brushes was nylon 6.10, the diameter of the brush bristles was 0.3 mm, and the bristle length was 50 mm. The brushes were produced by implanting bristles densely into the holes in a stainless steel cylinder having a diameter of 300 mm. The distance between two support rollers (a diameter of 200 mm) of the lower portion of the bundle bristle brush was 300 mm. The bundle bristle brushes were pressed until the load of a driving motor for rotating the brushes became 10 kW plus with respect to the load before the bundle bristle brushes were pressed against the aluminum plate. The rotation direction of the brushes was the same as the moving direction of the aluminum plate.

<<Alkali Etching Treatment>>

The aluminum plate obtained in the above-described manner was subjected to an etching treatment by spraying a caustic soda aqueous solution having a caustic soda concentration of of 26% by mass and an aluminum ion concentration of 6.5% by mass using a spray at a temperature of 70° C. Thereafter, the aluminum plate was washed with water using a spray. The amount of aluminum dissolved was 6 g/m².

<<Desmutting Treatment Using Acidic Aqueous Solution>>

Next, a desmutting treatment was performed using a nitric acid aqueous solution. Specifically, the desmutting treatment was performed by spraying the nitric acid aqueous solution to the aluminum plate for 3 seconds using a spray. As the nitric acid aqueous solution used for the desmutting treatment, a waste liquid of nitric acid used for the subsequent electrochemical roughening treatment step was used. The liquid temperature was 35° C.

<<Electrochemical Roughening Treatment>>

An electrochemical roughening treatment was continuously performed using an AC voltage of 60 Hz in nitric acid electrolysis. As an electrolytic solution at this time, an electrolytic solution which had been adjusted to have a concentration of aluminum ions of 4.5 g/L by adding aluminum nitrate to a nitric acid aqueous solution having a concentration of 10.4 g/L at a liquid temperature of 35° C. was used. The AC power source waveform is a waveform illustrated in FIG. 3. Further, using a trapezoidal rectangular waveform AC having a time tp, until the current value reached a peak from zero, of 0.8 msec and a duty ratio of 1:1, the electrochemical roughening treatment was performed using a carbon electrode as a counter electrode. As an auxiliary anode, ferrite was used. An electrolytic cell illustrated in FIG. 4 was used as the electrolytic cell. The current density was 30 A/dm² in terms of the peak current value, and 5% of the current from the power source was separately flowed to the auxiliary anode. The electric quantity (C/dm²) was 185 C/dm² as the total electric quantity during the anodization of the aluminum plate. Thereafter, the aluminum plate was washed with water using a spray.

<<Alkali Etching Treatment>>

The aluminum plate obtained in the above-described manner was subjected to an etching treatment by spraying a caustic soda aqueous solution having a caustic soda concentration of 27% by mass and an aluminum ion concentration of 2.5% by mass using a spray at a liquid temperature listed in Table 1 or Table 2. Thereafter, the aluminum plate was washed with water using a spray.

The etching amount of the aluminum on the surface subjected to the roughening treatment can be controlled by changing the temperature of the alkali etching treatment, and thus ΔS can be adjusted.

<<Desmutting Treatment Using Acidic Aqueous Solution>>

Next, a desmutting treatment was performed using a sulfuric acid aqueous solution. Specifically, the desmutting treatment was performed by spraying the sulfuric acid aqueous solution to the aluminum plate for 3 seconds using a spray. As the sulfuric acid aqueous solution used for the desmutting treatment, an aqueous solution having a sulfuric acid concentration of 170 g/L and an aluminum ion concentration of 5 g/L was used. The liquid temperature was 30° C.

<<Electrochemical Roughening Treatment>>

An electrochemical roughening treatment was continuously performed using an AC voltage of 60 Hz in hydrochloric acid electrolysis. As an electrolytic solution, an electrolytic solution which had been adjusted to have an aluminum ion concentration of 4.5 g/L by adding aluminum chloride to an aqueous solution having 6.2 g/L of hydrochloric acid at a liquid temperature of 35° C. was used. The AC power source waveform is a waveform illustrated in FIG. 3. Further, using a trapezoidal rectangular waveform AC having a time tp, until the current value reached a peak from zero, of 0.8 msec and a duty ratio of 1:1, the electrochemical roughening treatment was performed using a carbon electrode as a counter electrode. As an auxiliary anode, ferrite was used. An electrolytic cell illustrated in FIG. 4 was used as the electrolytic cell. The current density was 25 A/dm² in terms of the peak current value, and the electric quantity (C/dm²) in the hydrochloric acid electrolysis was 63 C/dm² as the total electric quantity during the anodization of the aluminum plate. Thereafter, the aluminum plate was washed with water using a spray.

<<Alkali Etching Treatment>>

The aluminum plate obtained in the above-described manner was subjected to an etching treatment by spraying a caustic soda aqueous solution having a caustic soda concentration of 5% by mass and an aluminum ion concentration of 0.5% by mass using a spray at a temperature of 60° C. Thereafter, the aluminum plate was washed with water using a spray.

<<Desmutting Treatment Using Acidic Aqueous Solution>>

Next, a desmutting treatment was performed using a sulfuric acid aqueous solution. Specifically, the desmutting treatment was performed by spraying the sulfuric acid aqueous solution to the aluminum plate for 3 seconds using a spray. As the sulfuric acid aqueous solution used for the desmutting treatment, specifically, a waste liquid generated in the anodization treatment step (an aqueous solution having a sulfuric acid concentration of 170 g/L and an aluminum ion concentration of 5 g/L) was used. The liquid temperature was 35° C.

<<First Stage Anodization Treatment>>

An anodized film having a predetermined coating amount was formed by performing a first stage anodization treatment with an anodization device using direct current electrolysis.

<<Pore Widening Treatment>>

The aluminum plate after being subjected to the anodization treatment was subjected to a pore widening treatment by being immersed in a caustic soda aqueous solution having a caustic soda concentration of 5% by mass and an aluminum ion concentration of 0.5% by mass at a temperature of 40° C. Thereafter, the aluminum plate was washed with water using a spray.

<<Second Stage Anodization Treatment>>

An anodized film having a predetermined coating amount was formed by performing a second stage anodization treatment with an anodization device using direct current electrolysis.

The average diameter (nm) of large-diameter pores in the surface of the anodized film in the anodized film having micropores after the second anodization treatment step which was obtained above, the average diameter (nm) of small-diameter pores at the communication positions, the depths (nm) of the large-diameter pores and the small-diameter pores, and the pit densities (density of micropore, unit; number of pores/μm²) are collectively listed in Tables 1 and 2.

Further, the average diameter of micropores (the average diameter of the large-diameter pores and the small-diameter pores) is a value obtained by observing 4 sheets (N=4) of the surfaces of the large-diameter pores and the surfaces of the small-diameter pores using a FE-SEM at a magnification of 150000, measuring the diameters of micropores (the large-diameter pores and the small-diameter pores) present in a range of 400 nm×600 nm in the obtained four sheets of images, and averaging the values. Further, in a case where the depth of the large-diameter pores is deep and the diameter of the small-diameter pores is unlikely to be measured and in a case where expanded-diameter pores in the small-diameter pores are measured, the upper portion of the anodized film is cut and then various kinds of diameters are acquired.

Further, the depth of the micropores (the depth of the large-diameter pores and the small-diameter pores) is a value obtained by observing the cross section of the support (anodized film) using a FE-SEM (at a magnification of 150000 in observation of the depth of the large-diameter pores and at a magnification of 50000 in observation of the depth of the small-diameter pores), measuring 25 cases of depths of optional micropores in the obtained image, and averaging the values.

(2) Preparation of Support: Surface Treatment: Hydrochloric Acid EG, Anodization Treatment: Sulfuric Acid

<<Alkali Etching Treatment>>

The aluminum plate was subjected to an etching treatment by spraying a caustic soda aqueous solution having a caustic soda concentration of 26% by mass and an aluminum ion concentration of 6.5% by mass, to the aluminum plate using a spray at a temperature of 70° C., and the surface of the aluminum plate was grained. Thereafter, the aluminum plate was washed with water using a spray. The amount of aluminum dissolved in the surface to be subsequently subjected to an electrochemical roughening treatment was 5 g/m².

<<Desmutting Treatment Using Acidic Aqueous Solution>>

Next, a desmutting treatment was performed using an acidic aqueous solution. Specifically, the desmutting treatment was performed by spraying the acidic aqueous solution to the aluminum plate for 3 seconds using a spray. As the acidic aqueous solution used for the desmutting treatment, an aqueous solution containing 150 g/L of sulfuric acid was used. The liquid temperature was 30° C.

<<Electrochemical Roughening Treatment (Hydrochloric Acid EG)>>

Next, an electrochemical roughening treatment was performed using an alternating current and a hydrochloric acid electrolytic solution. The hydrochloric acid concentration was set to 13 g/L, the aluminum concentration was set to 15 g/L, and the sulfuric acid concentration was set to 1 g/L, and the aluminum ion concentration was adjusted by adding aluminum chloride. The alternating current waveform was a sine wave with symmetrical positive and negative waveforms, the frequency was set to 50 Hz, the ratio between the anodic reaction time and the cathodic reaction time in one alternating current cycle was set to 1:1, and a carbon electrode was used for the counter electrode of the aluminum plate. Thereafter, a water washing treatment was performed.

<<Alkali Etching Treatment>>

The aluminum plate after being subjected to the electrochemical roughening treatment was subjected to an etching treatment by spraying a caustic soda aqueous solution having a caustic soda concentration of 5% by mass and an aluminum ion concentration of 0.5% by mass using a spray at the liquid temperature of listed in Table 1 or Table 2. By changing the temperature of the etching treatment, the etching amount of aluminum on the surface subjected to the electrochemical roughening treatment was controlled. Thereafter, a water washing treatment was performed.

In addition, the etching amount of aluminum after the electrochemical roughening treatment using hydrochloric acid can be adjusted by ΔS.

<<Desmutting Treatment Using Acidic Aqueous Solution>>

Next, a desmutting treatment was performed using an acidic aqueous solution. Specifically, the desmutting treatment was performed by spraying the acidic aqueous solution to the aluminum plate for 3 seconds using a spray. As the acidic aqueous solution used for the desmutting treatment, an aqueous solution having a sulfuric acid concentration of 170 g/L and an aluminum ion concentration of 5 g/L was used. The liquid temperature was 35° C.

<<First Stage Anodization Treatment (AD Treatment)>>

An anodized film having a predetermined coating amount was formed by performing a first stage anodization treatment with an anodization device using direct current electrolysis.

<<Pore Widening Treatment>>

The aluminum plate after being subjected to the anodization treatment was subjected to a pore widening treatment by being immersed in a caustic soda aqueous solution having a caustic soda concentration of 5% by mass and an aluminum ion concentration of 0.5% by mass at a temperature of 40° C. Thereafter, the aluminum plate was washed with water using a spray.

<<Second Stage Anodization Treatment>>

An anodized film having a predetermined coating amount was formed by performing a second stage anodization treatment with an anodization device using direct current electrolysis.

(3) Preparation of Support: Surface Treatment: Hydrochloric Acid EG, Anodization Treatment: Sulfuric Acid

A support was prepared under the same conditions as described above except that the liquid temperature of the alkaline aqueous solution used for the alkali etching treatment after the electrochemical roughening treatment was changed to the liquid temperature listed in Table 1 or Table 2, and the electrolytic solution used in the first stage and second stage anodization treatments was changed to phosphoric acid in the method of preparing the support (2).

The details of each support obtained as described above are listed in Tables 1 and 2.

### Example 1 to 17 and Comparative Examples 1 to 4

<Formation of Lithographic Printing Plate Precursor (Preparing Step)>

The support (printing surface side) listed in Table 1 or Table 2 was coated with a coating solution for an undercoat layer having the following composition such that the dry coating amount was set to 87 mg/m², thereby forming an undercoat layer.

The undercoat layer was bar-coated with the following image recording layer coating solution and dried in an oven at 120° for 40 seconds to form an image recording layer having a dry coating amount of 0.971 g/m², thereby obtaining a lithographic printing plate precursor.

The image recording layer coating solution containing the polymer particles (microgels) was prepared by mixing a photosensitive liquid obtained by mixing components other than the following microgel solution with the following microgel solution immediately before coating and stirring the mixture.

<Coating Solution for Undercoat Layer>
Compound (P-1) for undercoat layer: 0.1370 parts
Sodium gluconate: 0.0700 parts
Surfactant (EMALEX 710, manufactured by Nihon Emulsion Co., Ltd.): 0.00159 parts
Preservative (BIOHOPE L, manufactured by KI Chemical Industry Co., Ltd.): 0.00149 parts
Water: 3.29000 parts

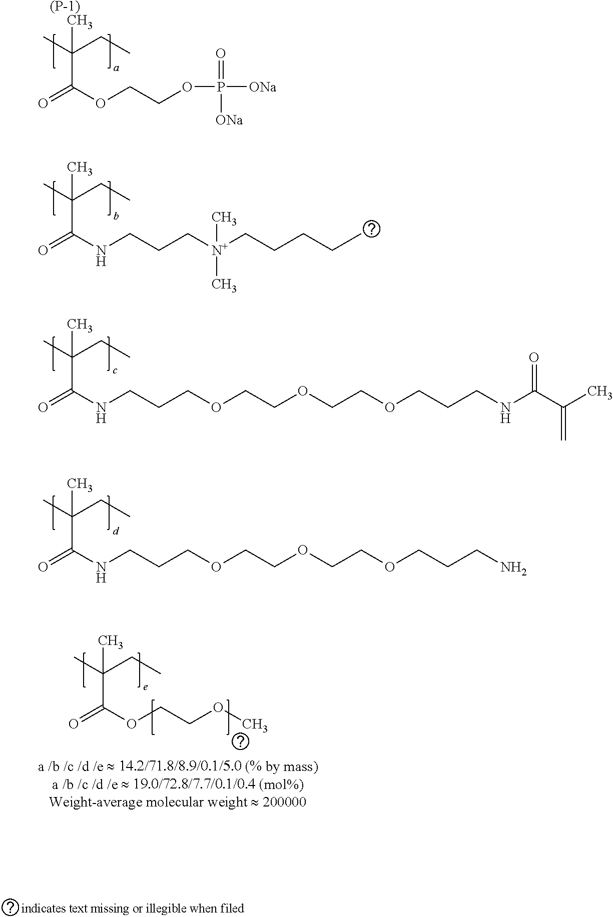

<Image Recording Layer Coating Solution>
IR-1 (infrared absorbing agent, compound shown below): 0.01970 parts
Acid color developing agent listed in Table 1 or Table 2: 0.02000 parts
IA-1 (acid generator (electron-accepting polymerization initiator), compound shown below): 0.11000 parts
Electron-donating polymerization initiator (borate compound, sodium tetraphenyl borate (TPB, HOMO=−5.90 eV): 0.02500 parts
Polymerizable compound (urethane acrylate oligomer UA-515H, manufactured by Kyoeisha Chemical Co., Ltd.): 0.24200 parts
Anionic surfactant (A-1, compound shown below): 0.02600 parts
Fluorine-based surfactant (W-1, compound shown below): 0.00416 parts
2-Butanone: 4.92 parts
1-Methoxy-2-propanol: 3.10 parts
Methanol: 2.79 parts
Microgel solution (microgel solution prepared by the following method): 2.32 parts

[Acid Generator (Electron-Accepting Polymerization Initiator)]

IA-1: compound having structure shown below, LUMO=−3.02 eV

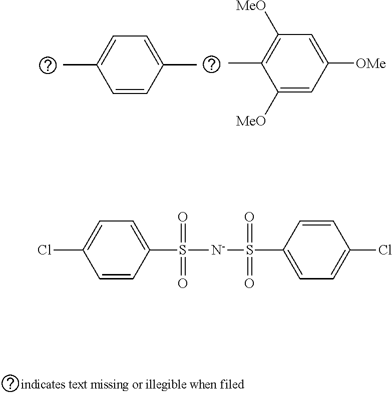

[Infrared Absorbing Agent]

IR-1: compound having the following structure, HOMO=−5.35 eV, LUMO=−3.73 eV, here, Ph represents a phenyl group

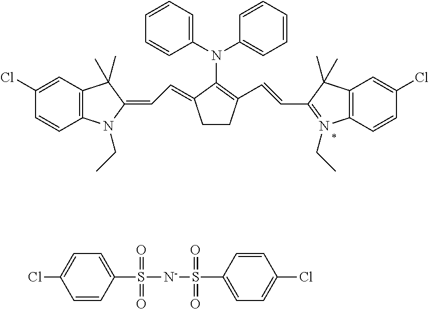

[Surfactant]

Anionic surfactant (A-1): compound shown below

Fluorine-based surfactant (W-1): compound shown below

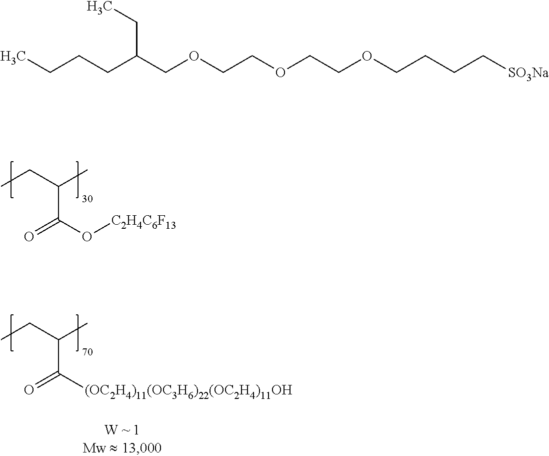

<Preparation of Microgel Solution>
Microgel (polymer particles): 2.640 parts
Distilled water: 2.425 parts

A method of preparing the microgels used in the microgel solution is described below.

—Preparation of Polyvalent Isocyanate Compound (1)—

0.043 parts of bismuth tris(2-ethylhexanoate) (NEOSTANN U-600 (manufactured by NITTO KΔSEI CO., LTD.)) was added to an ethyl acetate (25.31 parts) suspension solution of 17.78 parts (80 molar equivalents) of isophorone diisocyanate and 7.35 parts (20 molar equivalents) of the following polyhydric phenol compound (1), and the resulting solution was stirred. The reaction temperature was set to 50° in a case of heat generation being subsided, and the solution was stirred for 3 hours, thereby obtaining an ethyl acetate (50% by mass) solution of a polyvalent isocyanate compound (1).

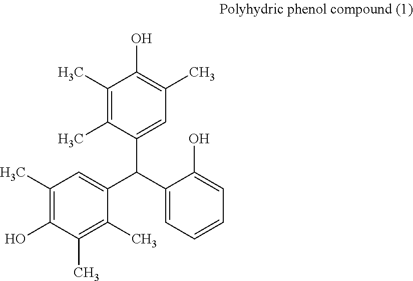 [SMILES: Cc1cc(C(c2ccccc2O)c2cc(C)c(O)c(C)c2C)c(C)c(C)c1O]

—Preparation of Microgels—

The oil phase components and the water phase components were mixed with each other and emulsified at 12000 rpm for 10 minutes using a homogenizer. The obtained emulsion was stirred at 45° C. for 4 hours, 5.20 g of a 10 mass % aqueous solution of 1,8-diazabicyclo[5.4.0]undeca-7-ene-octylate (U-CAT SA102, manufactured by San-Apro Ltd.) was added thereto, and the solution was stirred at room temperature for 30 minutes and allowed to stand at 45° C. for 24 hours. The concentration of solid contents was adjusted to 20% by mass using distilled water, thereby obtaining an aqueous dispersion liquid of the microgels (polymer particles). The average particle diameter thereof was measured by the light scattering method, and the value was 0.28 μm.

˜Oil Phase Component˜

(Component 1) ethyl acetate: 12.0 parts

(Component 2) adduct (50 mass % ethyl acetate solution, manufactured by Mitsui Chemicals, Inc.) obtained by adding trimethylolpropane (6 molar equivalents) and xylene diisocyanate (18 molar equivalents) and adding one-terminal methylated polyoxyethylene (1 molar equivalent, repetition number of oxyethylene units: 90) thereto: 3.76 parts

(Component 3) polyvalent isocyanate compound (1) (as 50 mass % ethyl acetate solution): 15.0 parts

(Component 4) 65 mass % solution of dipentaerythritol pentaacrylate (SR-399, manufactured by Sartomer Japan Inc.) in ethyl acetate: 11.54 parts

(Component 5) 10% solution of sulfonate type surfactant (PIONINE A-41-C, manufactured by TAKEMOTO OIL & FAT Co., Ltd.) in ethyl acetate: 4.42 parts

˜Water Phase Component˜

Distilled water: 46.87 parts

<Evaluation>

### [Ultraviolet Curable Ink Printing Durability (UV Printing Durability)]

The lithographic printing plate precursor prepared in the above-described manner was exposed by Magnus 800 Quantum (manufactured by Kodak Japan Ltd.) equipped with an infrared semiconductor laser under conditions of an output of 27 W, an external drum rotation speed of 450 rpm, and a resolution of 2400 dpi (dot per inch, 1 inch=2.54 cm) (irradiation energy of approximately 110 mJ/cm²). The exposed image had a solid image and an AM screen (Amplitude Modulation Screen) 10% halftone dot chart.

The obtained exposed precursor was attached to the cylinder of a printing press SX-74 (manufactured by Heidelberg Co.) having a medium octavo size without being subjected to a development treatment. The present printing press was connected to a dampening water circulation tank having a capacity of 100 L and including a nonwoven fabric filter and a temperature control device. The circulation device was charged with 80 L of acidic dampening water listed in Table 1 or Table 2, dampening water and ink were supplied using T & K UV OFS K-HS ink GE-M (manufactured by T&K TOKA Co., Ltd.) as printing ink according to a standard automatic printing start method, and printing was performed on 500 sheets of Tokubishi Art (manufactured by Mitsubishi Paper Mills Ltd., ream weight of 76.5 kg) paper at a printing speed of 10000 sheets per hour.

Next, the printing was further performed. As the number of printed sheets increased, the image area was gradually worn, and thus the ink density on the printed material decreased. The number of printed sheets in a case where the value obtained by measuring the halftone dot area ratio of AM screen 10% halftone dots using a Gretag densitometer (manufactured by GretagMacbeth) in the printed material was decreased by 3% than the measured value of the 500th printed sheet was defined as the number of completely printed sheets, and the printing durability was evaluated.

The evaluation was performed according to the following standards based on the relative printing durability in which a case where the number of printed sheets was 50000 was rated as 100. The printing durability is satisfactory as the numerical value increases. The evaluation results are listed in Table 1 or 2.

Relative printing durability=(number of printed sheets of target lithographic printing plate precursor)/50000×100

—Evaluation Standards—

A: The value of the relative printing durability was greater than 90

B: The value of the relative printing durability was greater than 75 and 90 or less.

C: The value of the relative printing durability was 75 or less.

[Visibility (Color Developability)]

Each of the obtained lithographic printing plate precursors was exposed by Trendsetter 3244VX equipped with a water-cooled 40 W infrared semiconductor laser (manufactured by Creo Co., Ltd.) under conditions of an output of 11.5 W, an external drum rotation speed of 220 rpm, and a resolution of 2400 dpi (dot per inch, 1 inch=25.4 mm). The exposure was performed in an environment of 25° C. and 50% RH.

Immediately after the exposure, the color development of the lithographic printing plate precursor was measured. The measurement was performed by a specular reflection light removal (SCE) method using a spectrophotometer CM2600d (manufactured by Konica Minolta Inc.) and operation software CM-S100 W. The color developability was evaluated by a difference ΔL (specifically, L* value of exposed portion−L* value of unexposed portion) between the L* value of the exposed portion and the L* value of the unexposed portion using the L* value (brightness) of the L*a*b* color system. The evaluation results are listed in Table 1 or 2. The color developability is excellent as the value of ΔL increases.

—Evaluation Standards—

A: ΔL was 6.0 or greater

B: ΔL was less than 6.0

[Property of Suppressing Residual Color]

The prepared lithographic printing plate precursor was exposed by Magnus 800 Quantum (manufactured by Kodak Japan Ltd.) equipped with an infrared semiconductor laser under conditions of an output of 27 W, an external drum rotation speed of 450 rpm, and a resolution of 2400 dpi (dot per inch, 1 inch=2.54 cm) (irradiation energy of approximately 110 mJ/cm²). The exposed image had a solid image and an AM screen (Amplitude Modulation Screen) 50% halftone dot chart.

The obtained exposed precursor was attached to the cylinder of a printing press SX-74 (manufactured by Heidelberg Co.) having a medium octavo size without being subjected to a development treatment. The present printing press was connected to a dampening water circulation tank having a capacity of 100 L and including a nonwoven fabric filter and a temperature control device. The circulation device was charged with 80 L of dampening water containing 2.0% of acidic dampening water listed in Table 1 or Table 2, dampening water and ink were supplied using T & K UV OFS K-HS ink GE-M (manufactured by T&K TOKA Co., Ltd.) as printing ink according to a standard automatic printing start method, and printing was performed on 200 sheets of Tokubishi Art (manufactured by Mitsubishi Paper Mills Ltd., ream weight of 76.5 kg) paper at a printing speed of 10000 sheets per hour.

In the on-press development, the printing was performed until the ink was not transferred to the non-image area, the plate was removed from the printing press, and the tint of the non-image area was visually evaluated. It can be said that the amount of residual color decreases and the property of suppressing residual color is enhanced as the tint of the non-image area is closer to the tint of the support. The evaluation results are listed in Table 1 or 2.

—Evaluation Standards—

5 points: The tint of the non-image area was the same as the tint of the support.

4 points: A tint derived from the acid color developing agent was slightly confirmed in a part of the non-image area.

3 points: A tint derived from the acid color developing agent was confirmed in a part of the non-image area.

2 points: A tint derived from the acid color developing agent was slightly confirmed on the entire surface of the non-image area.

1 point: A tint derived from the acid color developing agent was confirmed on the entire surface of the non-image area.

TABLE 1

| | | Support | | | | | | | |
|---|---|---|---|---|---|---|---|---|---|
| | | | | | Shape of large-diameter | | Shape of small-diameter | | |
| | | | | AD treatment | pore | | pore | | |
| | | | Alkali | Electrolytic | Average | | Average | | Density of |
| | | Surface | treatment | solution | diameter | Depth | diameter | Depth | micropores |
| | | treatment | (° C.) | (type) | (nm) | (nm) | (nm) | (nm) | (pc/μm²) |
| Example | 1 | MGV | 40 | Sulfuric acid | 26 | 100 | 8 | 900 | 1,080 |
| | 2 | MGV | 54 | Sulfuric acid | 26 | 100 | 8 | 900 | 1,080 |
| | 3 | Hydrochloric | 20 | Sulfuric acid | 26 | 100 | 8 | 900 | 1,080 |
| | | acid EG | | | | | | | |
| | 4 | Hydrochloric | 30 | Sulfuric acid | 26 | 100 | 8 | 900 | 1,080 |
| | | acid EG | | | | | | | |
| | 5 | Hydrochloric | 40 | Sulfuric acid | 26 | 100 | 8 | 900 | 1,080 |
| | | acid EG | | | | | | | |
| | 6 | Hydrochloric | 54 | Sulfuric acid | 26 | 100 | 8 | 900 | 1,080 |
| | | acid EG | | | | | | | |
| | 7 | Hydrochloric | 20 | Sulfuric acid | 26 | 100 | 8 | 900 | 1,080 |
| | | acid EG | | | | | | | |
| | 8 | Hydrochloric | 30 | Sulfuric acid | 26 | 100 | 8 | 900 | 1,080 |
| | | acid EG | | | | | | | |
| | 9 | Hydrochloric | 40 | Sulfuric acid | 26 | 100 | 8 | 900 | 1,080 |
| | | acid EG | | | | | | | |
| | 10 | Hydrochloric | 20 | Sulfuric acid | 26 | 100 | 8 | 900 | 1,080 |
| | | acid EG | | | | | | | |
| | 11 | Hydrochloric | 20 | Sulfuric acid | 26 | 100 | 8 | 900 | 1,080 |
| | | acid EG | | | | | | | |
| | 12 | Hydrochloric | 50 | Phosphoric | 26 | 130 | 8 | 900 | 1,150 |
| | | acid EG | | acid | | | | | |
| | 13 | Hydrochloric | 50 | Phosphoric | 26 | 100 | 8 | 900 | 1,150 |
| | | acid EG | | acid | | | | | |
| | 14 | Hydrochloric | 50 | Phosphoric | 24 | 130 | 8 | 900 | 1,150 |
| | | acid EG | | acid | | | | | |
| | 15 | Hydrochloric | 50 | Phosphoric | 28 | 130 | 8 | 900 | 1,150 |
| | | acid EG | | acid | | | | | |
| | 16 | Hydrochloric | 30 | Phosphoric | 26 | 130 | 8 | 900 | 1,150 |
| | | acid EG | | acid | | | | | |
| | 17 | Hydrochloric | 54 | Phosphoric | 26 | 130 | 8 | 900 | 1,150 |
| | | acid EG | | acid | | | | | |
| | | | | | | Acid color | Physical property value | | |
| | | | | | | developing | | Acid color developing agent | |
| | | | Acidic dampening water | | | agent | Support | | λmax |
| | | | pH | Type | Concentration | Type | (ΔL) | ε | (nm) |
| | Example | 1 | 4.2 | S-Z1 | 2% | S-1 | 60% | 64,400 | 550 |
| | | 2 | 4.2 | S-Z1 | 2% | S-1 | 55% | 64,400 | 550 |
| | | 3 | 4.2 | S-Z1 | 2% | S-1 | 45% | 64,400 | 550 |
| | | 4 | 4.2 | S-Z1 | 2% | S-1 | 41% | 64,400 | 550 |
| | | 5 | 4.2 | S-Z1 | 2% | S-1 | 33% | 64,400 | 550 |
| | | 6 | 4.2 | S-Z1 | 2% | 5-1 | 20% | 64,400 | 550 |
| | | 7 | 4.2 | S-Z1 | 2% | CL-1 | 45% | 20,000 | 440/578 |
| | | 8 | 4.2 | S-Z1 | 2% | CL-1 | 41% | 20,000 | 440/578 |
| | | 9 | 4.2 | S-Z1 | 2% | CL-1 | 33% | 20,000 | 440/578 |
| | | 10 | 4.2 | S-Z1 | 2% | S-15 | 45% | 94,600 | 549 |
| | | 11 | 5.0 | VITA | 2% | S-1 | 45% | 64,400 | 550 |
| | | | | FOUNT | | | | | |
| | | | | GOLD | | | | | |
| | | 12 | 4.2 | S-Z1 | 2% | S-1 | 26% | 64,400 | 550 |
| | | 13 | 4.2 | S-Z1 | 2% | S-1 | 26% | 64,400 | 550 |
| | | 14 | 4.2 | S-Z1 | 2% | S-1 | 26% | 64,400 | 550 |
| | | 15 | 4.2 | S-Z1 | 2% | S-1 | 26% | 64,400 | 550 |
| | | 16 | 4.2 | S-Z1 | 2% | S-1 | 40% | 64,400 | 550 |
| | | 17 | 4.2 | S-Z1 | 2% | S-1 | 20% | 64,400 | 550 |
| | | | | | | | Evaluation | | |
| | | | | | | | | | Property of |
| | | | | | | | UV | | suppressing |
| | | | | | | | printing | Visibility | residual |
| | | | | | | | durability | (ΔL) | color |
| | | | | | Example | 1 | A | A | 2 |
| | | | | | | 2 | A | A | 3 |
| | | | | | | 3 | A | A | 3 |
| | | | | | | 4 | A | A | 4 |
| | | | | | | 5 | B | A | 4 |
| | | | | | | 6 | B | A | 5 |
| | | | | | | 7 | A | B | 3 |
| | | | | | | 8 | A | B | 4 |
| | | | | | | 9 | B | B | 4 |
| | | | | | | 10 | A | A | 3 |
| | | | | | | 11 | A | A | 3 |
| | | | | | | 12 | B | A | 4 |
| | | | | | | 13 | B | A | 4 |
| | | | | | | 14 | B | A | 5 |
| | | | | | | 15 | B | A | 3 |
| | | | | | | 16 | A | A | 3 |
| | | | | | | 17 | B | A | 5 |

TABLE 2

| | | Support | | | | | | | |
|---|---|---|---|---|---|---|---|---|---|
| | | | | | Shape of large-diameter | | Shape of small-diameter | | |
| | | | | AD treatment | pore | | pore | | |
| | | | Alkali | Electrolytic | Average | | Average | | Density of |
| | | Surface | treatment | solution | diameter | Depth | diameter | Depth | micropores |
| | | treatment | (° C.) | (type) | (nm) | (nm) | (nm) | (nm) | (pc/μm²) |
| Comparative | 1 | MGV | 25 | Sulfuric acid | 26 | 100 | 8 | 900 | 1,080 |
| Example | 2 | Hydrochloric | 65 | Sulfuric acid | 26 | 100 | 8 | 900 | 1,080 |
| | | acid EG | | | | | | | |
| | 3 | MGV | 25 | Sulfuric acid | 26 | 100 | 8 | 900 | 1,080 |
| | 4 | Hydrochloric | 65 | Sulfuric acid | 26 | 100 | 8 | 900 | 1,080 |
| | | acid EG | | | | | | | |
| | | | | | | | | | Acid color |
| | | | | | | | | | developing |
| | | | | | | Acidic dampening water | | | agent |
| | | | | | | pH | Type | Concentration | Type |
| | | | | Comparative | 1 | 4.2 | S-Z1 | 2% | S-1 |
| | | | | Example | 2 | 4.2 | S-Z1 | 2% | S-1 |
| | | | | | 3 | 4.2 | S-Z1 | 2% | CL-1 |
| | | | | | 4 | 4.2 | S-Z1 | 2% | CL-1 |
| | | | | | | | Evaluation | | |
| | | | | Physical property value | | | | | Property of |
| | | | | | Acid color developing agent | | UV | | suppressing |
| | | | | Support | | λmax | printing | Visibility | residual |
| | | | | (ΔL) | ε | (nm) | durability | (ΔL) | color |
| | | Comparative | 1 | 60% | 64,400 | 550 | A | A | 1 |
| | | Example | 2 | 15% | 64,400 | 550 | C | A | 5 |
| | | | 3 | 65% | 20,000 | 440/578 | A | B | 1 |
| | | | 4 | 15% | 20,000 | 440/578 | C | B | 5 |

The details of the abbreviations listed in Table 1 and Table 2 other than those described above are shown below.

The maximum absorption wavelength λmax “440/578” of the acid generator CL-1 in Table 1 and Table 2 denotes that the acid generator had the maximum absorption wavelengths at wavelengths of 440 nm and 578 nm.

The “alkali treatment (° C.)” in Table 1 and Table 2 denotes the liquid temperature of the alkaline aqueous solution used for the alkali etching treatment after the electrochemical roughening treatment. The “alkali treatment (° C.)” in Examples 1 and 2 and Comparative Examples 1 and 3 in Table 1 or Table 2 denotes the liquid temperature of the alkaline aqueous solution used for the alkali etching treatment after the first electrochemical roughening treatment.

[Acid Color Developing Agent]

CL-1: Compound having the following structure, S-205 (manufactured by Fukui Yamada Chemical Co., Ltd.)

S-15: compound having the following structure

S-1: compound having the following structure

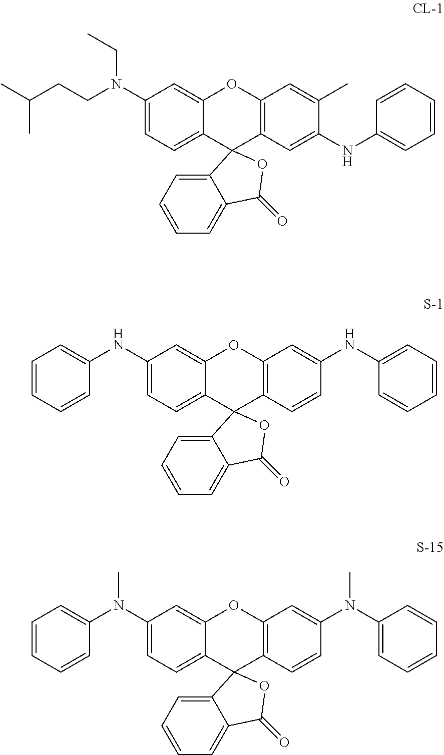 [SMILES: CCN(CCC(C)C)c1ccc2c(c1)Oc1cc(C)c(Nc3ccccc3)cc1C21OC(=O)c2ccccc21 ; O=C1OC2(c3ccc(Nc4ccccc4)cc3Oc3cc(Nc4ccccc4)ccc32)c2ccccc21 ; CN(c1ccccc1)c1ccc2c(c1)Oc1cc(N(C)c3ccccc3)ccc1C21OC(=O)c2ccccc21]

[Acidic Dampening Water]

S-Z1: a liquid obtained by diluting the etching solution S-Z1 (manufactured by FUJIFILM Corporation) to S-Z1/water=2/98 (volume ratio).

VITAFOUNTGOLD: a liquid obtained by diluting VITAFOUNTGOLD (manufactured by Bottcher) to VITAFOUNTGOLD/water=2/98 (volume ratio).

As shown in the results listed in Table 1 and Table 2, the lithographic printing plates of Examples 1 to 17 obtained by the lithographic printing method according to the present disclosure had excellent printing durability of the lithographic printing plate to be obtained and the excellent property of suppressing residual color even in a case where a UV ink was used, as compared with the lithographic printing plates of Comparative Examples 1 to 4.

Further, as shown in the results listed in Table 1 and Table 2, the lithographic printing plates of Examples 1 to 17 obtained by the lithographic printing method according to the present disclosure also had excellent visibility.

### EXPLANATION OF REFERENCES

1: aluminum plate
2, 4: roller-like brush
3: polishing slurry liquid
5, 6, 7, 8: support roller
18: aluminum plate
ta: anodic reaction time
tc: cathodic reaction time
tp: time until current value reaches peak from zero
Ia: peak current on anode cycle side
Ic: peak current on cathode cycle side
AA: current of aluminum plate for anodic reaction
CA: current of aluminum plate for cathodic reaction
10: lithographic printing plate precursor
12a, 12b: aluminum support
14: undercoat layer
16: image recording layer
20a, 20b: anodized film
22a, 22b: micropore
24: large-diameter pore
26: small-diameter pore
D: depth of large-diameter pore
50: main electrolytic cell
51: AC power source
52: radial drum roller
53a, 53b: main pole
54: electrolytic solution supply port
55: electrolytic solution
56: auxiliary anode
60: auxiliary anode cell
W: aluminum plate
A1: liquid supply direction
A2: electrolytic solution discharge direction
610: anodization treatment device
612: power supply tank
614: electrolytic treatment tank
616: aluminum plate
618, 26: electrolytic solution
620: power supply electrode
622, 628: roller
624: nip roller
630: electrolytic electrode
632: cell wall
634: DC power source

The disclosure of JP2019-239025 filed on Dec. 27, 2019 is incorporated herein by reference in its entirety. All documents, patent applications, and technical standards described in the present specification are incorporated herein by reference to the same extent as in a case of being specifically and individually noted that individual documents, patent applications, and technical standards are incorporated by reference.

What is claimed is:

1. A lithographic printing method comprising:
preparing a lithographic printing plate precursor which includes an aluminum support, and an image recording layer containing an acid color developing agent and an acid generator on the aluminum support;
imagewise-exposing the lithographic printing plate precursor;
supplying acidic dampening water to the exposed lithographic printing plate precursor and removing a non-image area of the image recording layer; and
performing printing using a lithographic printing plate obtained by the development, with printing ink and acidic dampening water,
wherein the aluminum support includes an aluminum plate and an anodized aluminum film disposed on the aluminum plate,
the anodized film is positioned on a side of the image recording layer with respect to the aluminum plate, the anodized film has micropores extending from a surface of the anodized film on the side of the image recording layer in a depth direction, and
an average diameter of the micropores in the surface of the anodized film is greater than 10 nm and 100 nm or less, and a specific surface area ΔS which is a value acquired by Equation (i) for a geometrically measured area So and an actual area Sₓ obtained by an approximate three-point method, based on three-dimensional data obtained by measuring 512×512 points in a range of 25 μm×25 μm on the surface of the anodized film on the side of the image recording layer using an atomic force microscope, is 15% or greater and 60% or less,
ΔS=(Sₓ−S₀)/S₀×100(%) (i).

2. The lithographic printing method according to claim 1, further comprising:
drying the acidic dampening water on the lithographic printing plate obtained by the development.

3. The lithographic printing method according to claim 1,
wherein the micropores are formed of large-diameter pores extending to a position at a depth of 10 nm to 1000 nm from the surface of the anodized film and small-diameter pores communicating with bottom portions of the large-diameter pores and extending to a position at a depth of 20 nm to 2000 nm from communication positions, and
an average diameter of the large-diameter pores in the surface of the anodized film is in a range of 15 nm to 100 nm, and an average diameter of the small-diameter pores at the communication positions is 13 nm or less.

4. The lithographic printing method according to claim 3,
wherein a depth of the large-diameter pores is in a range of 10 nm to 130 nm.

5. The lithographic printing method according to claim 3,
wherein the average diameter of the large-diameter pores in the surface of the anodized film is in a range of 20 nm to 100 nm.

6. The lithographic printing method according to claim 1,
wherein the acid color developing agent has a molar absorption coefficient ε of 20000 to 100000 at a maximum absorption wavelength.

7. The lithographic printing method according to claim 1,
wherein at least one maximum absorption wavelength λmax of an image area of the exposed lithographic printing plate precursor is in a range of 400 nm to 700 nm.

8. The lithographic printing method according to claim 1,
wherein the image recording layer contains a polymerization initiator, and the polymerization initiator includes an electron-donating polymerization initiator and an electron-accepting polymerization initiator.

9. The lithographic printing method according to claim 8,
wherein the image recording layer contains an infrared absorbing agent, and a difference between HOMO of the infrared absorbing agent and HOMO of the electron-donating polymerization initiator is 0.70 eV or less.

10. The lithographic printing method according to claim 8,
wherein the image recording layer contains an infrared absorbing agent, and a difference between LUMO of the electron-accepting polymerization initiator and LUMO of the infrared absorbing agent is 0.80 eV or less.

11. The lithographic printing method according to claim 1,
wherein the image recording layer contains a polymerizable compound, and the polymerizable compound includes a hepta- or higher functional polymerizable compound, preferably a deca- or higher functional polymerizable compound.

12. The lithographic printing method according to claim 1,
wherein the acid color developing agent is a leuco coloring agent.

13. The lithographic printing method according to claim 12,
wherein the leuco coloring agent is a leuco coloring agent having a phthalide structure or a fluorane structure.

14. The lithographic printing method according to claim 13,
wherein the leuco coloring agent having a phthalide structure or a fluorane structure is a compound represented by any of Formulae (Le-1) to (Le-3), 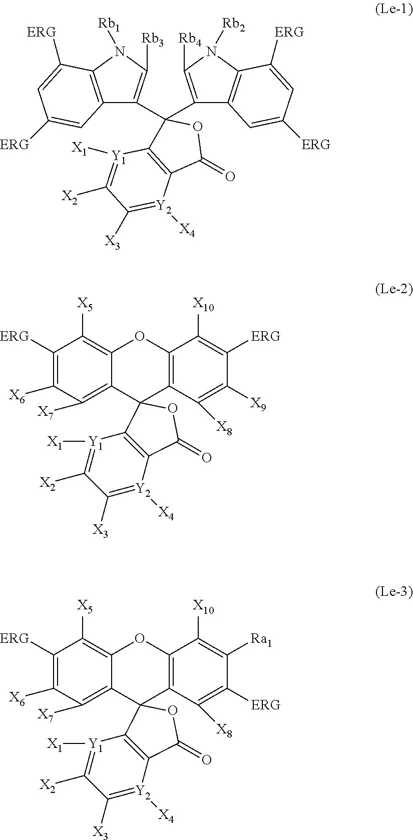
in Formulae (Le-1) to (Le-3), ERG's each independently represent an electron-donating group, X₁ to X₄ each independently represent a hydrogen atom, a halogen atom, or a dialkylanilino group, X₅ to X₁₀ each independently represent a hydrogen atom, a halogen atom, or a monovalent organic group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent an alkyl group or an aryl group.

15. The lithographic printing method according to claim 13,
wherein the leuco coloring agent having a phthalide structure or a fluorane structure is a compound represented by any of Formulae (Le-4) to (Le-6), 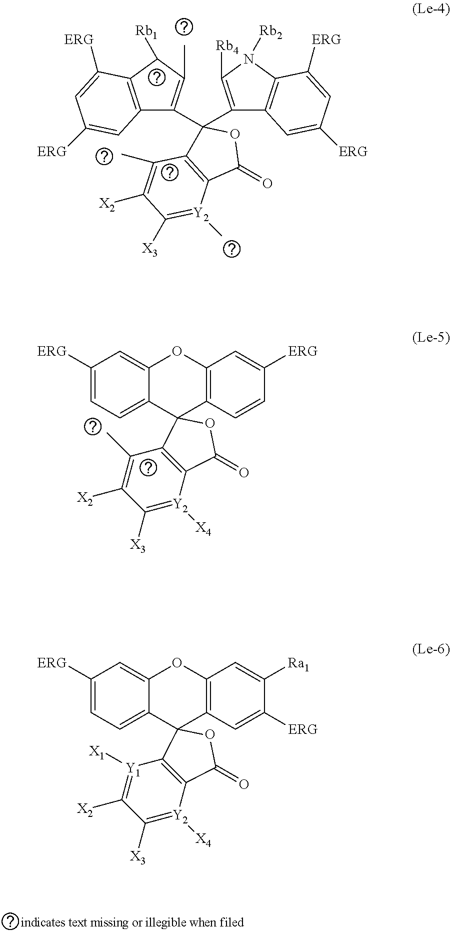
in Formulae (Le-4) to (Le-6), ERG's each independently represent an electron-donating group, X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ represents a hydrogen atom, an alkyl group, or an alkoxy group, and Rb₁ to Rb₄ each independently represent an alkyl group or an aryl group.

16. The lithographic printing method according to claim 13,
wherein the leuco coloring agent having a phthalide structure or a fluorane structure is a compound represented by any of Formulae (Le-7) to (Le-9), 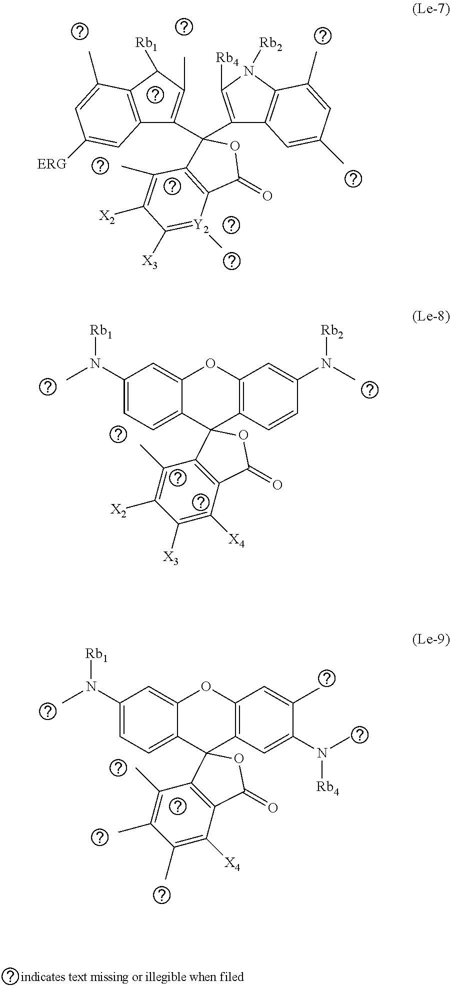
in Formulae (Le-7) to (Le-9), X₁ to X₄ each independently represent a hydrogen atom, a halogen atom, or a dialkylanilino group, Y₁ and Y₂ each independently represent C or N, X₁ is not present in a case where Y₁ represents N, and X₄ is not present in a case where Y₂ represents N, Ra₁ to Ra₄ each independently represent a hydrogen atom, an alkyl group, or an alkoxy group, Rb₁ to Rb₄ each independently represent an alkyl group or an aryl group, and Rc₁ and Rc₂ each independently represent an aryl group.

17. The lithographic printing method according to claim 16,
wherein Ra₁ to Ra₄ each independently represent an alkoxy group.

18. The lithographic printing method according to claim 16,
wherein the leuco coloring agent having a phthalide structure or a fluorane structure is a compound represented by Formula (Le-8).

19. The lithographic printing method according to claim 18,
wherein X₁ to X₄ represent a hydrogen atom, and Y₁ and Y₂ represent C.

20. The lithographic printing method according to claim 18,
wherein Rb₁ and Rb₂ each independently represent a hydrogen atom or an alkyl group.
